(19) United States
(12) Patent Application Publication
(10) Pub. No.: US 2013/0317875 A1
(43) Pub. Date: Nov. 28, 2013

(54) INVESTIGATION REPORTING SYSTEM WITH FREELANCER INPUT OPTION

(71) Applicant: Michael Morgan Parker, Sterling, VA (US)

(72) Inventor: Michael Morgan Parker, Sterling, VA (US)

(21) Appl. No.: 13/898,527

(22) Filed: May 21, 2013

Related U.S. Application Data
(60) Provisional application No. 61/649,955, filed on May 22, 2012.
(60) Provisional application No. 61/756,180, filed on Jan. 24, 2013.

(51) Int. Cl. G06Q 10/06

(52) U.S. Cl. CPC G06Q 10/06313
USPC 705/7.23

(57) ABSTRACT

A system distributes instructions from a central server to repossession agents through a smart-phone application that is in networked communication with the central server, and the repossession agents report information back to the central server through the smart-phone application. The smart-phone application can also be used by freelancers to provide suspect vehicle information to the central server. The central server does not provide the freelancers with vehicle information of vehicles to be repossessed but compares the suspect vehicle information with repossession information in the central server's database and when a match results in a vehicle being repossessed, the freelancer that provided the suspect vehicle information is provided a reward for having provided the information.

### CROSS-REFERENCE TO RELATED APPLICATIONS

This application claims priority from U.S. Provisional Patent Application Nos. 61/649,955 and 61/756,180 respectively filed on May 22, 2012 and Jan. 24, 2013 which are hereby incorporated by reference.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to systems in which instructions are distributed from a central control station, such as where investigative agents are dispatched, investigations are performed in the field according to the distributed instructions, and status reports are returned to the central control station. This invention particularly relates to vehicle repossession systems in which scouts receive their instructions through an electronic messaging system and report their findings directly to a centralized system through a prompt-driven software application that queries the scouts in real-time as they investigate the vehicles that are to be repossessed.

2. Related Art

There are a number of computerized project tracking systems which are used by tow companies and repossession businesses in particular. However, most of these systems are focused primarily on the dispatching of tow trucks after the location of a vehicle has already been determined. Therefore, the collection of information and action reports of these systems typically begin with the initial call identifying the location of the vehicle and the dispatch of the tow truck, and these systems allow for logging and collecting information all the way through to the completion of the tow to its destination. These systems typically provide maps that show the tow truck drivers the location of the vehicles to be towed and even may collect and report additional information after the vehicles are towed, such as storage information or lien sale information. However, none of these systems provide for the collection and reporting of scouting information through the centralized system.

In current systems, manual entry of scouting data is required after repo-drivers return from their shifts, usually nightly runs. This reporting of the scouting data is important, because in the repossession industry, recovery companies are required to provide detailed updates about every single address that is run. These updates paint a picture for the client and provide proof that the agent actually checked the address. Active repossession files to be worked in a particular shift are given to the repo agents, and the office then sends individual faxes, text messages or e-mail messages to the scouts. If the vehicle is not at the location identified in the file, the agent will return the file back to the office with a written update. Typically, the update may be written in short hand abbreviations, and the scout will later compose a full update on a faxable or printed form, enter the update into a text message on their phone or create a message in an e-mail. The updates can be a physical description of a location as well as the contacts that have been made with neighbors or other individuals with information related to the property to be repossessed. At the end of the shift, the agents e-mail, fax, text or otherwise deliver their updates to the office and the corresponding files are returned to the office.

The office collects and sorts the files and the agents' updates. For agents who use a shorthand system to create their updates, the office must decode the updates and enter them into the system in an acceptable format for the client to be notified of the status. The scouting of addresses linked to vehicles is time consuming work, and the current methods of reporting are inefficient so this adds to the time which a scout must spend to satisfy their obligations. Therefore, there is a need for more efficiently preparing and producing scouting reports in the repossession industry.

With current repossession software systems, repossession company must accept new work from various clients via fax, email or online portal. At this point the repo office employee will have some sort of paper form that describes all information about the assignment the client wants worked. The employee will then need to enter this information into an online database so they can digitally manage this repossession assignment along with all other assignments being worked by the repossession company. The functions listed below are general features that are typically found in online repossession assignment databases.
Manage all information about the repossession company's storage facilities, clients, police departments and third party companies such as transporters and auto auctions that deal with the repossession company.
Enter all information for every new assignment into the database so that the information is searchable, editable and printable.
Manage all assignments by entering updates into the database for each address as the investigation for each repossession assignment progresses.
Manage the status of each repossession assignment (Open, On-Hold, Closed, Repossessed and Released)
Print various documents such as Repossession and Delivery Orders, Invoices, Monthly Reports, Transportation Authorization, Redemption Receipts with and without fees, Personal Property Reports and Hold Harmless Letters.

There are additional functions that are offered by the various online databases, but these are the primary functions that are used by most repossession companies. These are the bare bones functions needed for a repossession company to effectively manage their repossession assignments digitally. Once the information for any repossession assignment is entered into their database, the assignment can be worked.

When an address for a repossession assignment needs to be checked out by a field agent, the information needed by the field agent is gathered and sent to the field agent via email, text message or fax and the paper copy of the assignment is given to the field agent. This becomes more of a task when multiple addresses need to be checked and when there are several field agents requiring information.

When multiple addresses need to be ran on any given night, the office employee will need to go through the paper files and decide which addresses need to be ran and then either just give the files to the field agent or they will manually type the information in and generate a route for the field agent and send it to them via email, text message or fax.

As each address is checked throughout the night, the paper file is turned over and an update is written on the back. An update is a description of either the physical appearance of an address or the description of conversations had at the address or a combination of both. These updates are eventually given to the clients as proof of the address being checked out and could contain information that is helpful in locating the collateral which the client has assigned. At the end of the night, all paper files are taken back to the repossession company office to be processed. In the morning, the repossession company office employee must read each update and attempt to understand what the field agents wrote down at each address, manually enter each update into the online database in a way that is acceptable to the client (verbiage, punctuation and spelling) and then send each update to each client.

At this point, the repossession company office employees continue working each repossession assignment and attempt to find better information for the field agents to run and the process keeps going until the collateral is either located or the repossession assignment is closed by the client.

Examples of known systems are described in the references listed below which are incorporated by reference. Generally, computerized systems for tow management or vehicle repossession use general database programs which do not have any inquiries, optional selections or even data fields for the scouting information. As discussed above, these database programs are designed more for the dispatch of tow trucks after the location of a vehicle is known. These database programs typically have data entry fields for standard text entry or which may be linked to optional selections using drop down menus or auto-fill options based on prior text entries. However, these database programs to not have sequential logic paths which would step a user through alternative selections based on earlier selections. Also, these database programs do not change the optional selections shown on a screen display based on earlier selections.

### SUMMARY OF INVENTION

According to the inventive system described herein and shown in the corresponding drawings, the system provides same basic functions that are required for any repossession company to manage their repossession assignments digitally, but there are new features that are aimed towards easing address and update management as well as route creation and dispatch. According to the present invention, a repossession company office employee with access to a software system running on a centralized server will now act as an administrative user for the system to view a group map on their screen with selectable pins at each address their repossession company is currently investigating. Selecting any pin will allow the repossession company employee to view all information associated with the address and the pins are also searchable in various ways such as last 6 of the VIN, customer name, address, city, state and vehicle make and model. This will allow the repossession company office employee to actually manage their active addresses and view exactly where all of their active addresses are located when creating routes for their field agents rather than having to thumb through each paper file and pull out the ones they wish to have run based on looking through the files and hoping not to miss something. This new feature will ease address management and allow the repossession company office employees to keep better track of their active addresses.

Additionally, the administrative user can select any number of pins and easily have all of the information associated with each pin sent to any field agent that has downloaded a corresponding smart-phone application that integrates to and communicates with the software system running on the central server. With its communication connection to the repossession system software, the smart-phone applications have access the server's online database, allowing for information to be automatically provided to the field agent, such as the complete name of the customer, address of the customer and the vehicle information including VIN, year, make, model and all drivetrain, engine and body specifications for the exact vehicle in question as well as any additional notes the repossession company office employee wishes to share with their field agents. The ability to simply select a few pins to have a route sent to a field agent will save significant amounts of time in the organization and communication of assignments and objectives to the field agents and status reports back to the office from the field agents. Once a route that was sent from a repossession company office employee has been selected, the smart-phone application allow a field agent to easily view all of the addresses within their route as a selectable list of addresses or as a Google map with selectable pins at each address. This new function will allow the field agent to actually see where their route will be taking them and they can decide to run the addresses in any order they desire.

The field agent can then select any address in the list or pin on the Google map and view all information about the address and if desired, they can simply select the address and utilize the navigation functions already built into the smart-phone and easily navigate to the address without having to manually enter the address. This will allow the field agents to save countless hours by never having to enter addresses into a GPS device or having to thumb through the paper files to decide which is the next to be run.

If a field agent of any kind is connected to a repossession company within the database, then the field agent can view the group map belonging to their connected repossession company office and view a Google map with pins at every address their connected repossession company is currently investigating. The field agent can select any pin on this map to view all information associated with the pin and then select the address to navigate to the address. The pins are also searchable in various ways such as last 6 of the VIN, customer name, address, city, state and vehicle make and/or model. This allows a field agent to access the information within any active repossession assignment their team is currently working.

If a field agent of any kind travels within an adjustable radius of any address that is active on the group map for their team, they are automatically notified of this address nearby and given the option to navigate to the address and investigate.

When a scout arrives at any address and the vehicle is successfully located, they can easily select one button and notify all repossession agents on their repo team of this successful location and all of the information associated with the address will be forwarded to each repossession agent on the team that also uses my smart-phone application including vehicle and assignment details and a photo of the vehicle if the scout user captured one.

When a repossession agent arrives at an address and successfully repossesses the collateral, they can easily notify the repossession company office employee of the successful recovery. A repossession agent can also now enter a condition report process that will allow them to use their smart-phone to generate a condition report for the collateral at any time. This condition report process will allow the repossession agent to capture photos of the collateral and describe any damage by being directed around the collateral and asked to describe every part of the collateral inside and out. The condition report is then saved in the database and is then searchable and printable by the repossession company office employee.

If the vehicle is not located at any address, the field agent can select to be directed through an update process that will ask the field agent to capture various photos throughout the update process as it asks simple questions regarding the address and the answers to these questions will be viewed as selectable buttons and the buttons selected will determine the language used in creating an update for the address which will automatically be sent to the repossession company office as soon as the field agent completes the update process.

Each update can also contain an attached photo of a Google map with the exact route the field agent traveled while searching around an address. This function is optional and will be used to provide proof of exactly where the field agent looked while investigating an address when they wish to do so. This photo can also be sent to the client to provide proof of service at the address.

The inventive update process allows a field agent to create thousands of different updates that are perfectly worded, spelled and punctuated that provide a physical description of the property including the description and tag information for any vehicle on the property, a description of any contact made at the address as well as any number of neighbors addresses and a physical description of the approximate age, race and sex of anybody the field agent made contact with. The inventive update process as particularly implemented is designed for the repossession industry which means that the application will ask only the right questions and the update is worded correctly to avoid a possible misunderstanding or trouble. It will be appreciated that the update process can also be used with other service industries. The update process provides a knowledge-base tool that includes specialized formats and information, such as for repossession companies, which significantly decrease the training time for new users and standardize communications so that the same level of detail of professionalism with every single update regardless of prior experience.

With the integration of the smart-phone application into the overall system, it is also possible to prevent a field agent from creating an update for any address until they are within ⅓ mile of the address by only activating the button to initiate the update process within this range. This can increase the trust-level in the update data because the system requires the field agent to physically be within a few blocks of the address in order to create the update which means that field agents are not able to sit at home and enter false information just to look like they are doing their job.

Each update may also be given a randomly generated reference number or other unique reference number, such as a sequential reference number, that is searchable within the database by anybody for a period of time, such as forty-eight (48) hours. If one of these reference numbers is given to a client and the client goes to the database and enters the reference as a search, they will be displayed a Google map with a pin at the address that was being run by the field agent. This creates “verifiable” updates and adds an extra level of comfort for any client within the industry by allowing them to have access to the system that helped create the update and double check that the information was actually created within the system.

Each update is automatically sent into the database and attached to the correct address so the repossession company office employee ends up no longer needing to decode and translate updates from their field agents and enter each update into the database at the beginning of every day. This will save additional time for the staff in the repossession company office.

The system can generate a text file that contains a physical address, a physical description of the property and a description of all vehicles on the property including license plate information and possibly even a description of who lives at the address along with any photos that were captured. The system can also take the public information out of each update entered into the database (including photos) and allow the information to become searchable in various ways. These searches can be performed by persons that have been authorized by their company with an account on the Va Repo system to obtain an account on the database that will allow them to enter information they may have about a vehicle they wish to locate in the hopes of finding a location for the vehicle within the database.

If a successful search result occurs, the approved account user is shown a display that lists of all dates and times that the vehicle has been entered into the database and if desired they can purchase the addresses, updates and photos for all information in the database pertaining to the vehicle or person in question. Once a purchase has been made, an email will be sent to the approved account user every 7 days (stopping at 45 days) asking the user to select one of the addresses they were given at the time of purchase if an address was deemed a successful location of the vehicle or person of interest.

The system allows field agents to generate information pertaining to the location of vehicles throughout the entire country which is information that can be monetized. The inventive system gives the repossession industry a way to utilize the information already being generated while field agents are working assignments in the field which gives the industry a new place to look for this type of unique information. With a system that can compile the repossession information in a centralized location that the repossession industry can efficiently use, another capability is incorporated into the system which allows anybody with a smart-phone to participate in helping locate collateral for the repossession industry. Upon opening the smart-phone application, any user will have the ability to enter any information they wish to share with the industry such as a name, address, VIN, license plate information, vehicle year, make, model and color and any additional notes they wish to manually enter as well as the ability to enter photographic information.

There are several ways in which a user may input this information into the database. The user can select the “I see this” button which will capture all information the user entered and then capture the GPS coordinates of the user and send all of the information into the database to be stored in a way that is also searchable along with the stored updates. Alternatively, the user can select the “Just a tip” button which will only capture all of the information the user entered and send all of the information into the database to be stored in a way that is also searchable along with the stored updates. Additionally, the user can select the “Photo Auto Entry” button which will allow the use to simply capture a photo of any vehicle and all of the required information will automatically be pulled from the photo and the GPS coordinates of the user, the photo of the vehicle and the tag information in a text (searchable) format will all be gathered and sent into the database so that it can be purchased. The users can be motivated to input this type of information into the database with an offer for a chance at a reward, such as the promise of paying twenty dollars ($20) to any user for good information that leads to the location of a vehicle or person at the location entered by the user, and in fact, the system may allow for paying multiple users, such as two (2) or up to three (3), for good information when any location is purchased from the database. If an approved account user selects an address in any of the emails sent from the database to the approved account user after any purchase, the database will pay up to the first three (3) smart-phone users that entered the good information that assisted locating the vehicle or person of interest. Any smart-phone application user is eligible to obtain twenty dollars ($20) for any piece of information they enter into the system by using the smart-phone application.

### BRIEF DESCRIPTION OF THE DRAWINGS

The present invention will become more fully understood from the detailed description and the accompanying drawings. The drawings constitute a part of this specification and include exemplary embodiments of the invention, which may be embodied in various forms. It is to be understood that in some instances, various aspects of the invention may be shown exaggerated or enlarged to facilitate an understanding of the invention; therefore the drawings are not necessarily to scale.

FIG. 1 is a system diagram of the present invention.

FIG. 2 is a flowchart of the present invention.

FIGS. 3A-3LL are screenshots of an application used by a mobile communications device with the present invention.

FIGS. 4A-4EEE are screenshots of the centralized system server program.

FIGS. 5A-5G show a process flowchart according to the present invention.

### DETAILED DESCRIPTION OF THE PREFERRED EMBODIMENTS

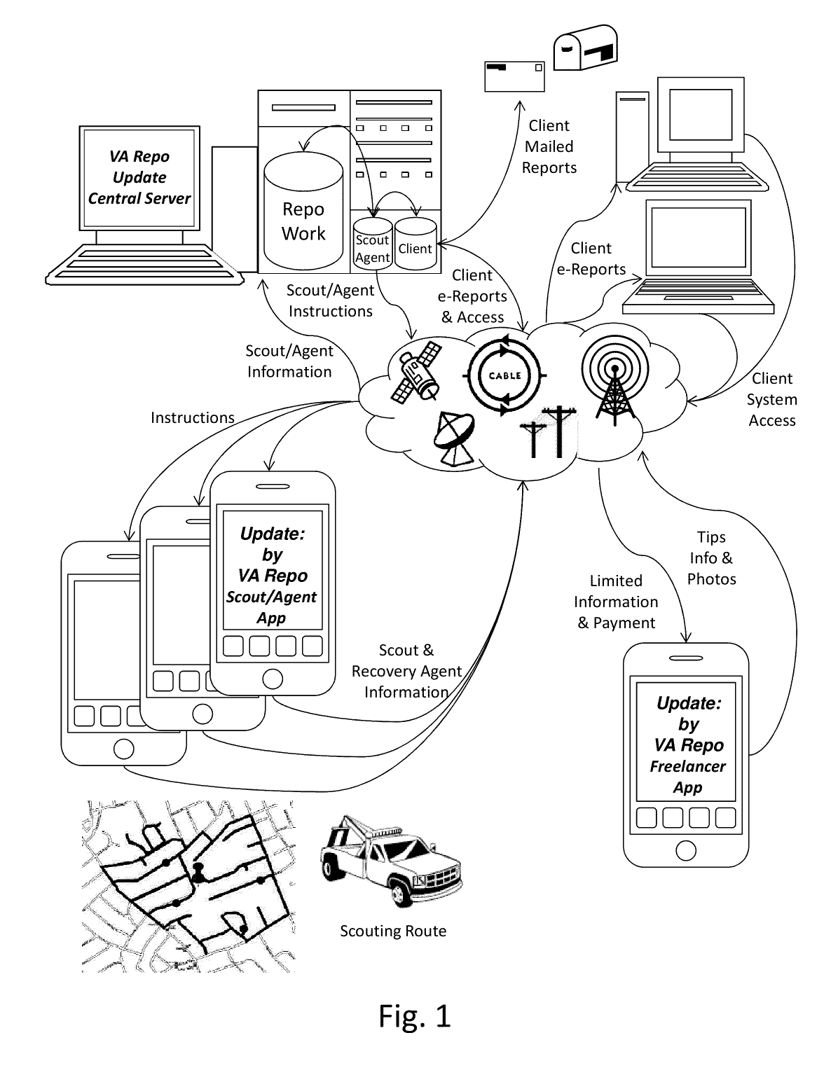

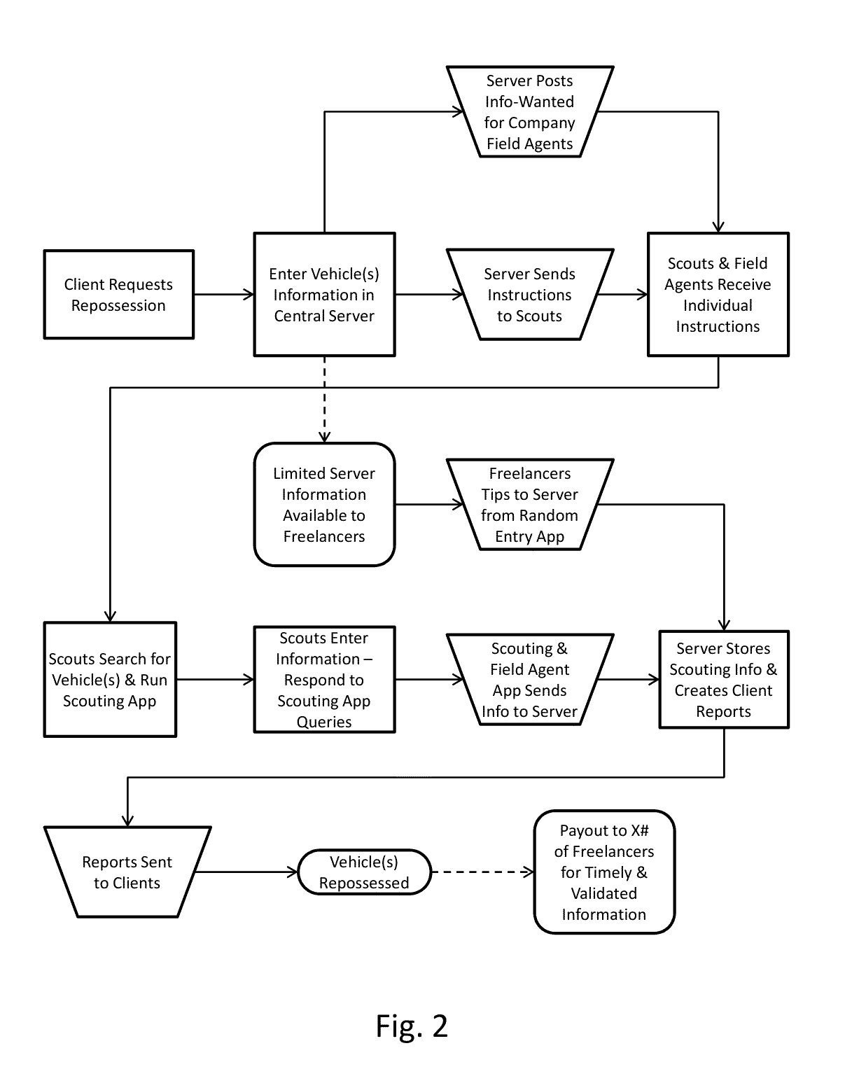

The following description of the preferred embodiment(s) is merely exemplary in nature and is in no way intended to limit the invention, its application, or uses. The present system is designed particularly for vehicle repossessions and can also be used for repossession of other types of personal property or collateral generally. The overall system of the present invention is illustrated in FIG. 1 and the overall process of the present invention is shown in FIG. 2. The general operation of the system is described below followed by particular aspects of the present invention.

The system as particularly described according to the present invention is used for scouting and reporting on personal property and corresponding locations with a mobile communications device, which can be a smart-phone, a tablet computer or even a laptop computer. The mobile communications device is preferably in communication with a centralized server that provides secure access to an online database.

The mobile communications device has a computer processor, data storage, a display screen and a user input. The mobile communications device also has a communications module and preferably includes a camera module, a geo-location module and a navigation module. Inquiry tables and response tables are saved in the data storage. As discussed with reference to the particular use of the system for repossession scouting missions, the inquiries are preferably related to physical site properties and optional responses correspond with potential physical site findings. For example, as indicated in the tables below, physical site information may include one or more of the following items: a geographic location, a building-type, a vehicle parking descriptor and a vehicle tag. Regardless of how the system is being used, one set of optional responses is related to one inquiry while one alternative set of optional responses is related to another inquiry and another alternative set of optional responses is related to another alternative inquiry. Inquiries can also be related to information obtained from witnesses and could include their contact information as well as the information that they report.

The computer processor provides one logic path between a particular response to one set of optional responses and the subsequent inquiry and an alternative logic path based on an alternative response which could result in a different subsequent second inquiry being presented to the user. The computer processor provides the display screen with the viewing information necessary to show the various inquiries and sets of optional responses. The computer processor is also in communication with the user input interface to accept selection of the optional responses and either store the responses in the data storage or other memory and ultimately instruct the communications module to report the responses back to the central server where the responses are stored in the database. The server preferably receives a sequence of the user's selections from the mobile communications device and assembles the selections into a report that can be stored with the electronic file on the particular property and can also be provided to interested third parties, such as clients who have requested the investigation.

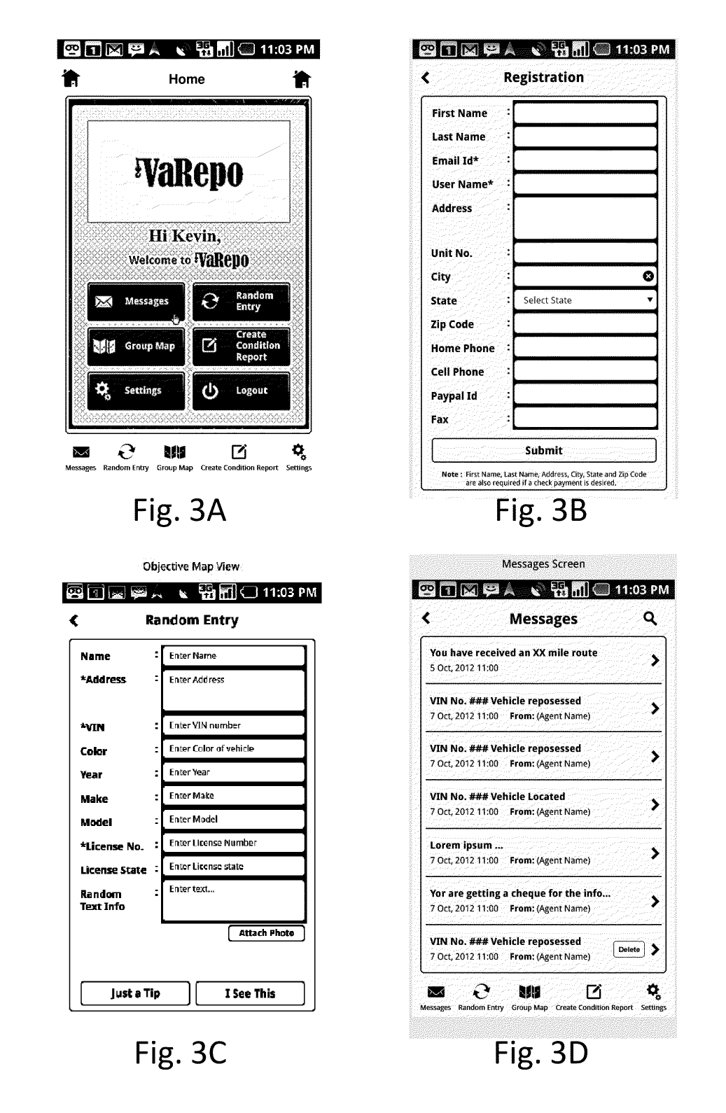

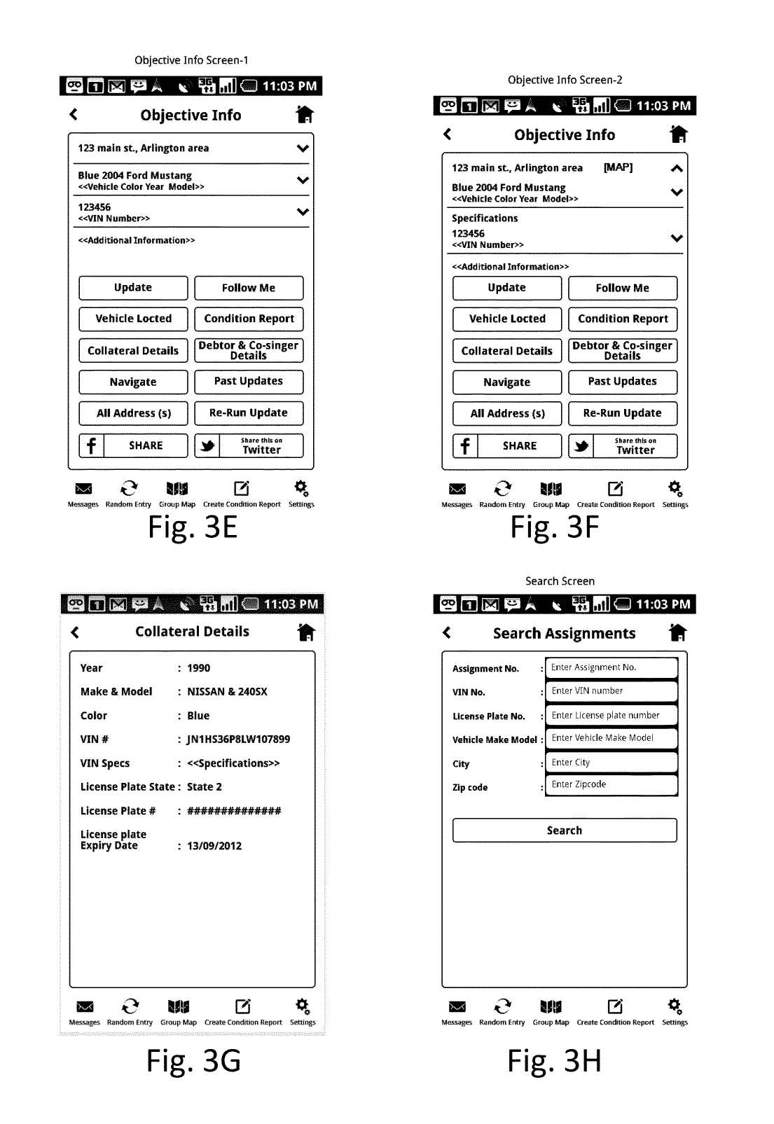

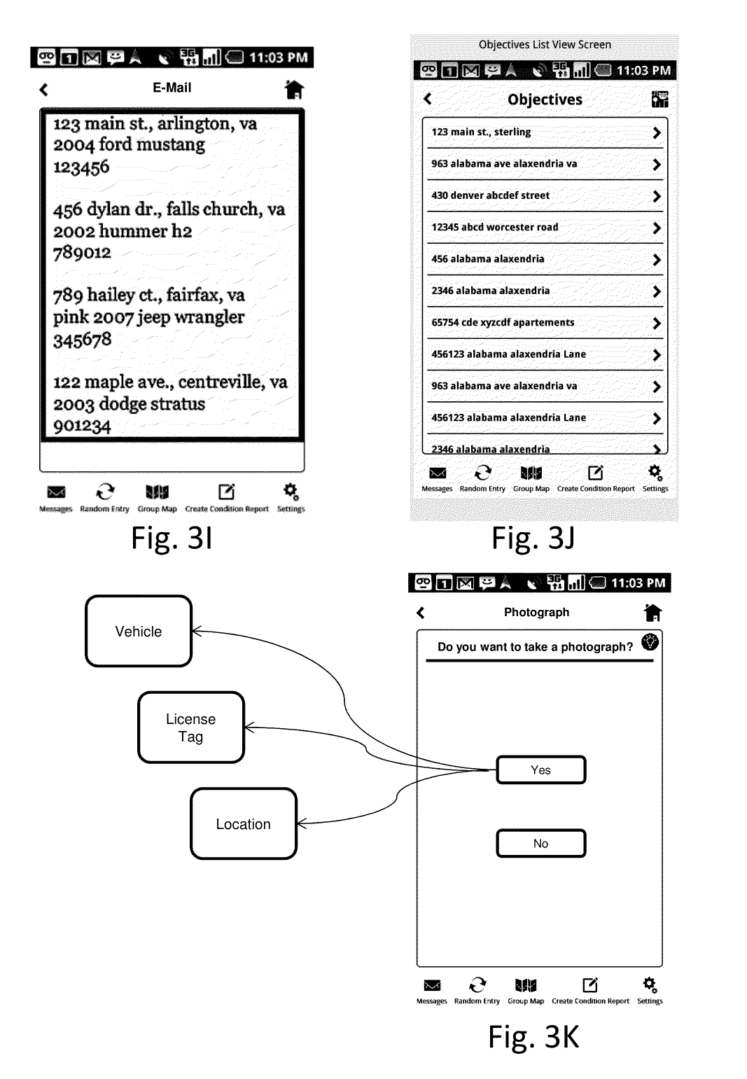

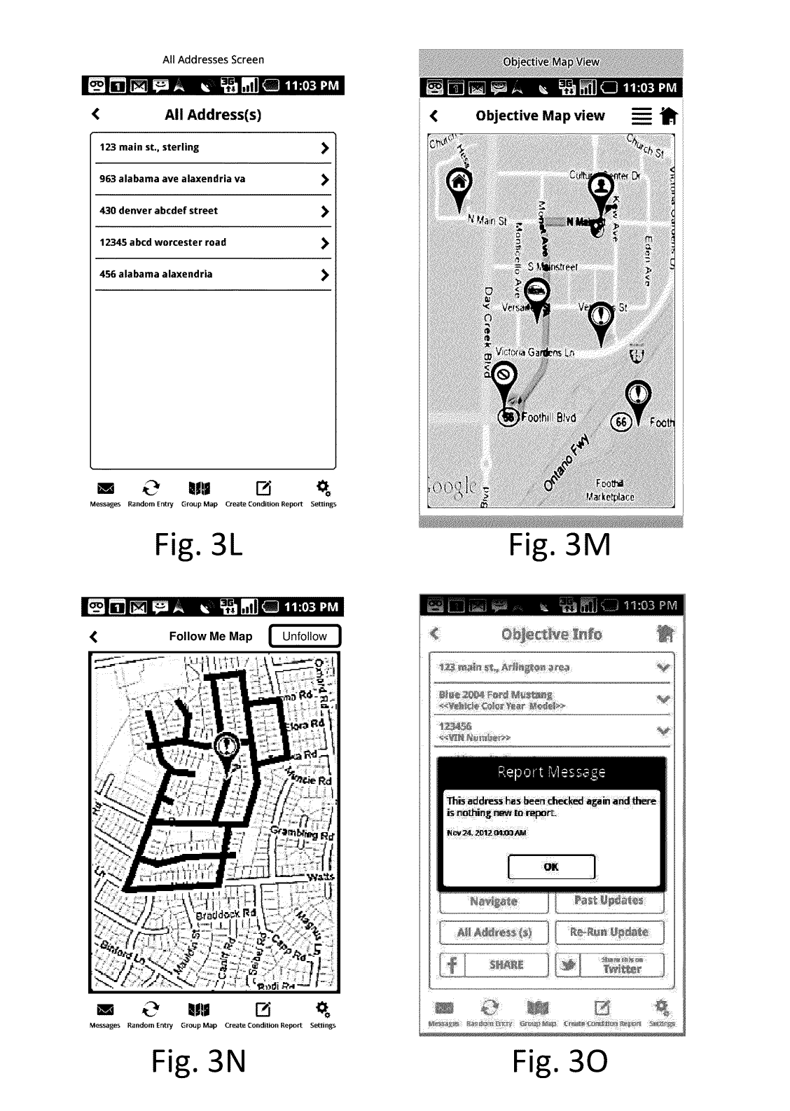

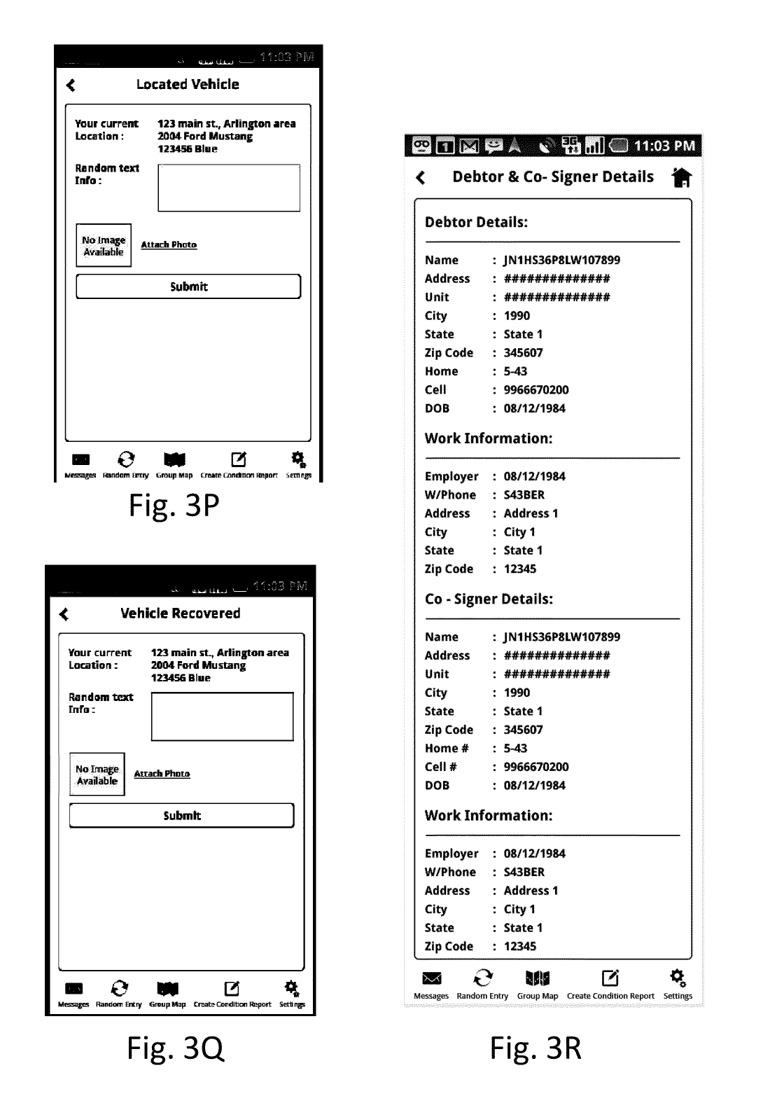

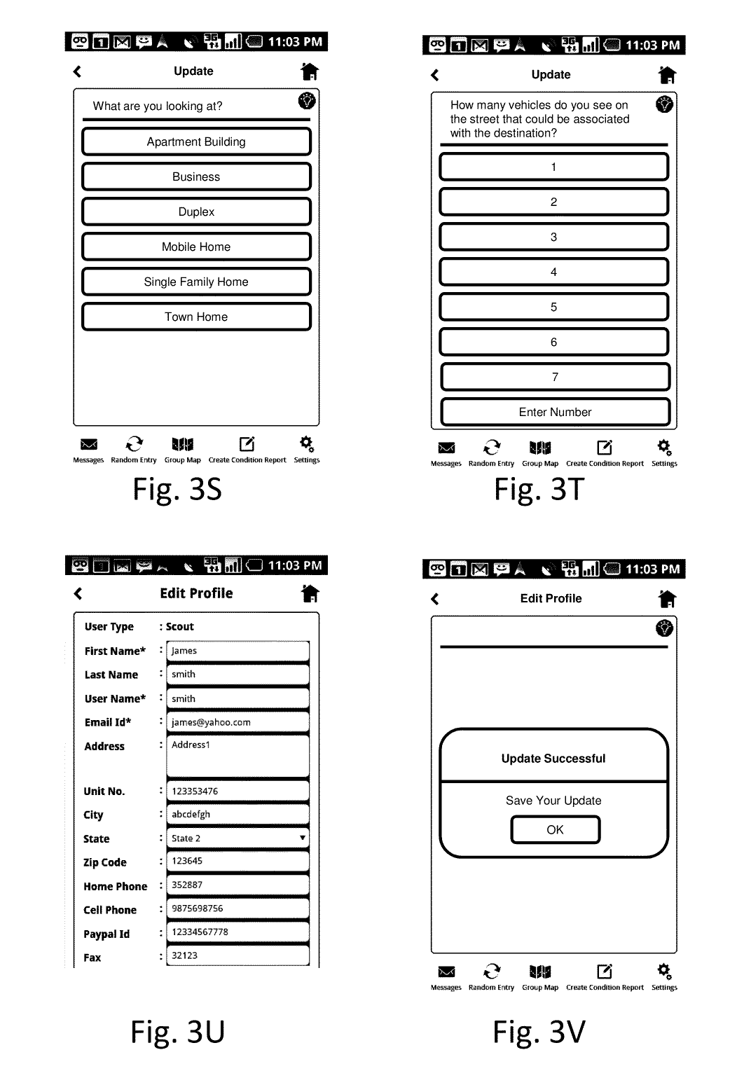

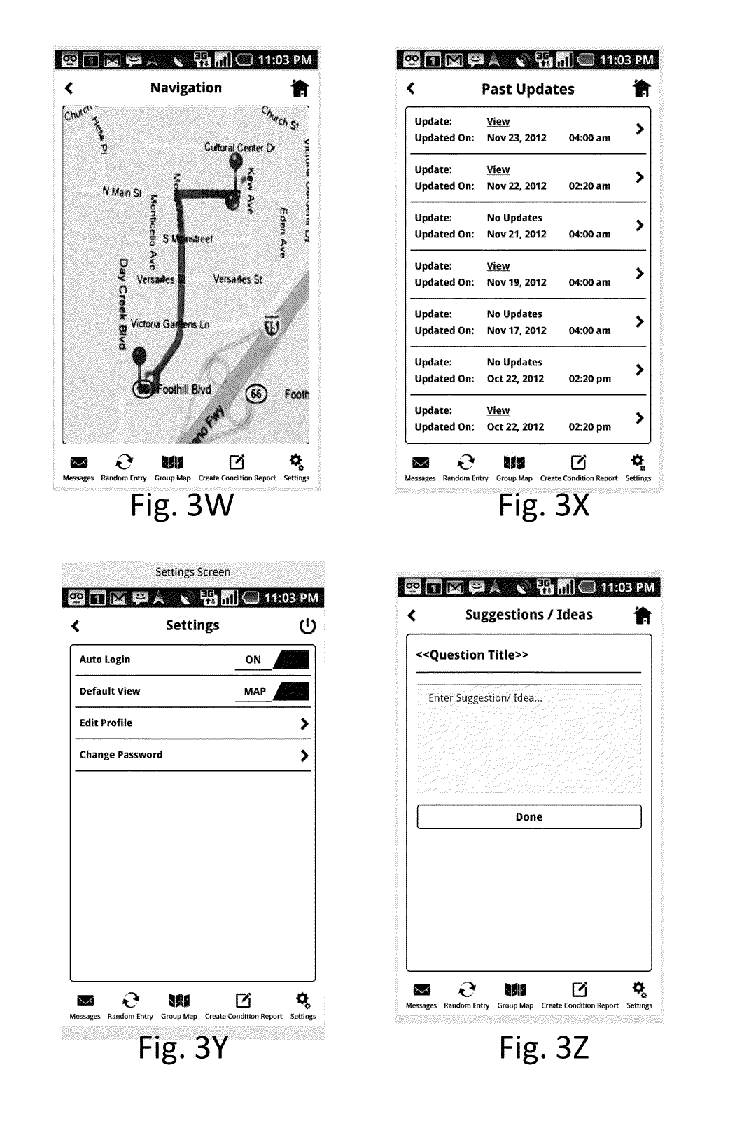

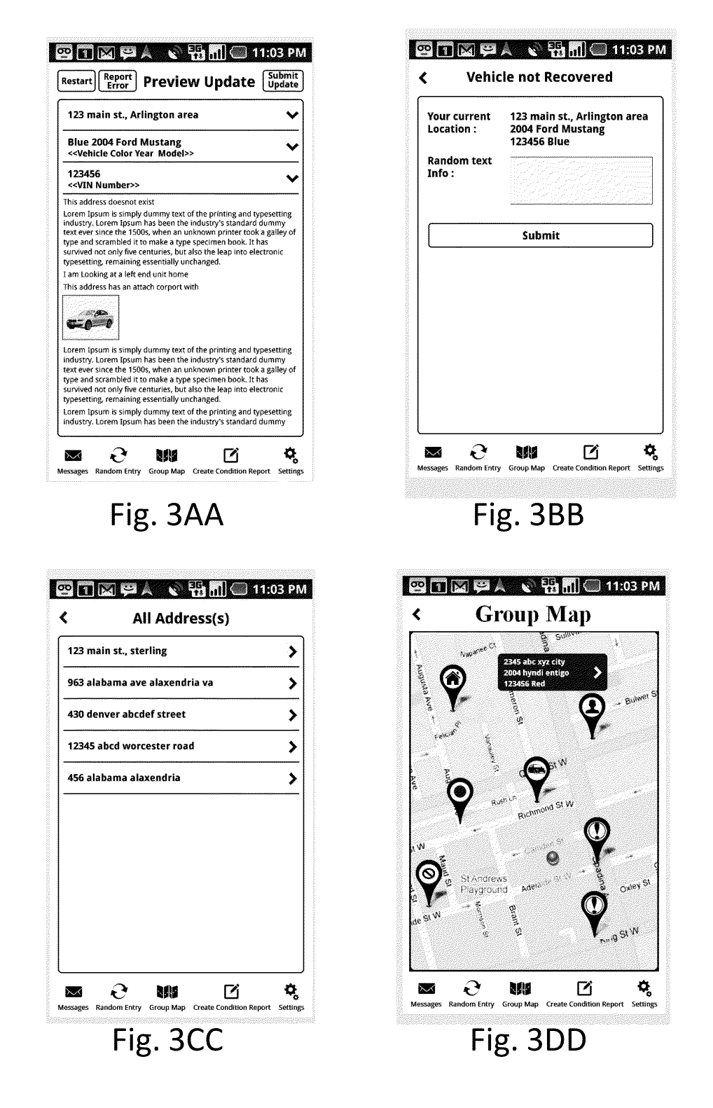

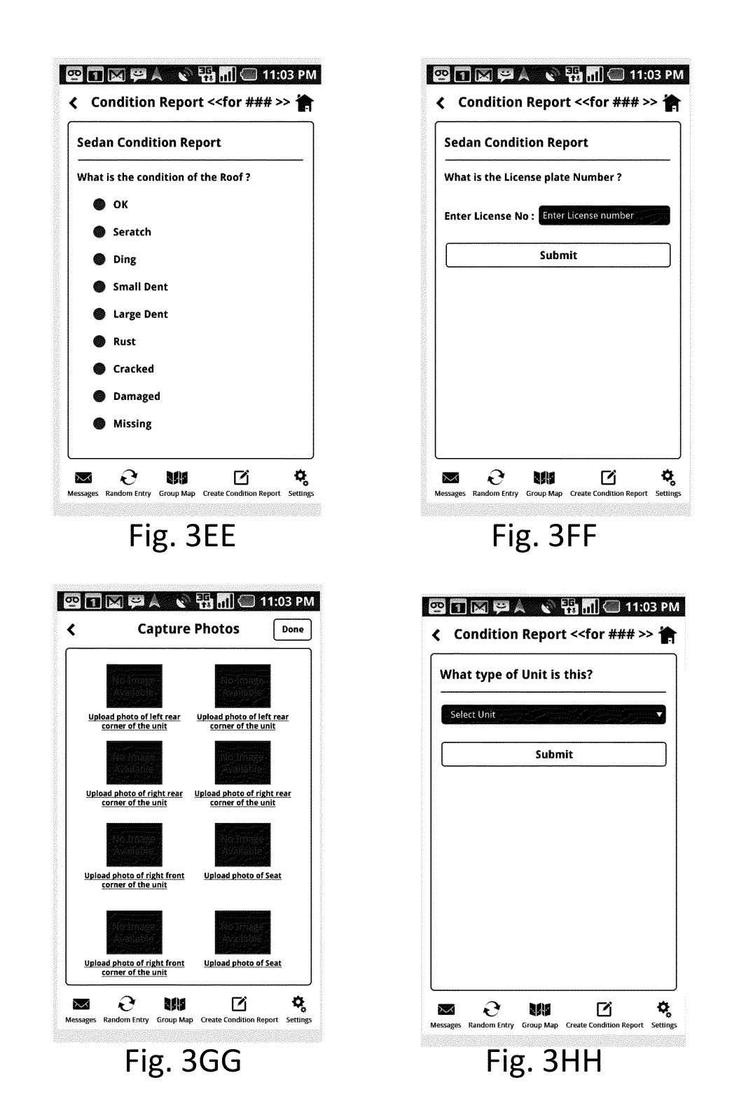

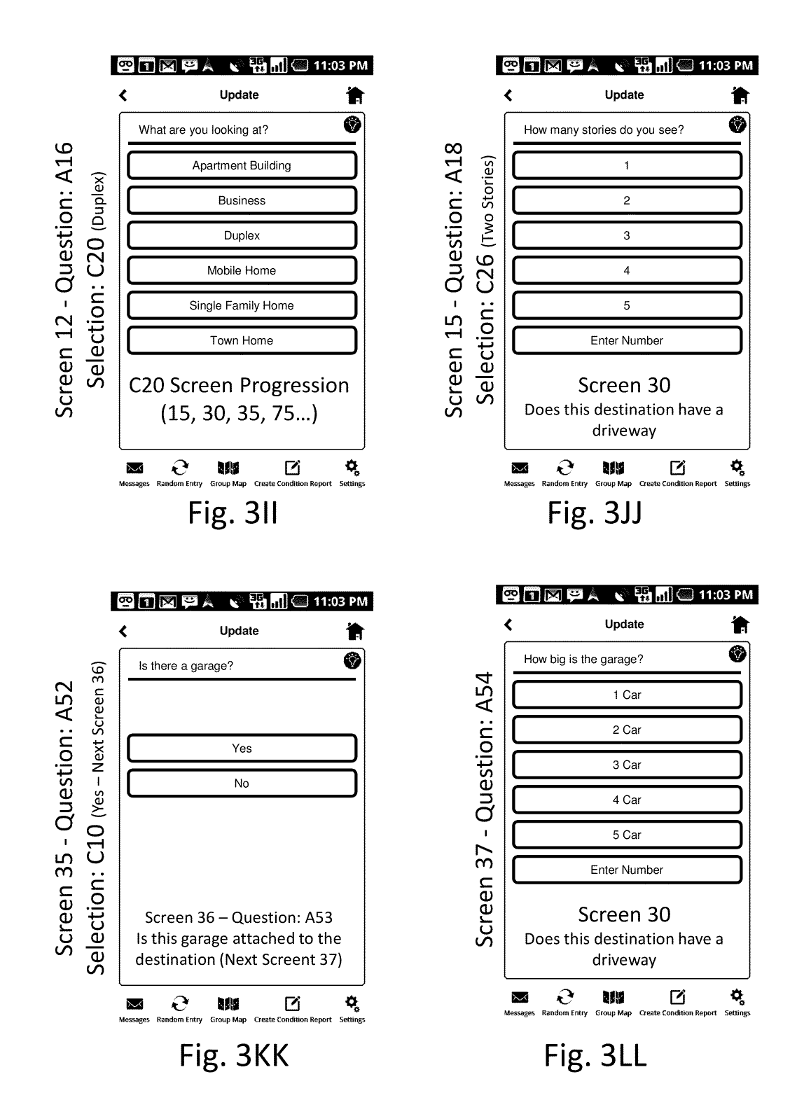

In a particular embodiment of the invention for scouting vehicles, the mobile communication device can be used for “Random Tag Updates” by providing a geo-location report on a location of the mobile communications device. This could be a quick reporting option that bypasses most of the other inquiries in the tables by providing the user with a special vehicle tag location update selection. In such a case, one inquiry may be the vehicle tag State and another inquiry would be vehicle tag number. An optional inquiry may be the make and model of the vehicle to confirm that the vehicle tag matches the State's department of motor vehicles records. As generally shown in FIG. 1 and discussed in detail below, a “freelancer” version of the random update smart-phone application may also be made available to the general public. The freelancers can actually be provided with same smart-phone application that is used by company field agents and scouts, but since a freelancer is not associated with any particular company in the system's database, the freelancer's version of the software is only enabled to operate those features that the system allows for generally accessibility to the public. Screenshots of the smart-phone application are shown in FIG. 3.

According to this overview of the system of the present invention, it will be appreciated that this general system can be used in other project management and task management systems. For example, it will be appreciated that other inquiry tables and response tables could be used for real estate professionals who are preparing reports on realty properties that they are documenting for listings or their clients. Other tables could also be prepared for inspectors or investigators who evaluate personal property items, such as home inspectors or insurance investigators. Additionally, the system could be used by law enforcement authorities to help guide the documentation of their investigations of crime scenes or onsite witness interviews.

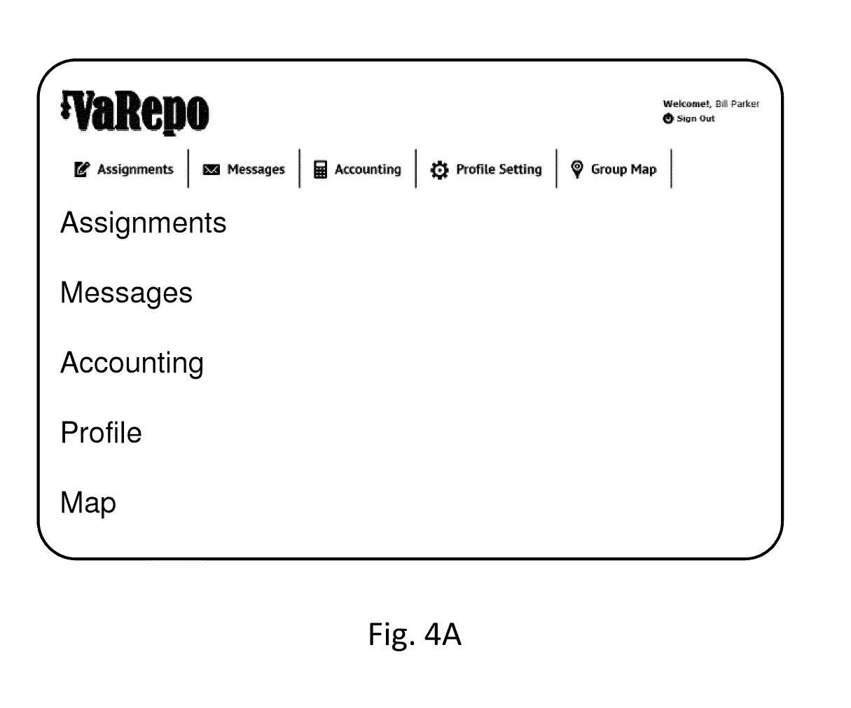

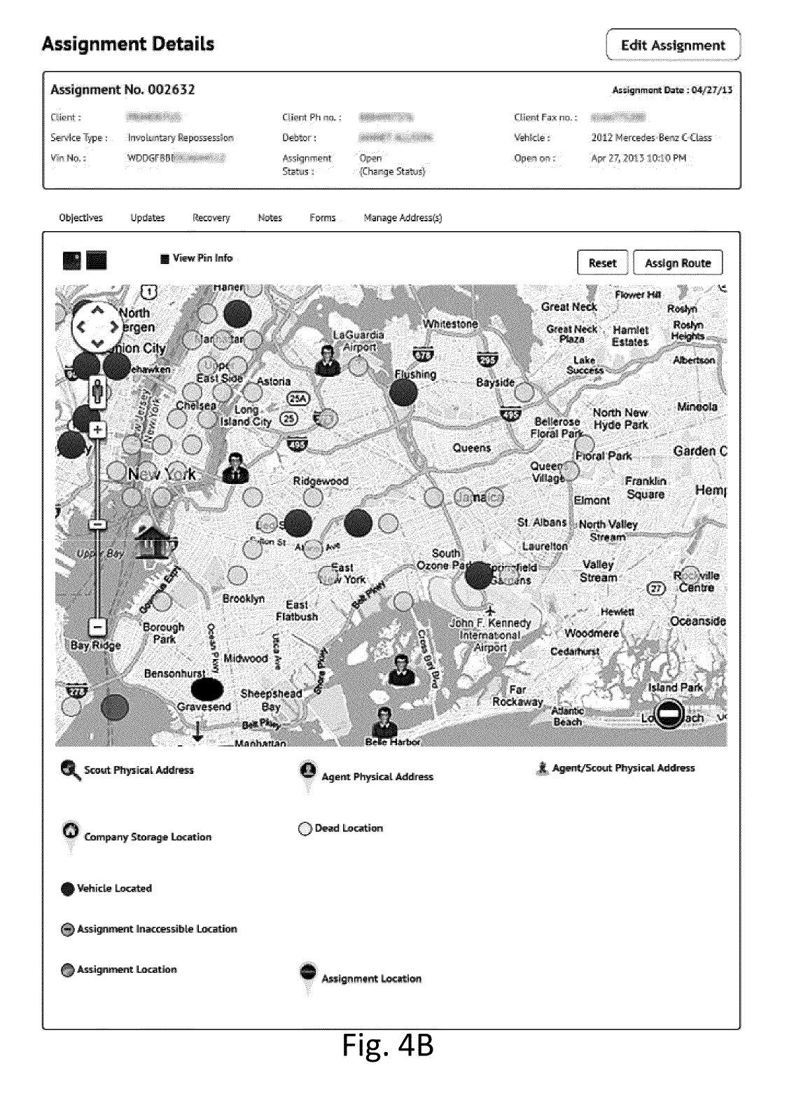

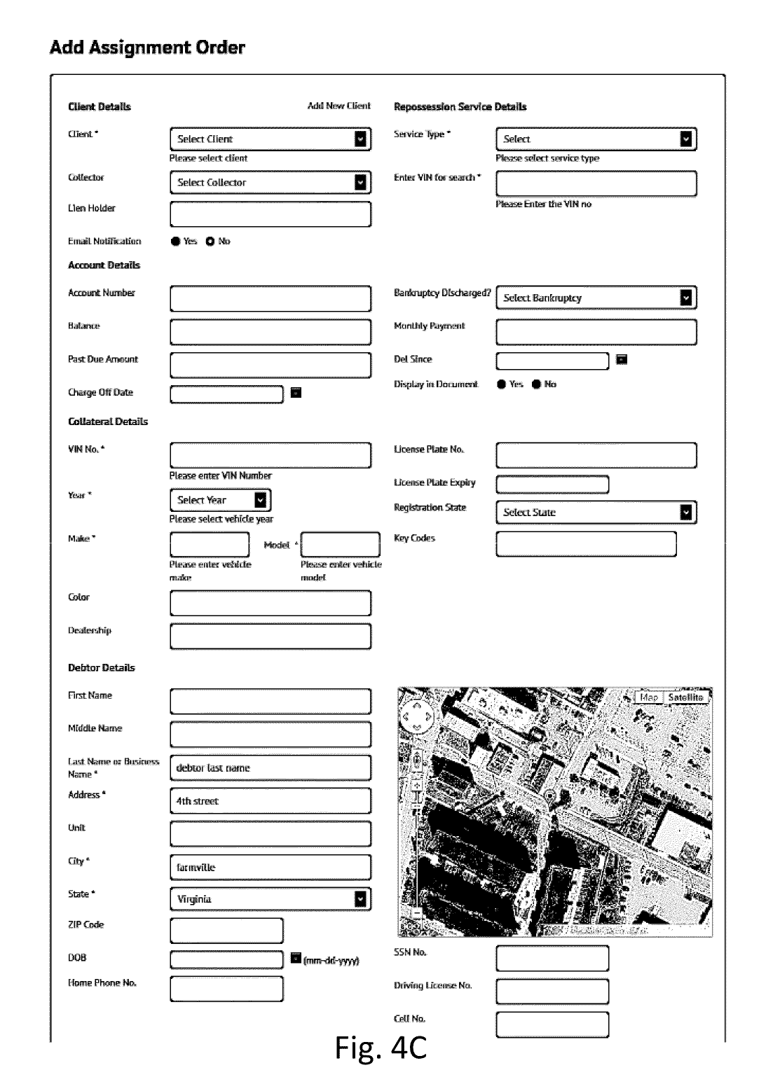

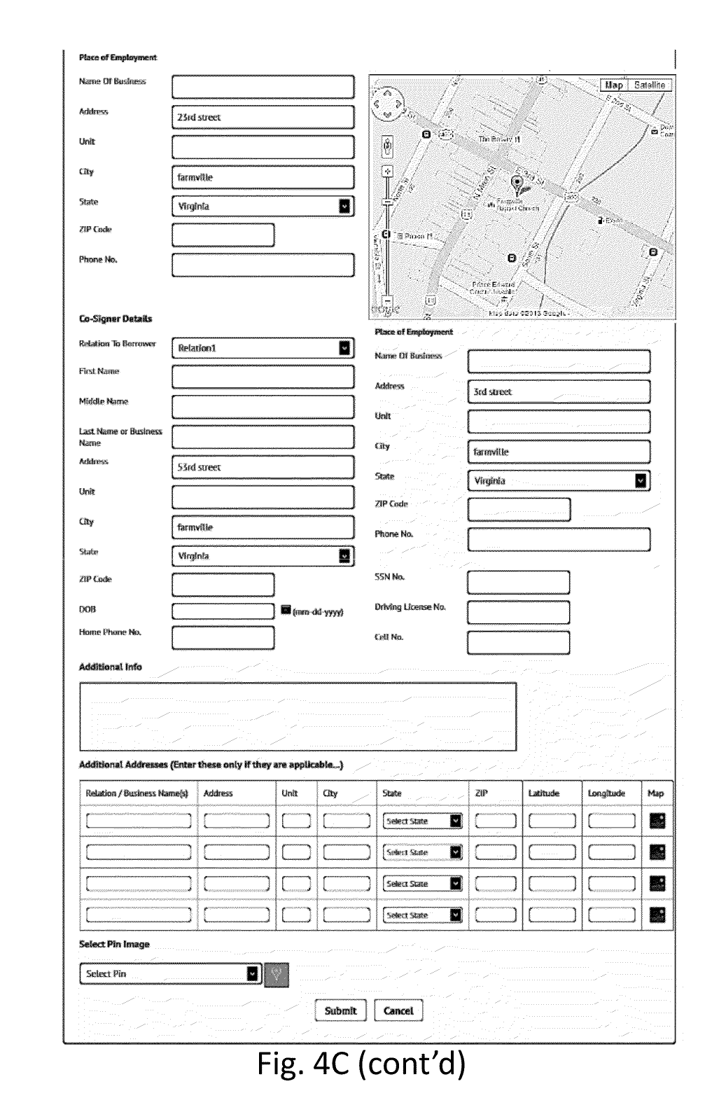

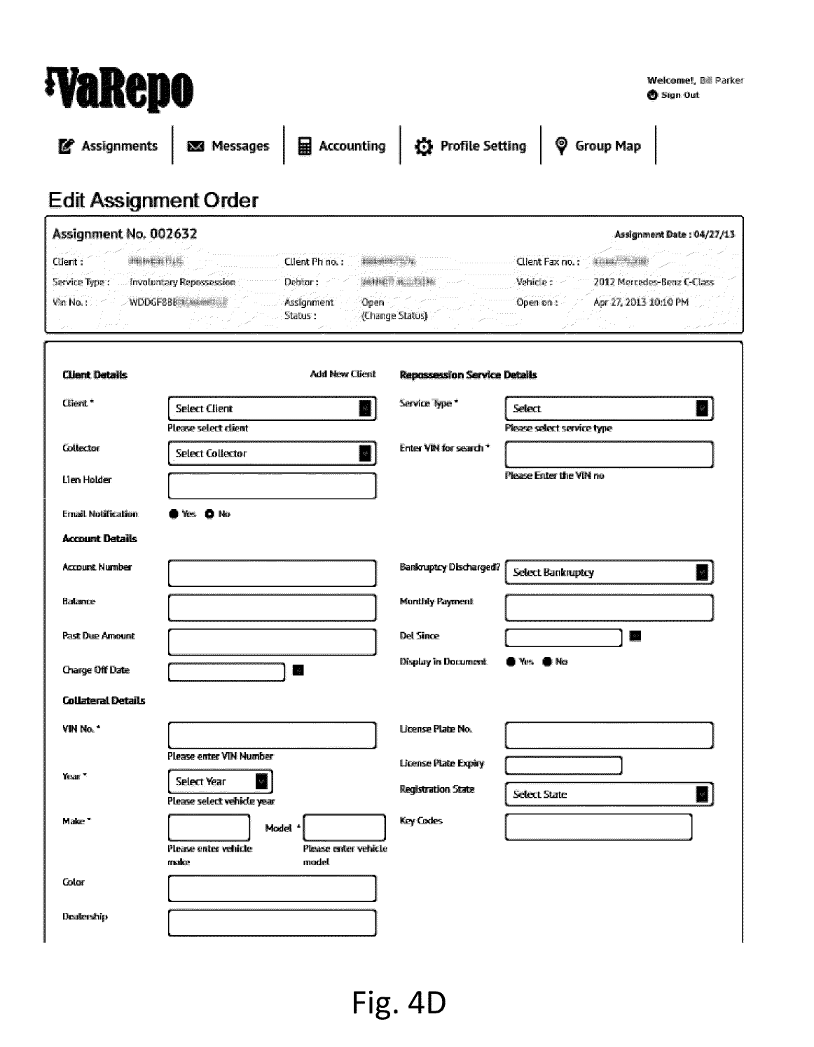

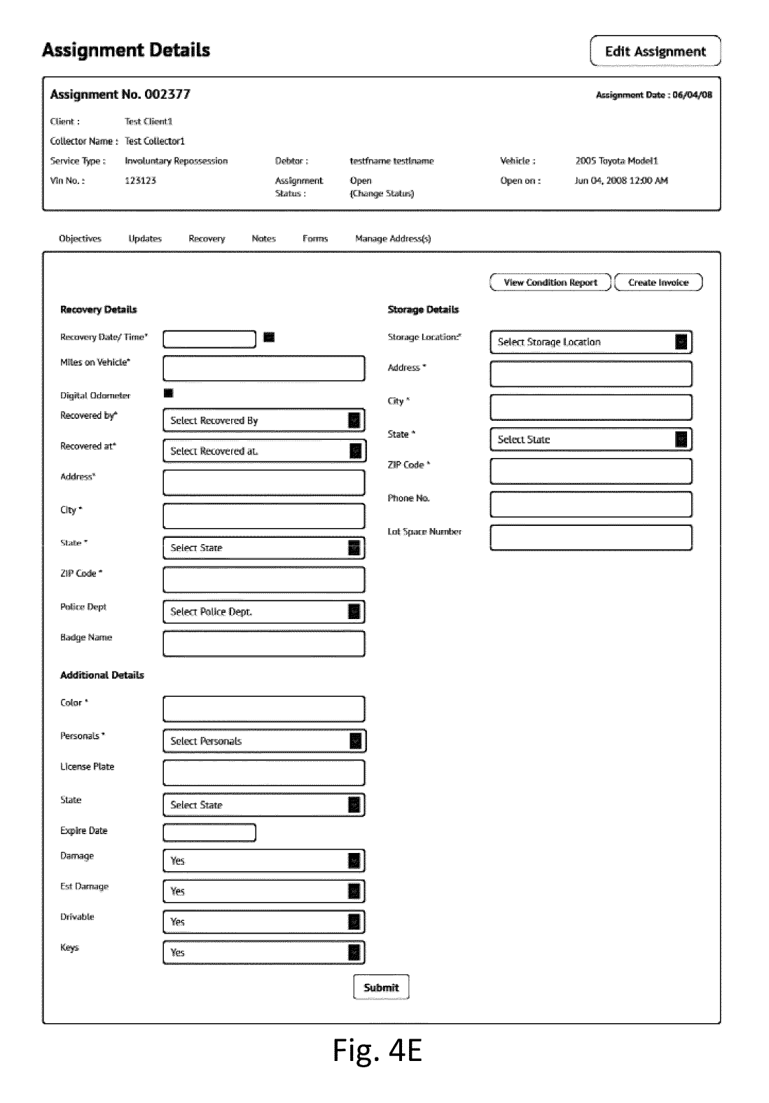

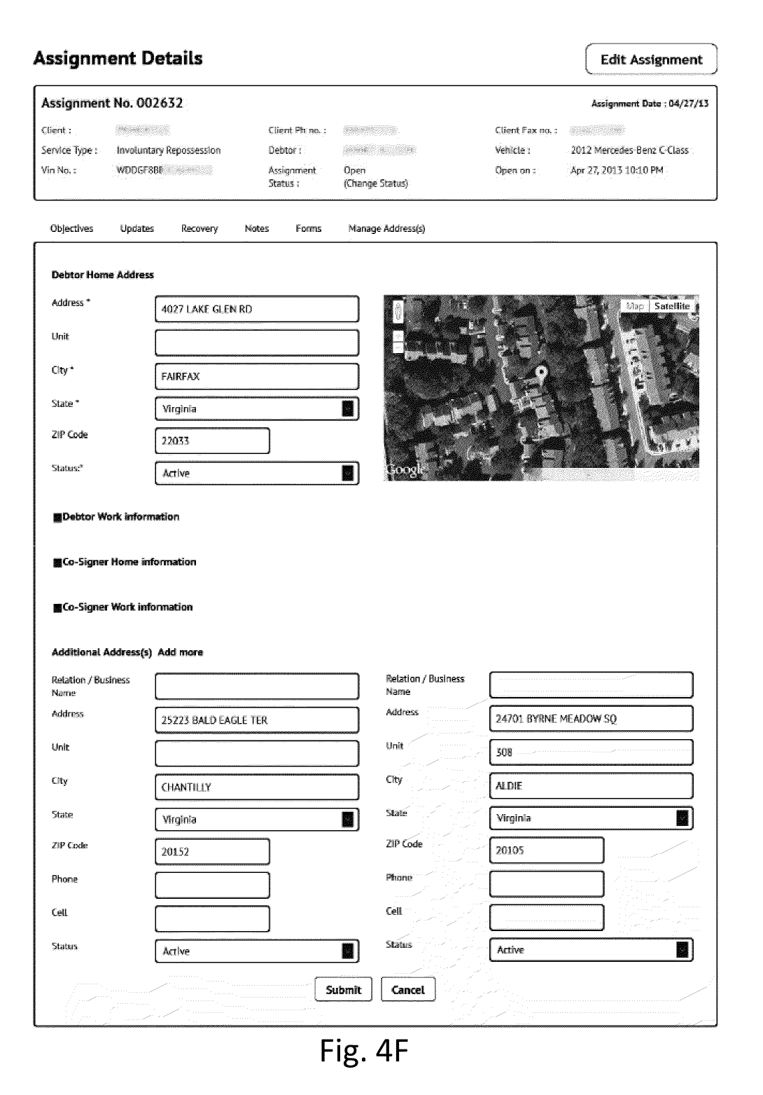

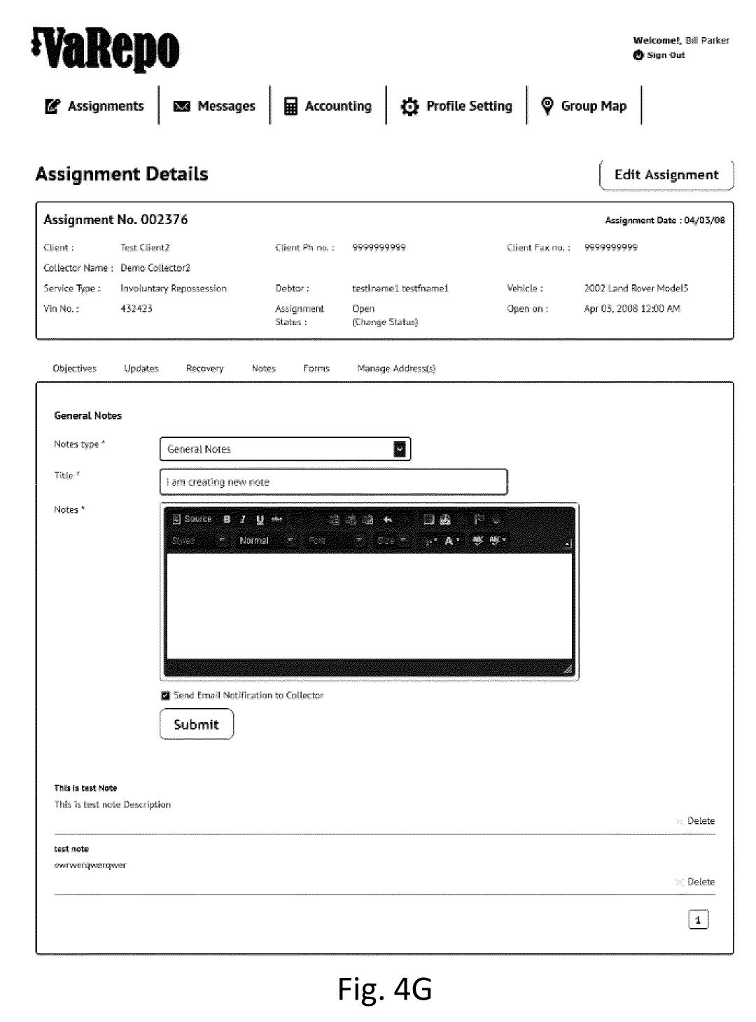

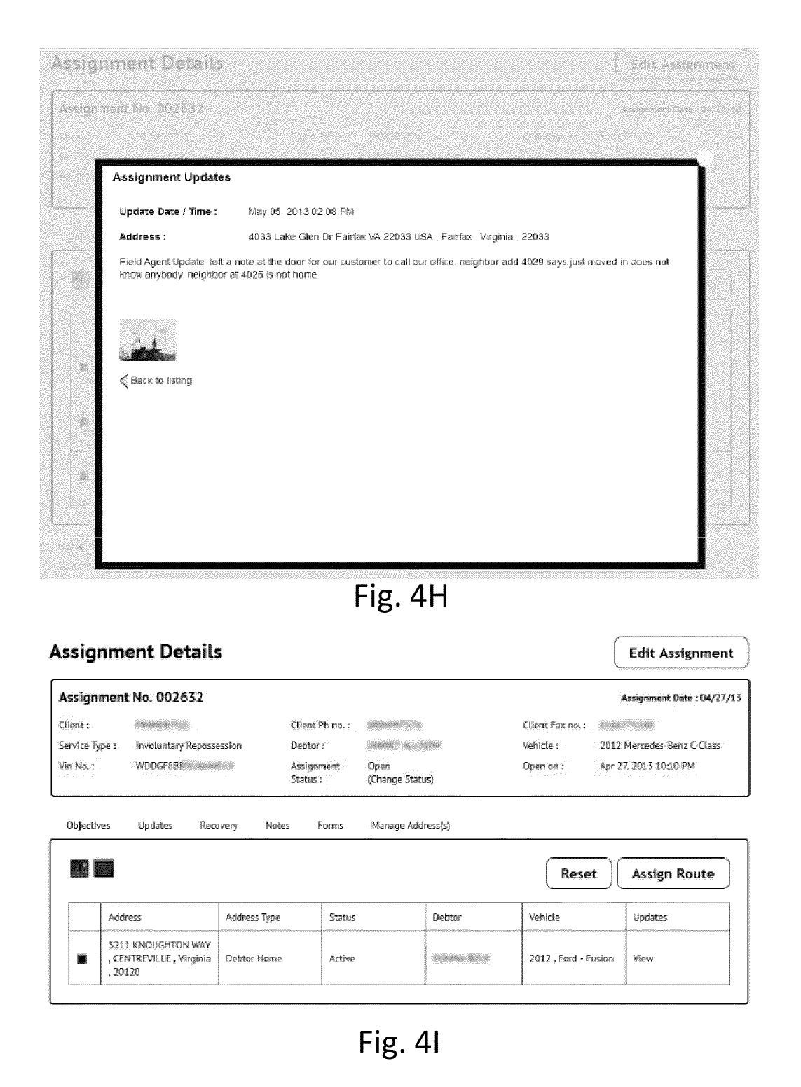

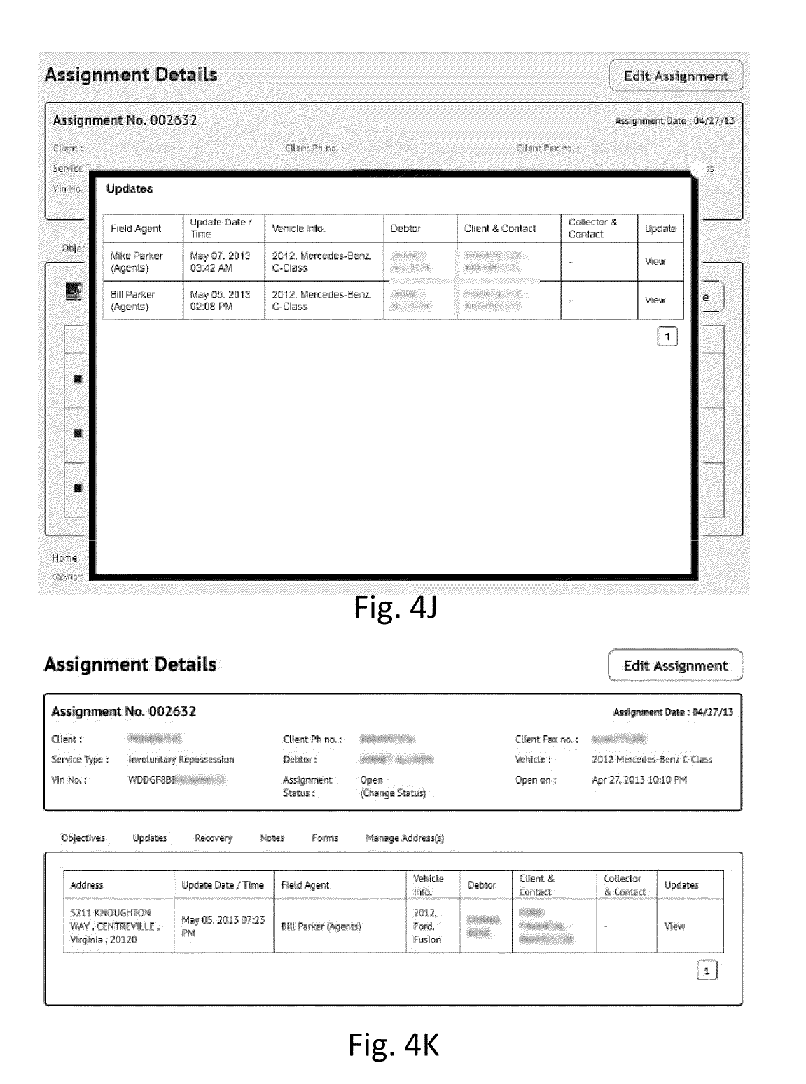

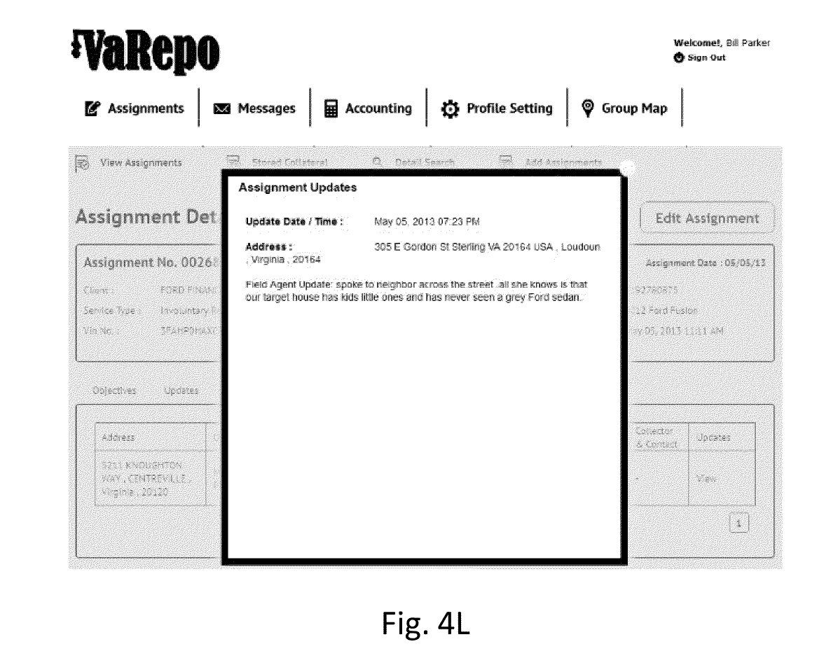

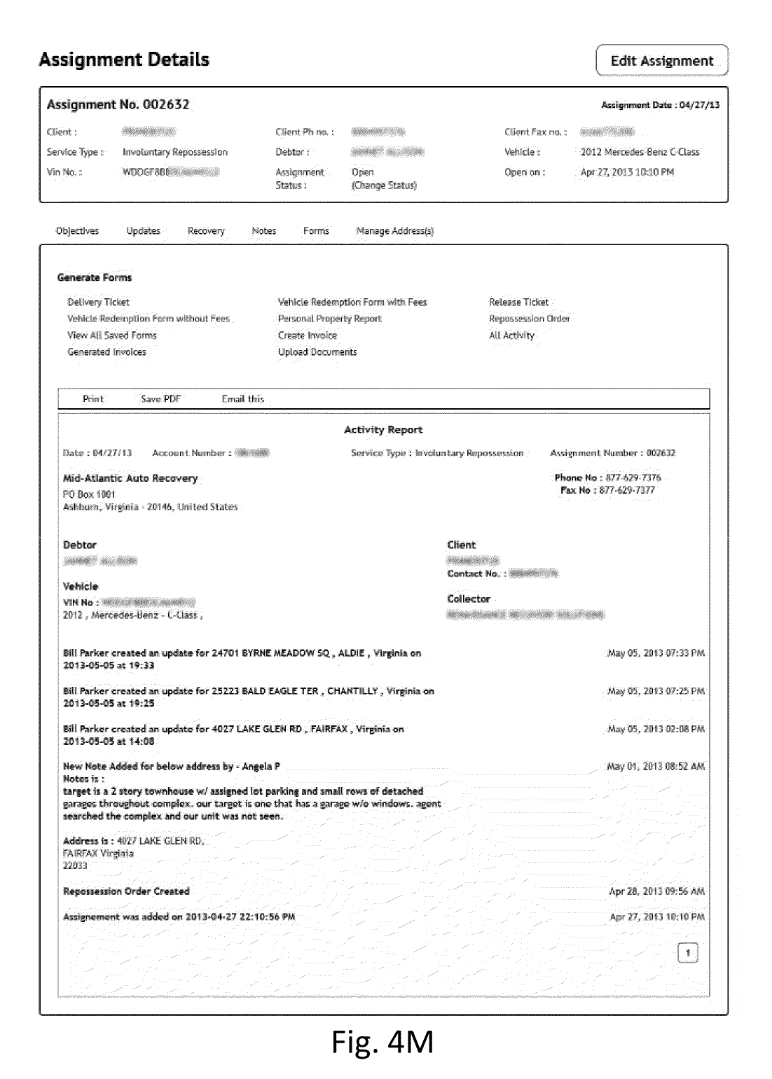

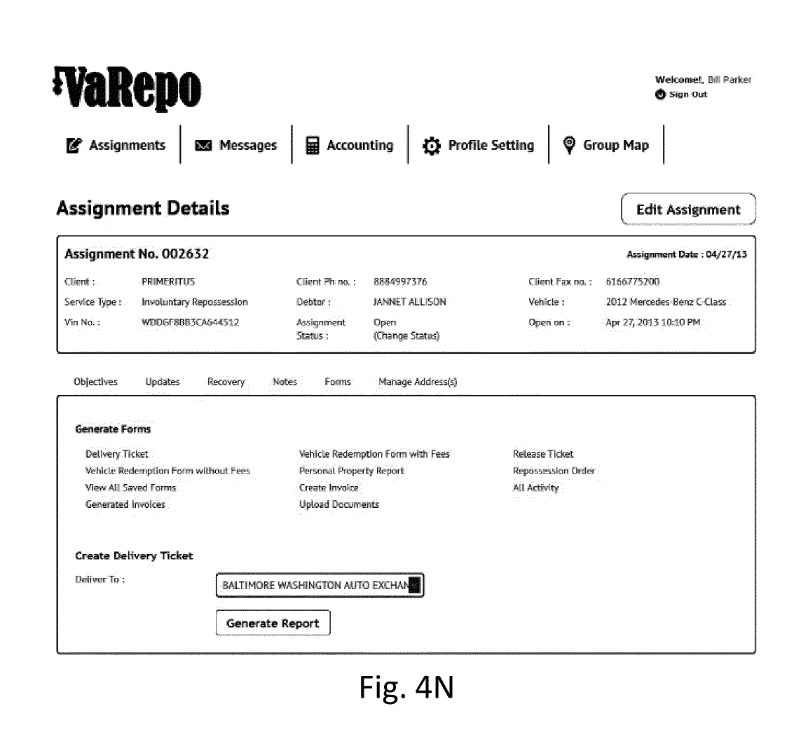

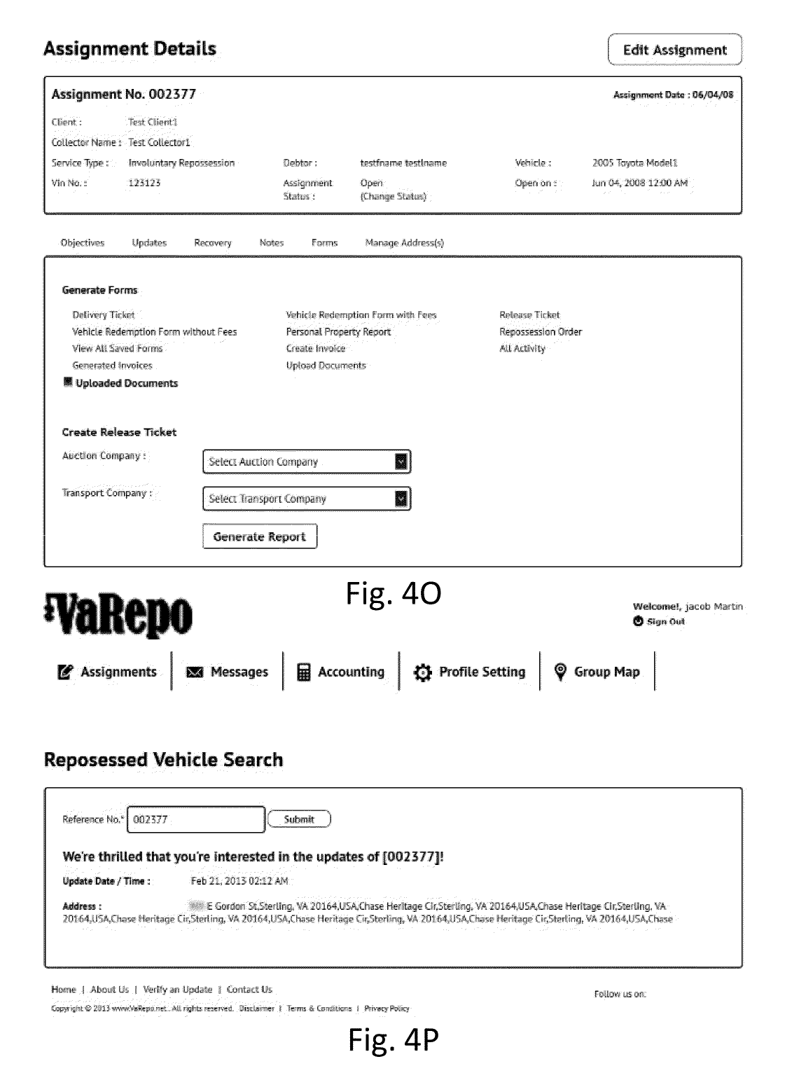

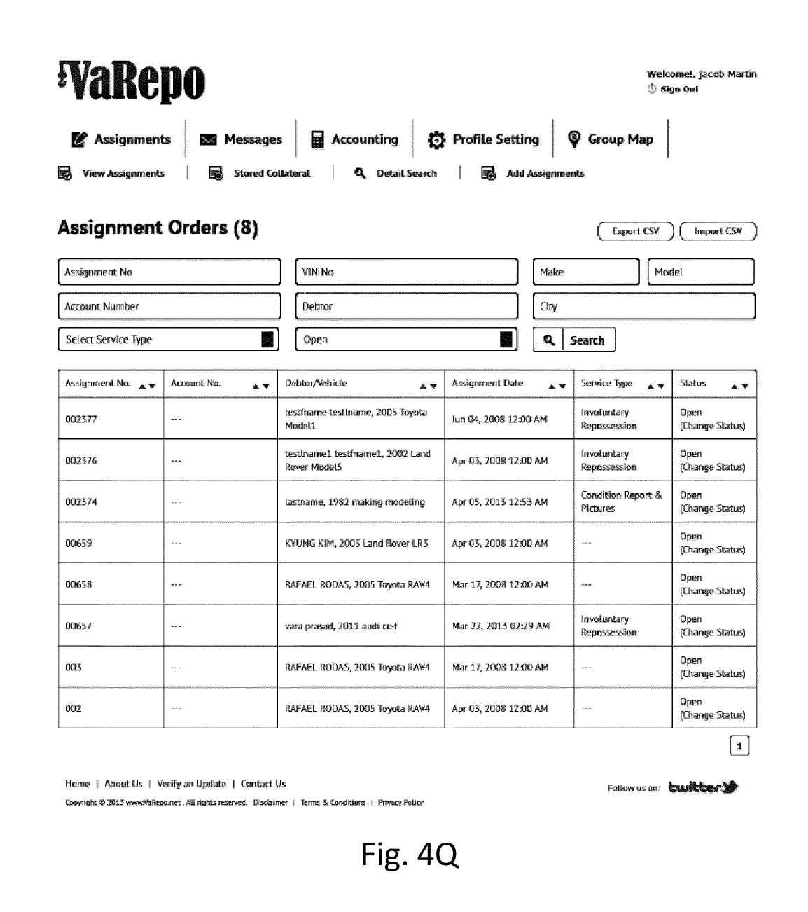

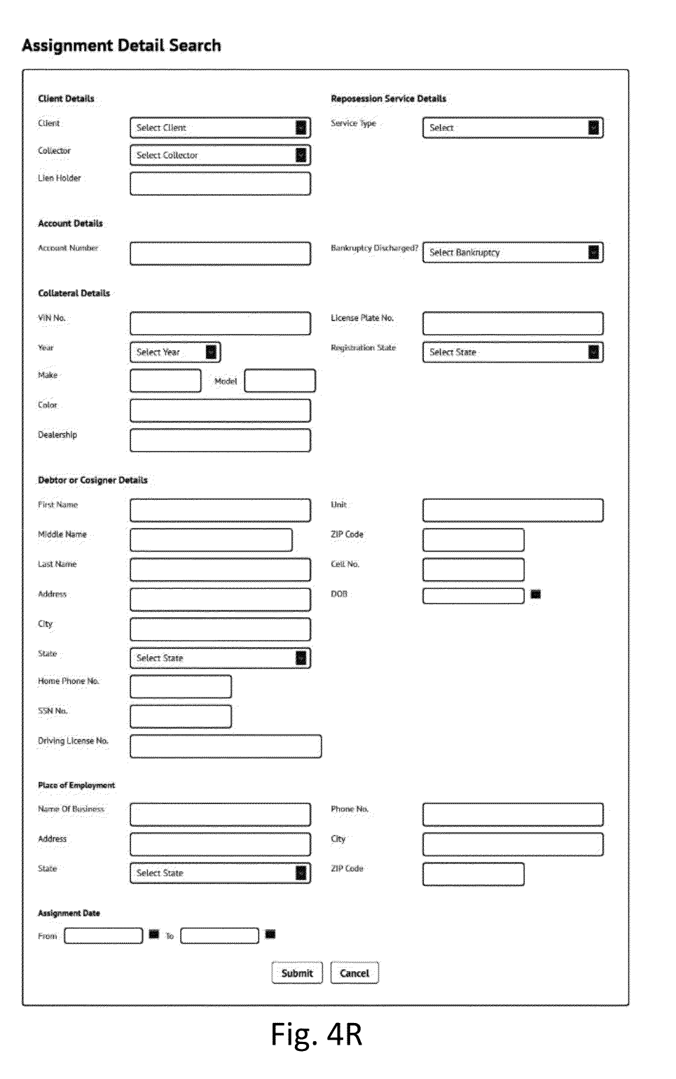

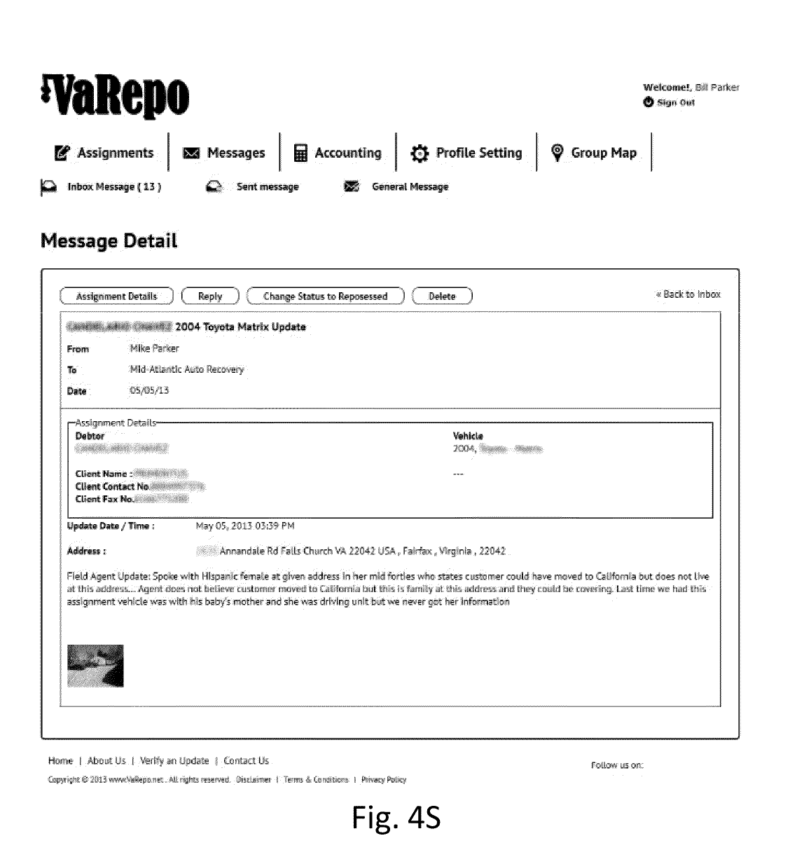

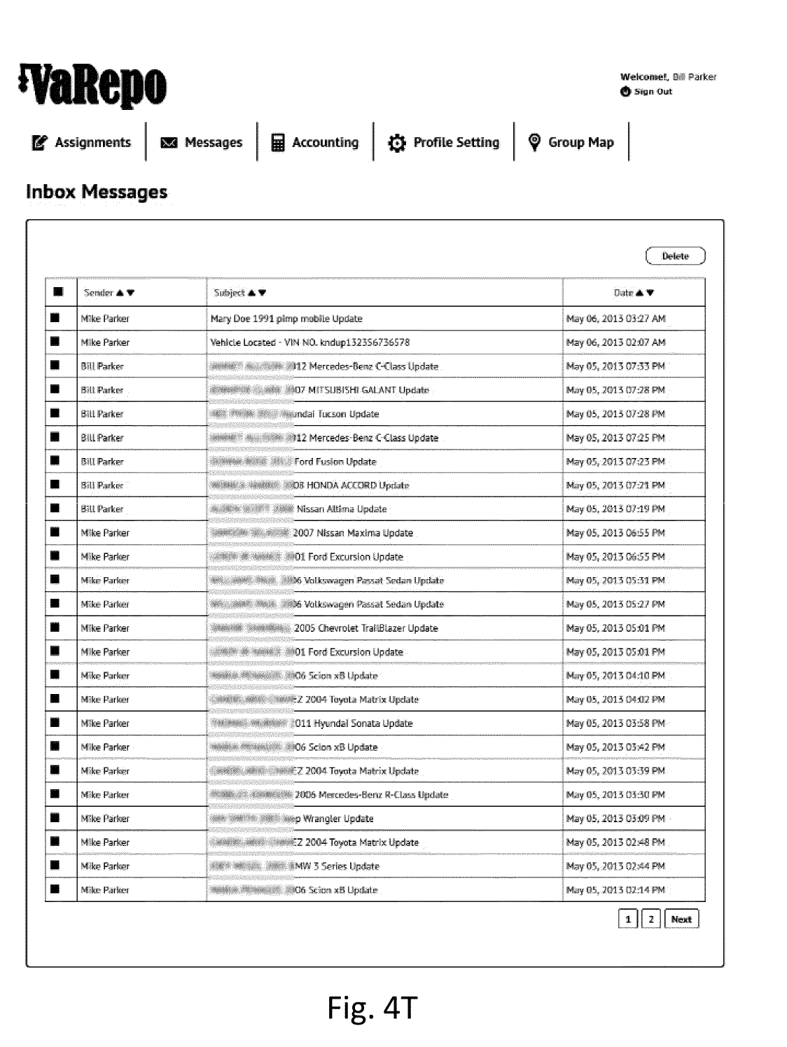

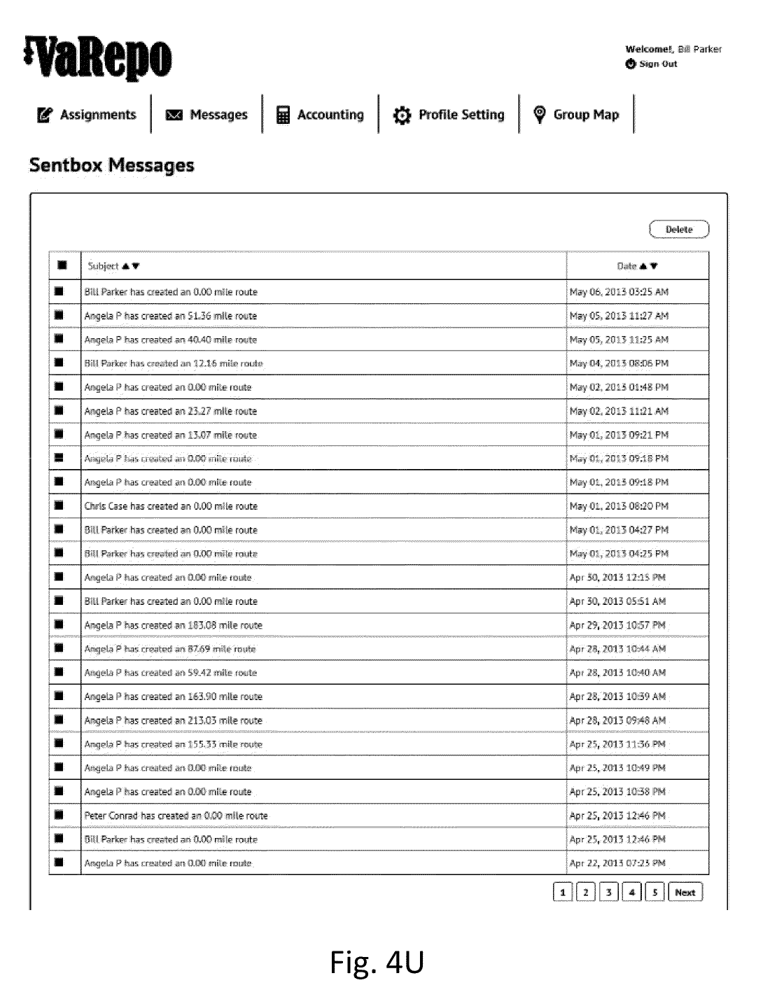

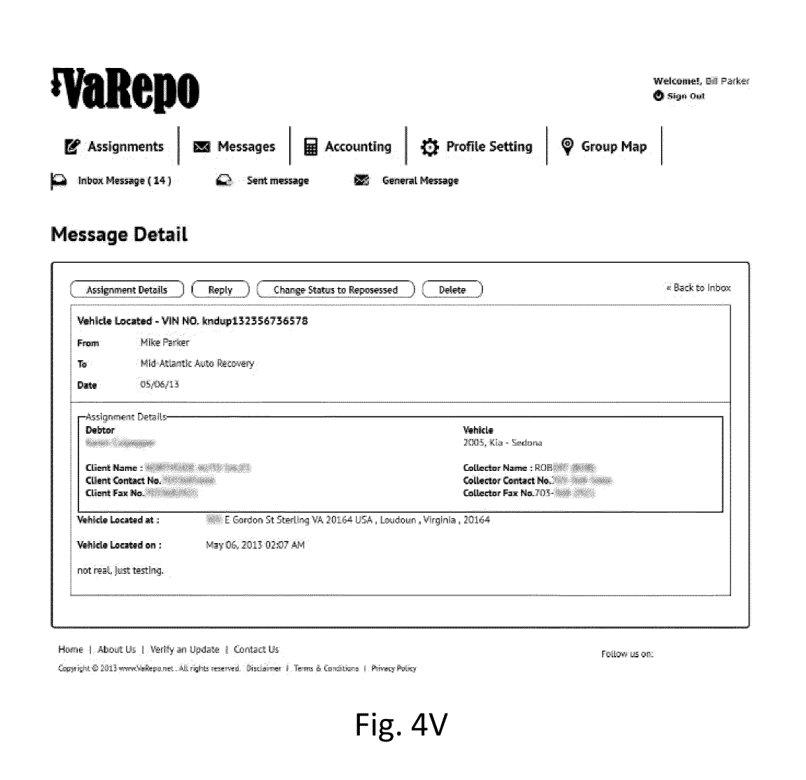

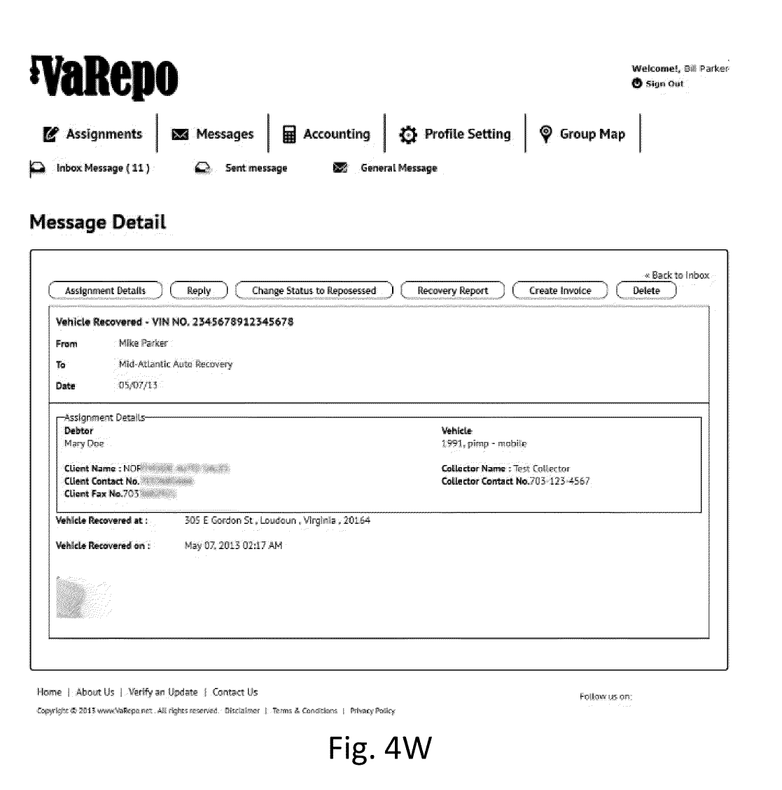

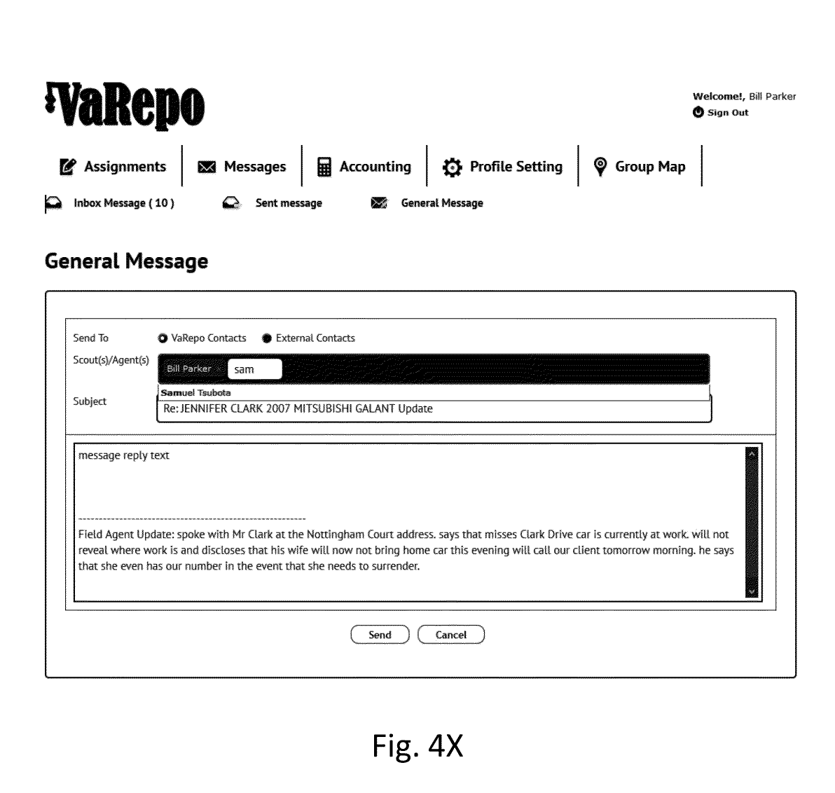

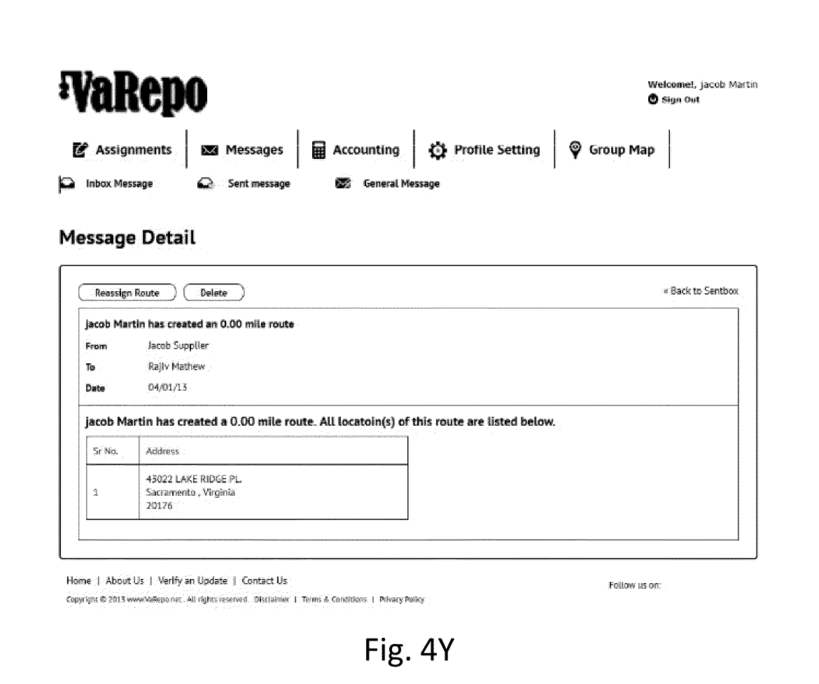

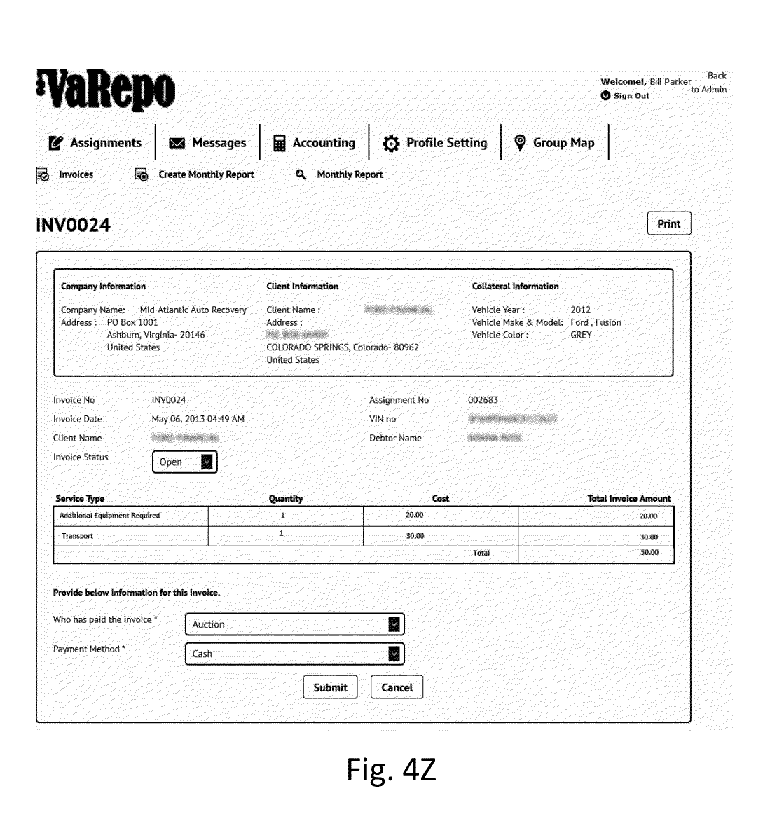

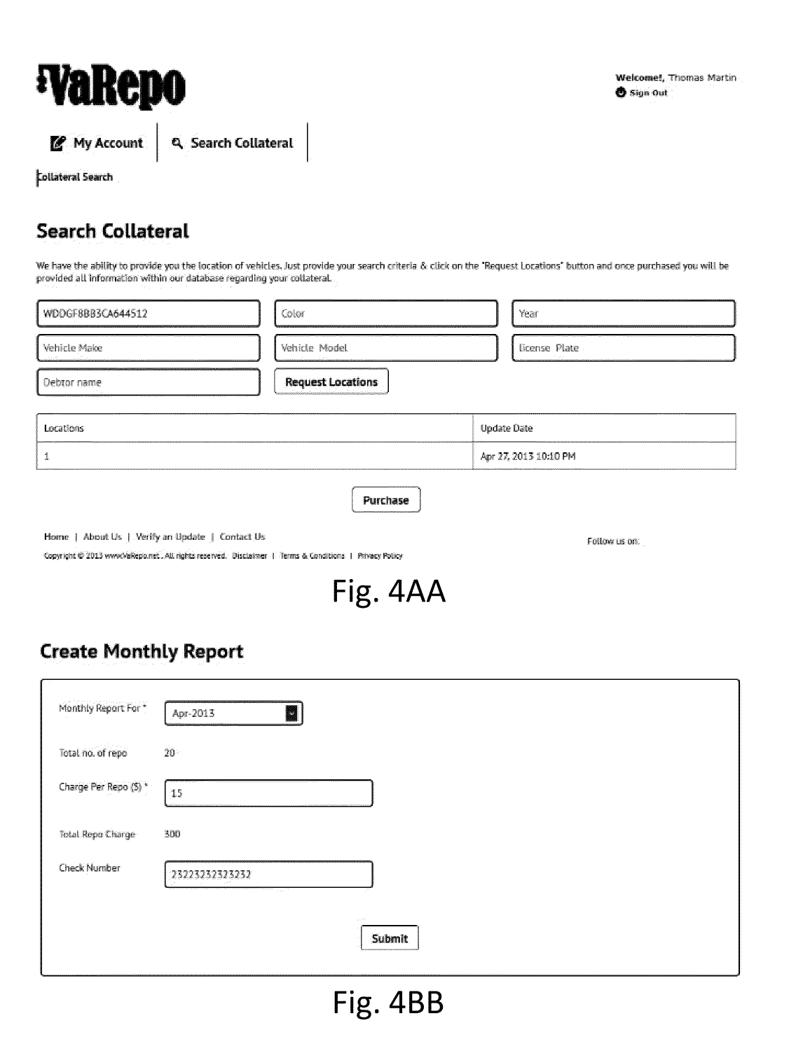

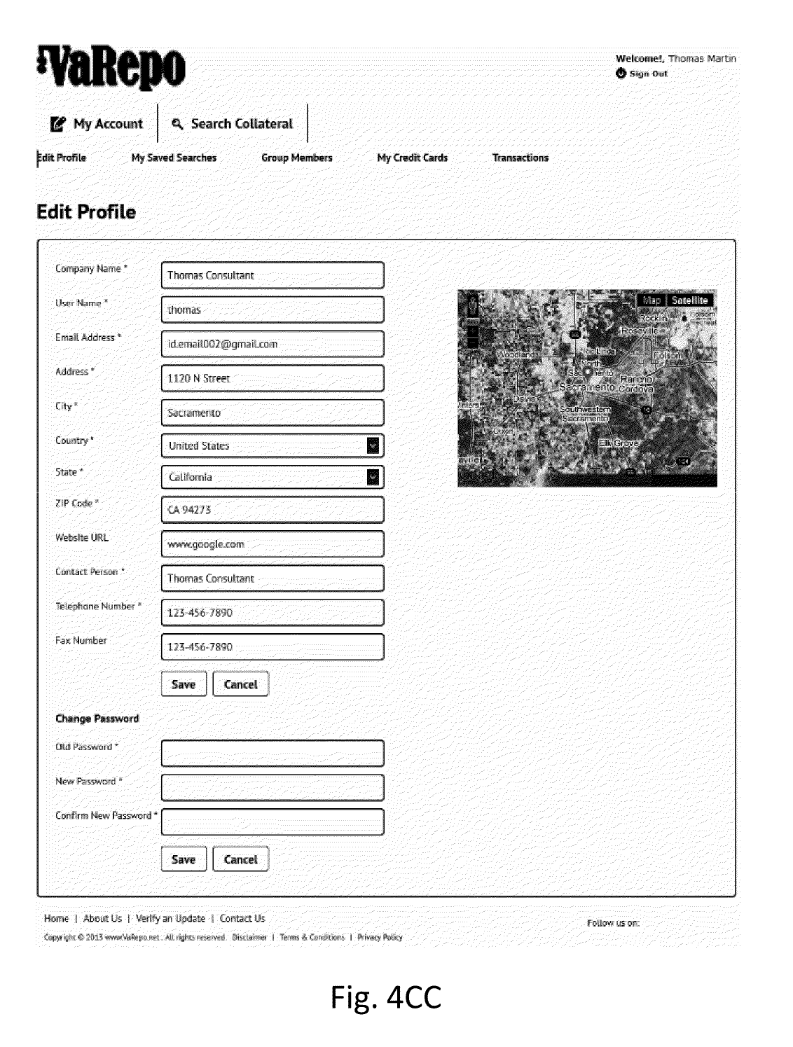

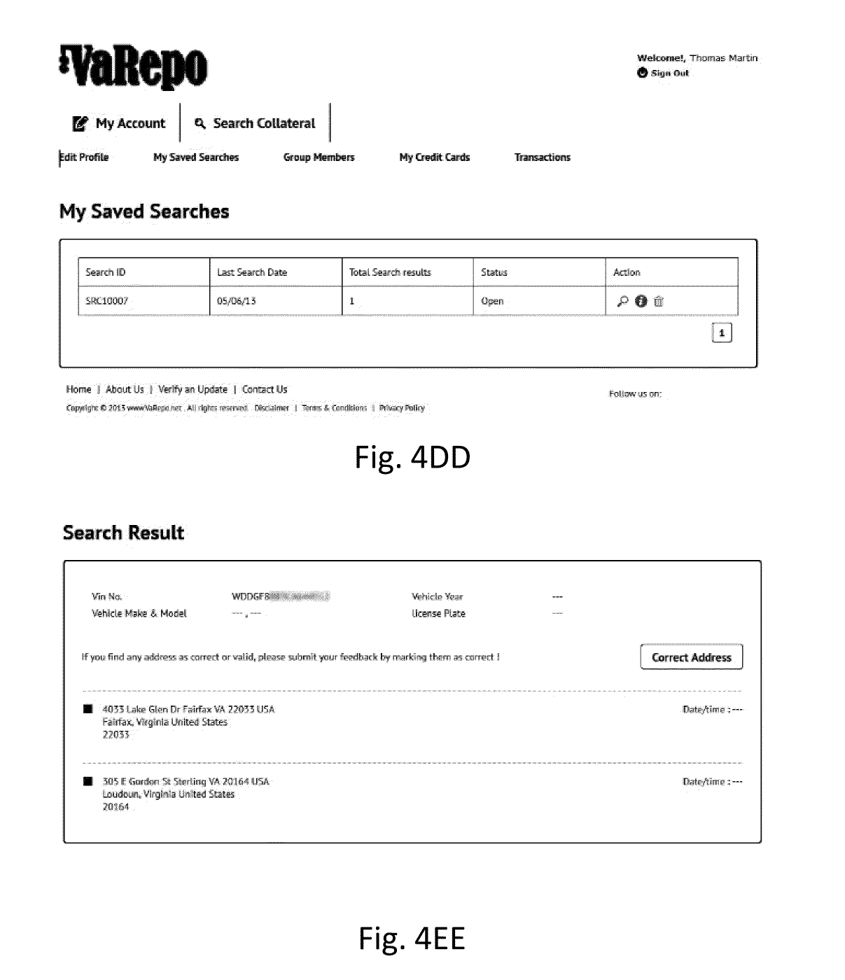

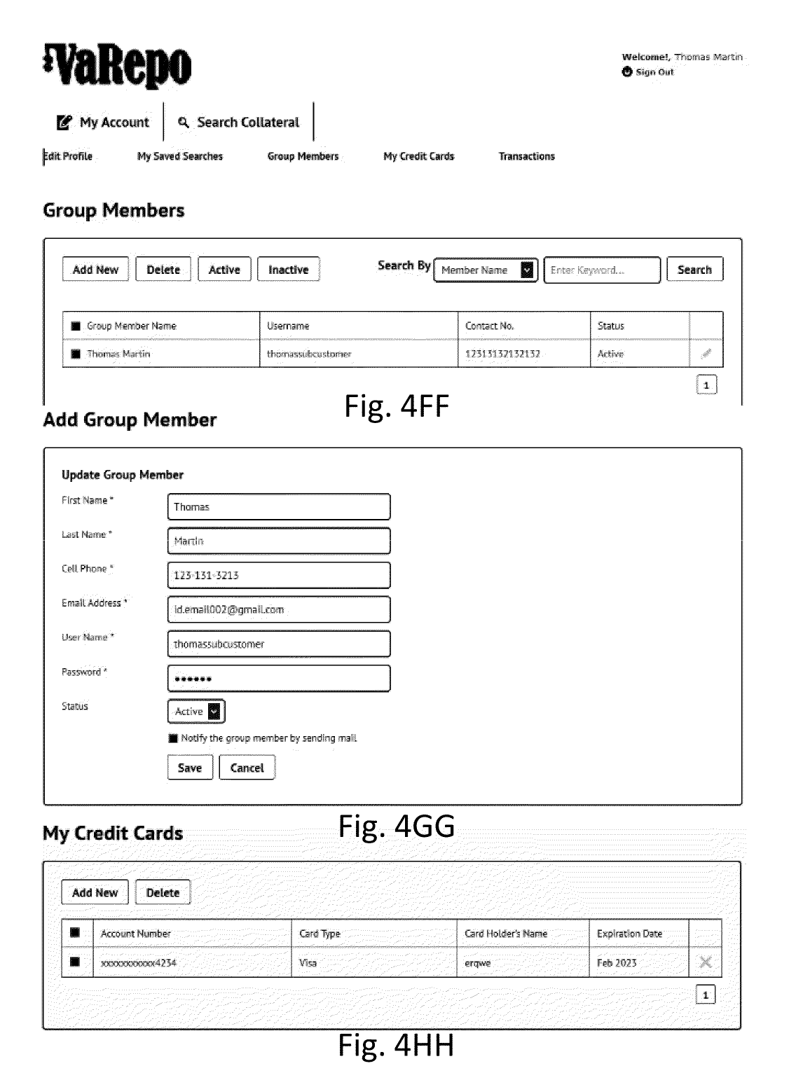

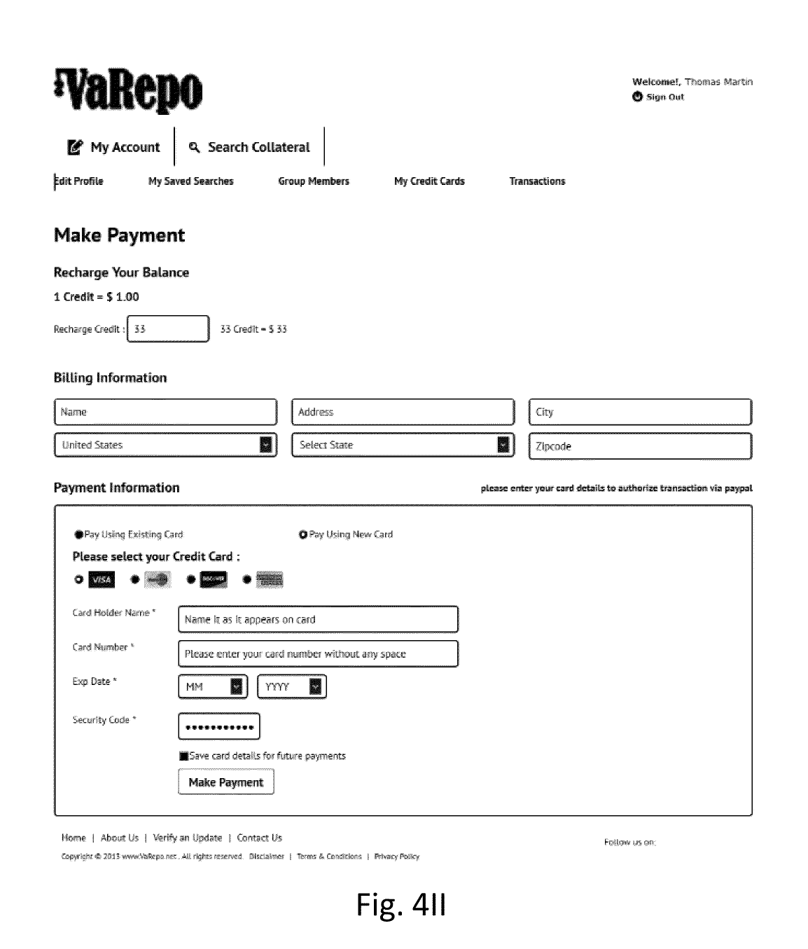

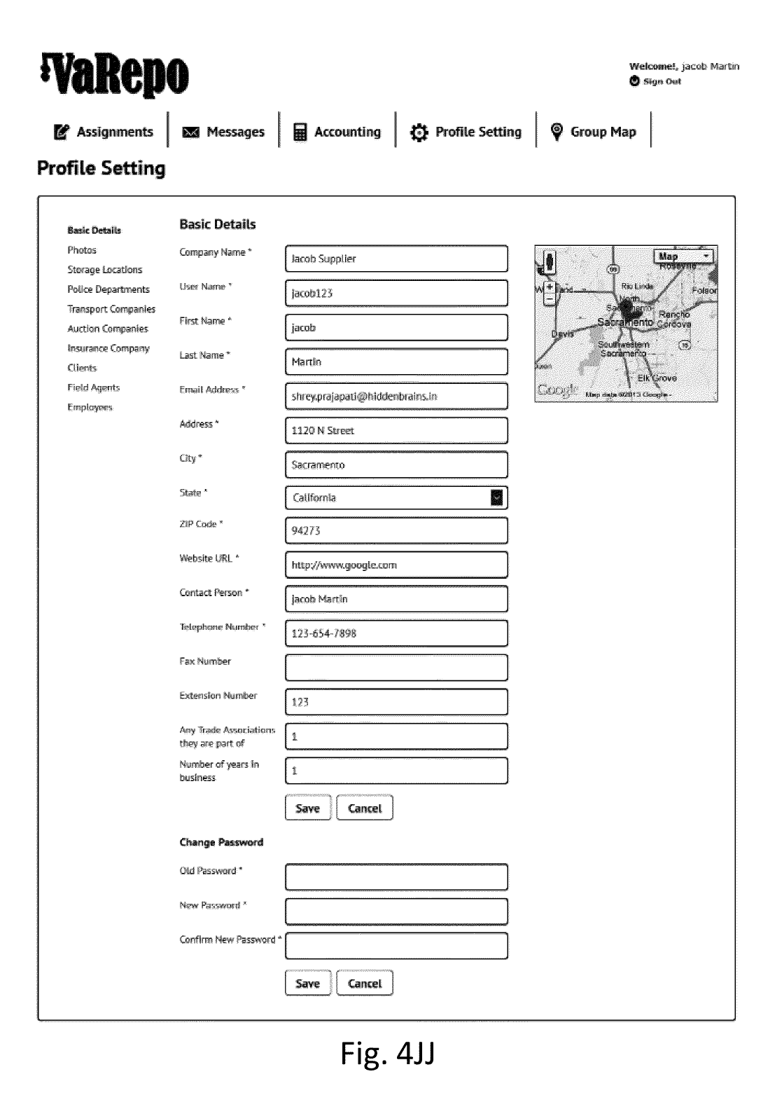

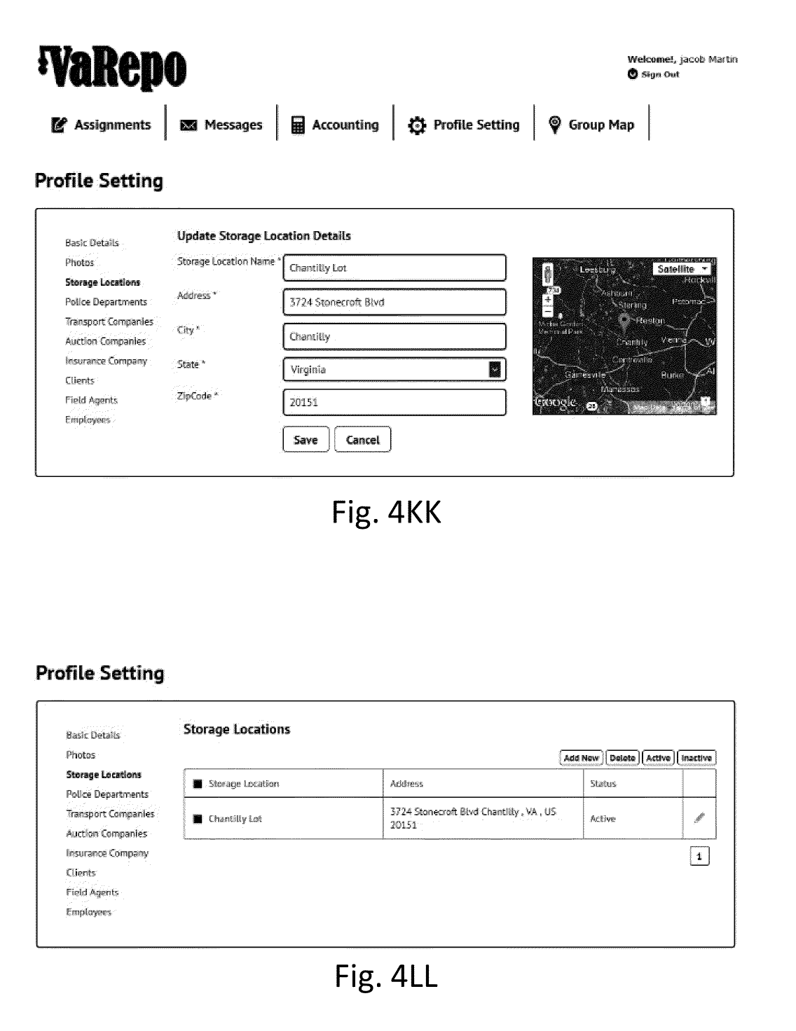

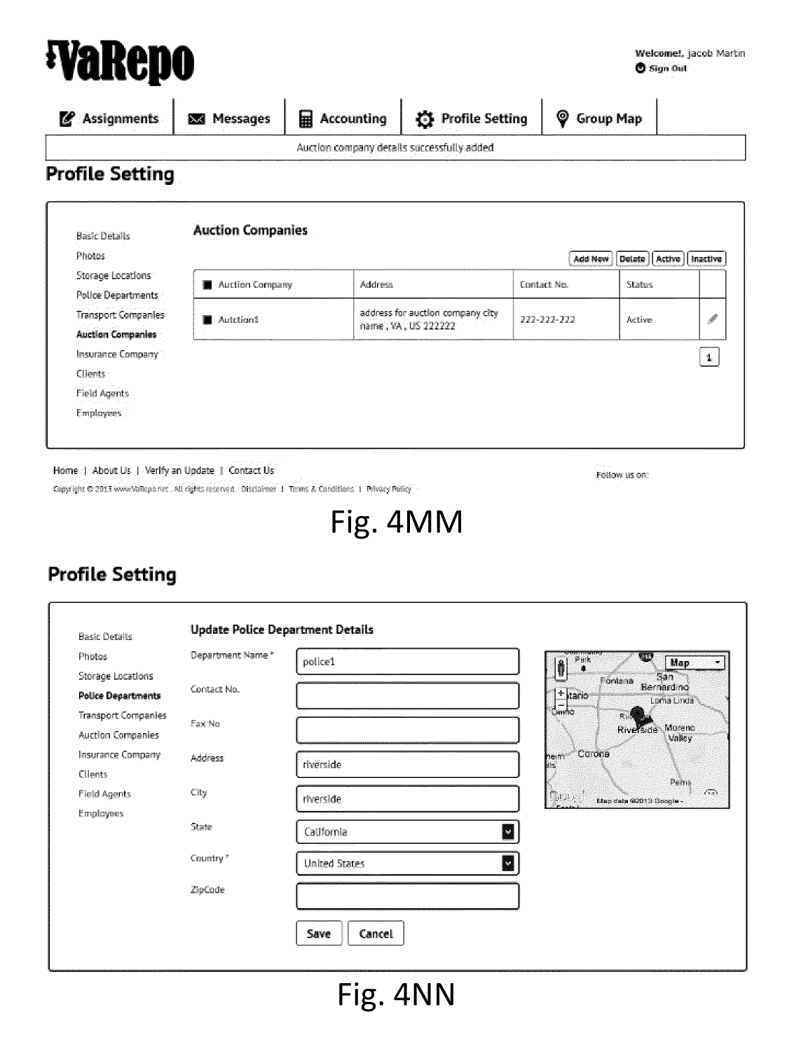

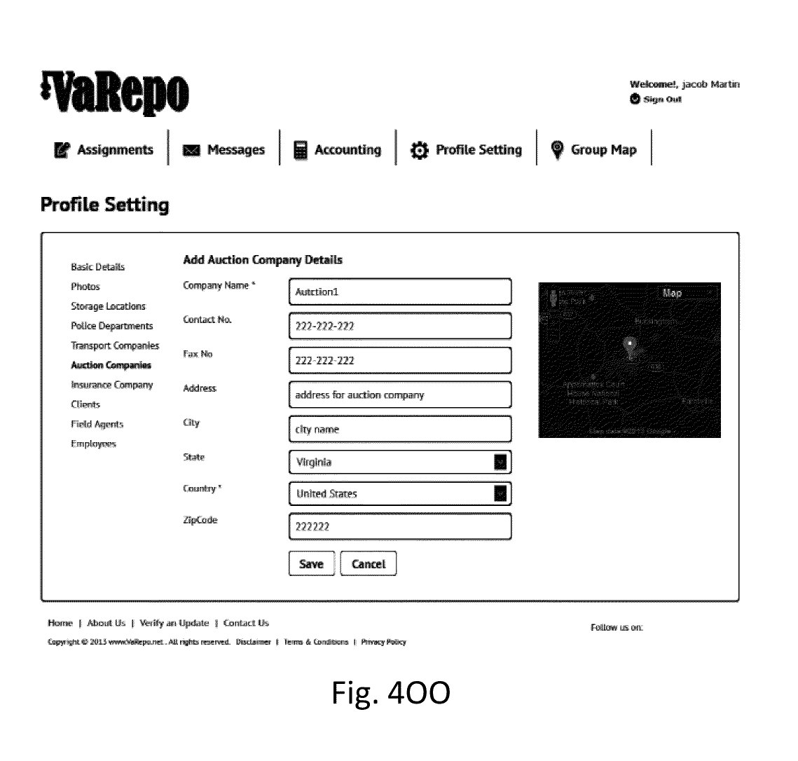

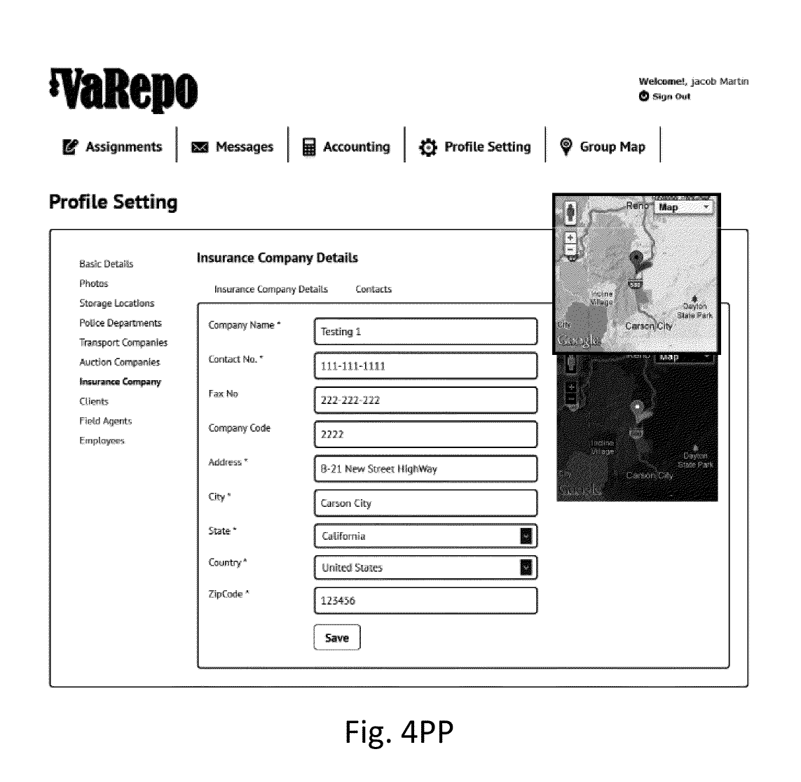

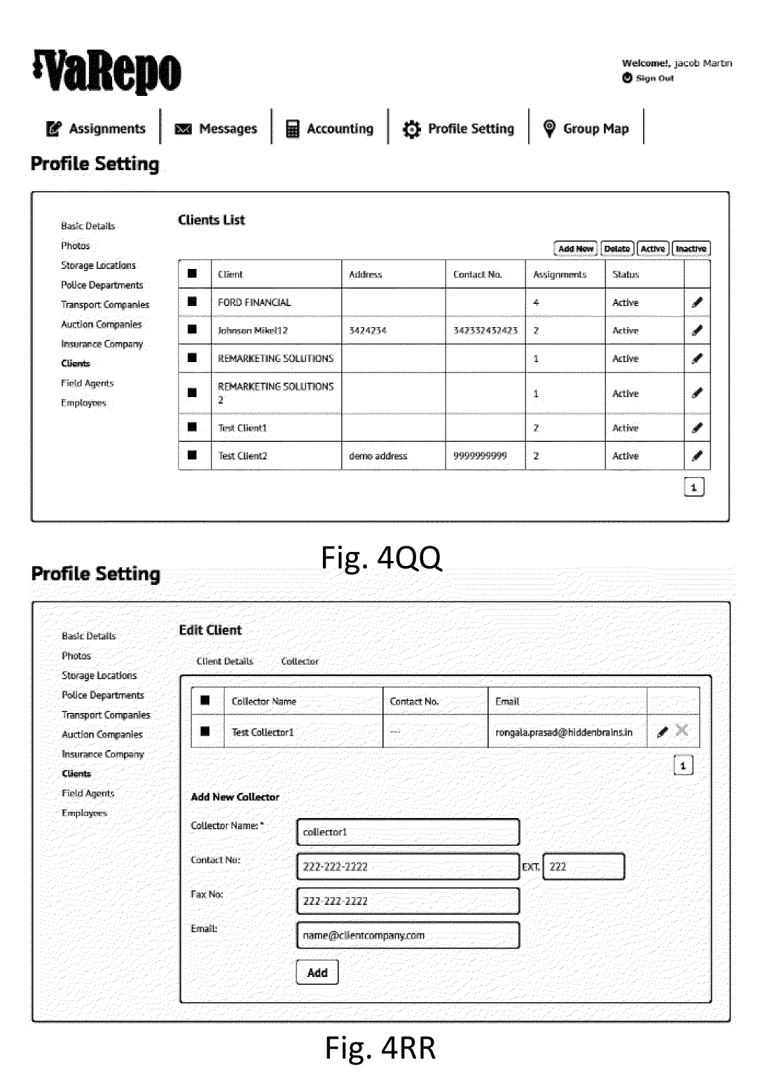

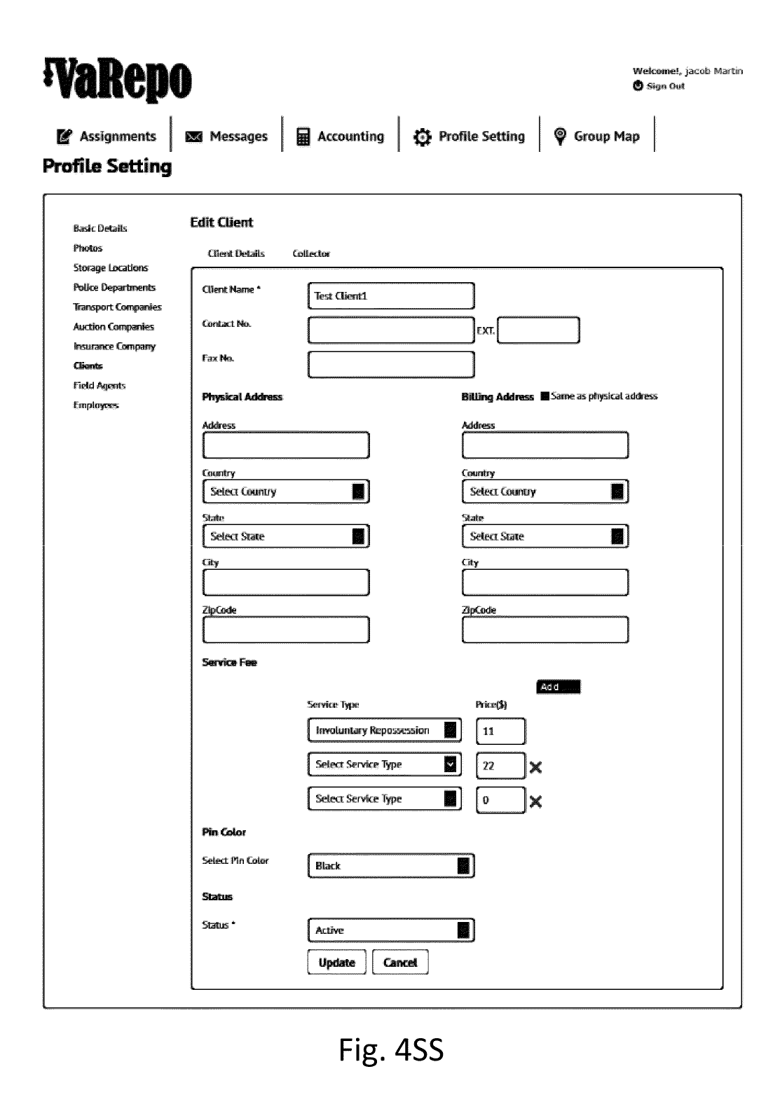

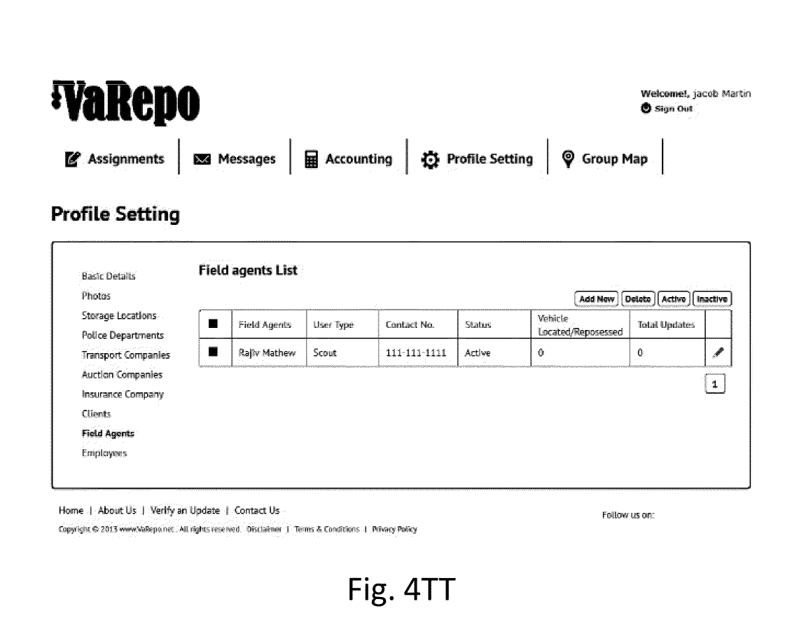

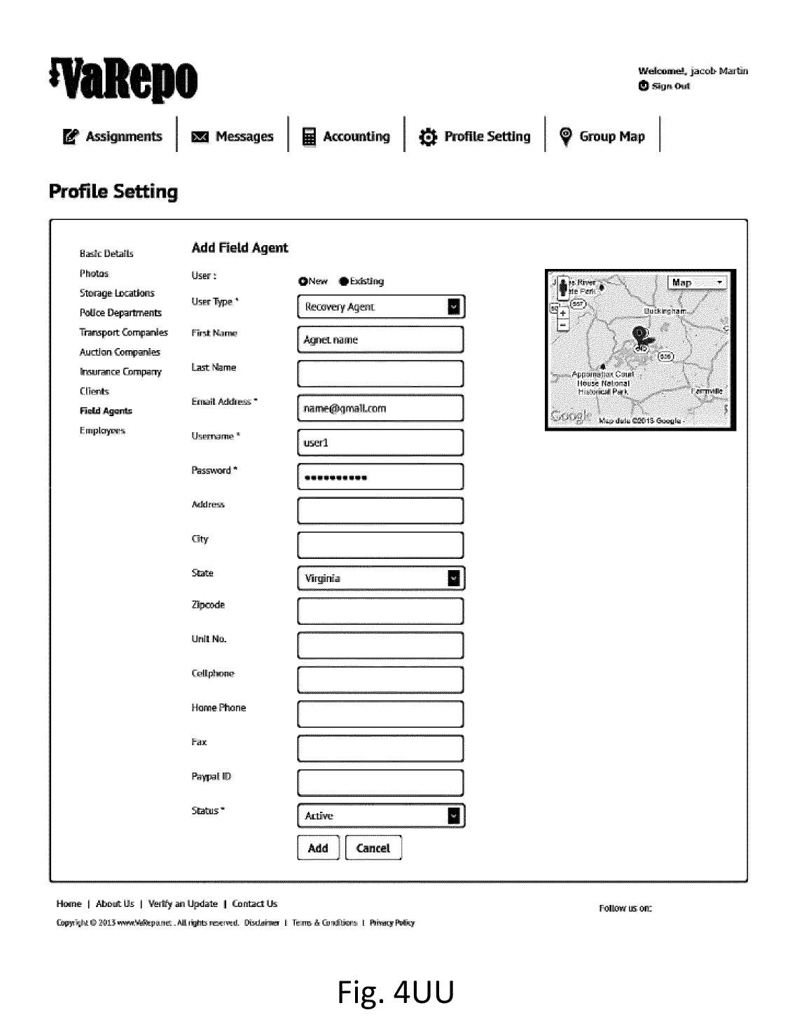

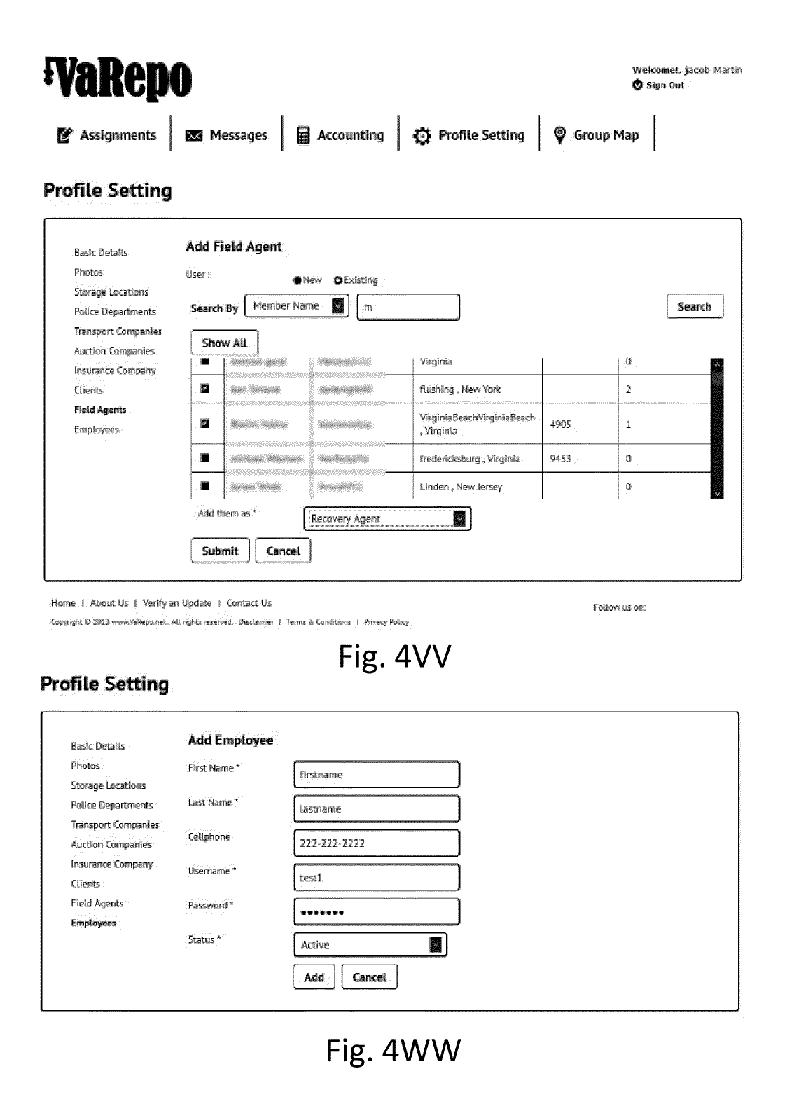

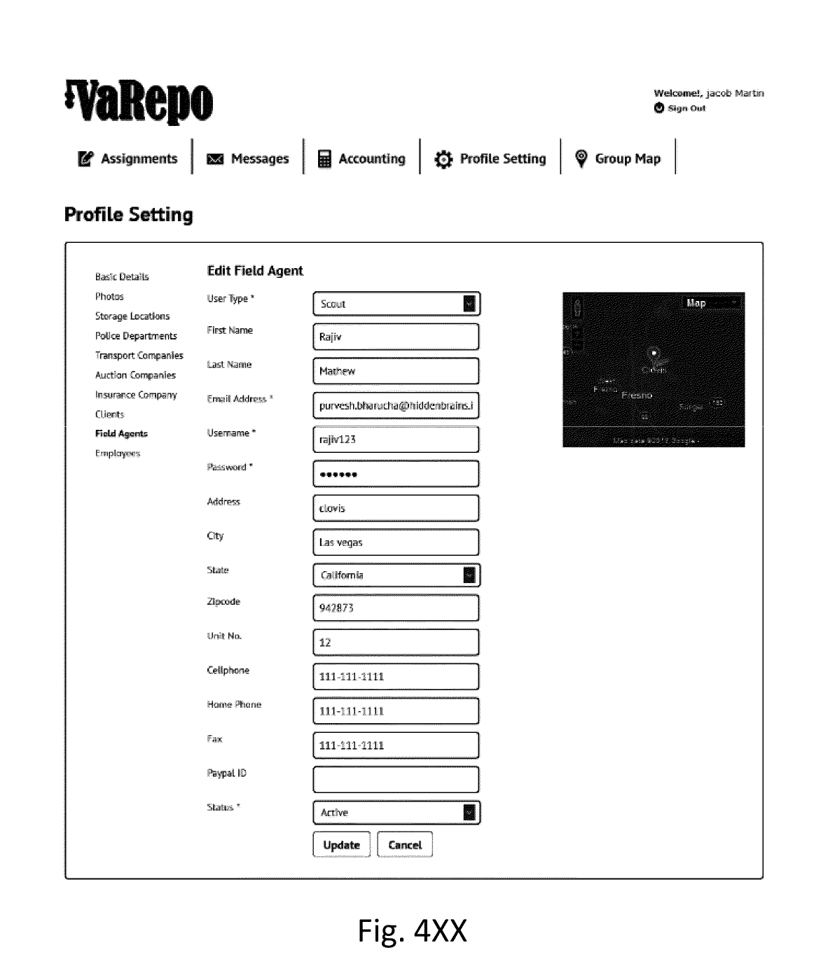

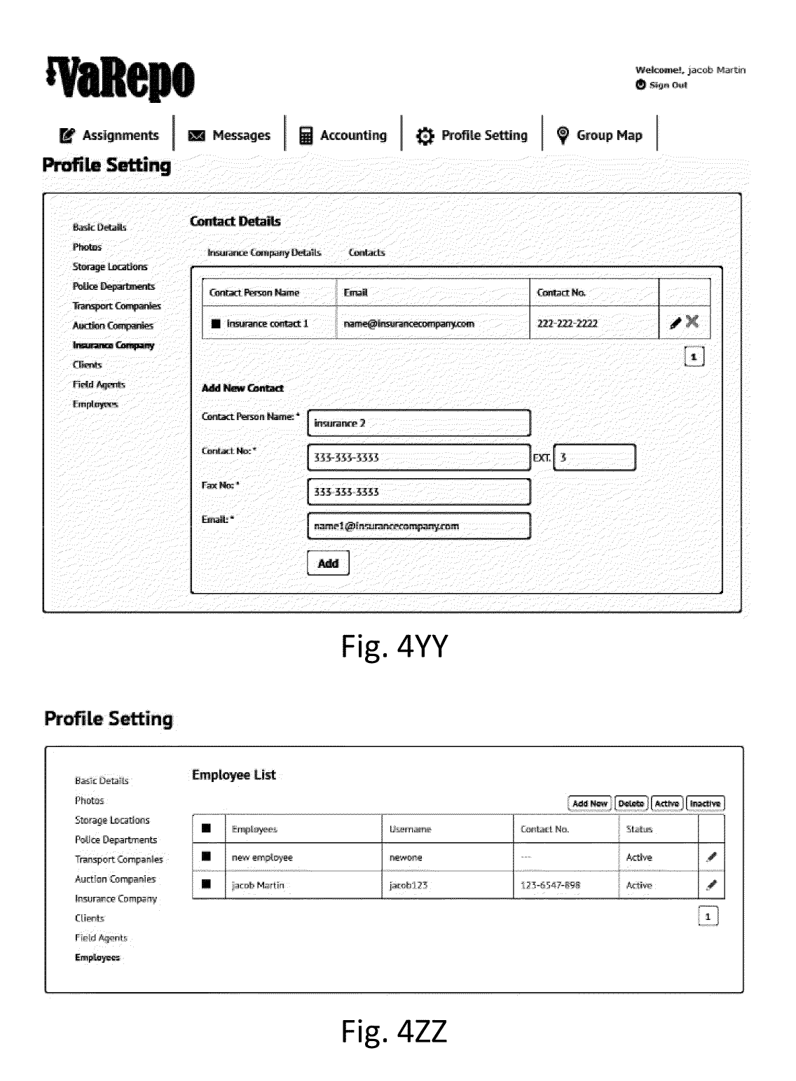

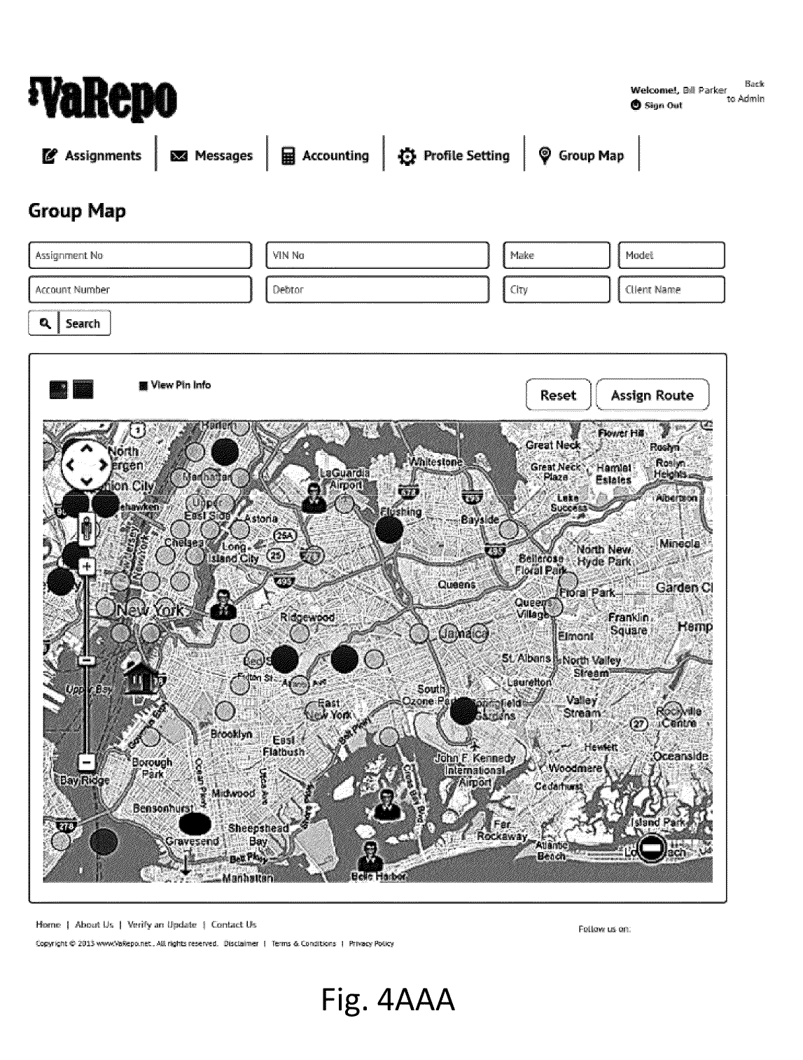

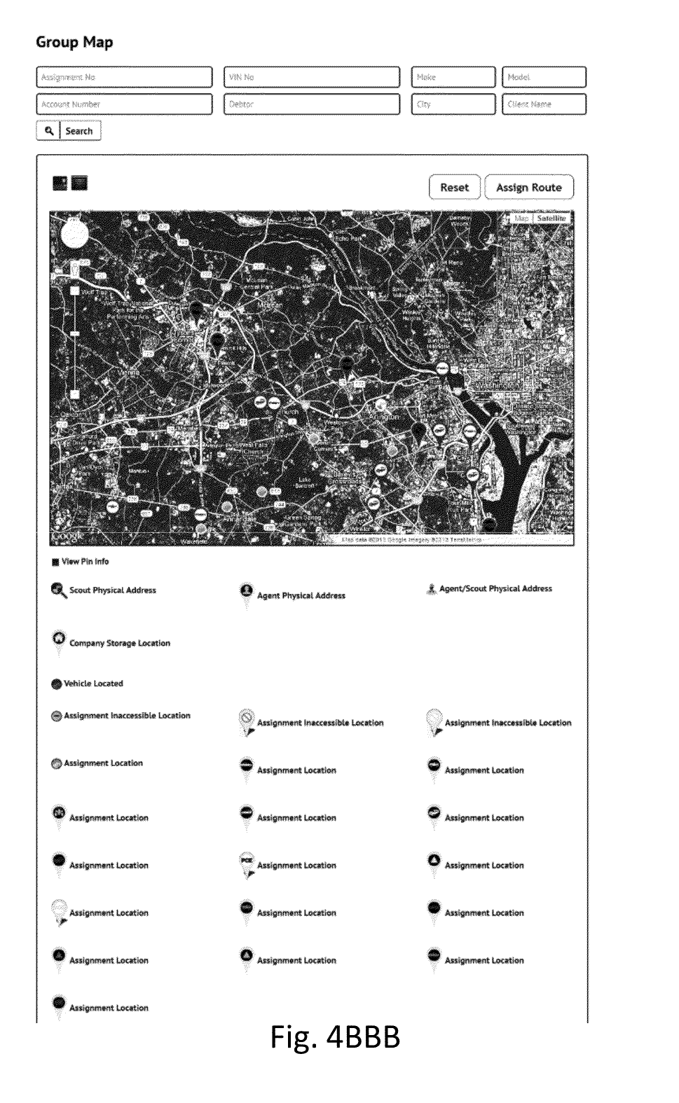

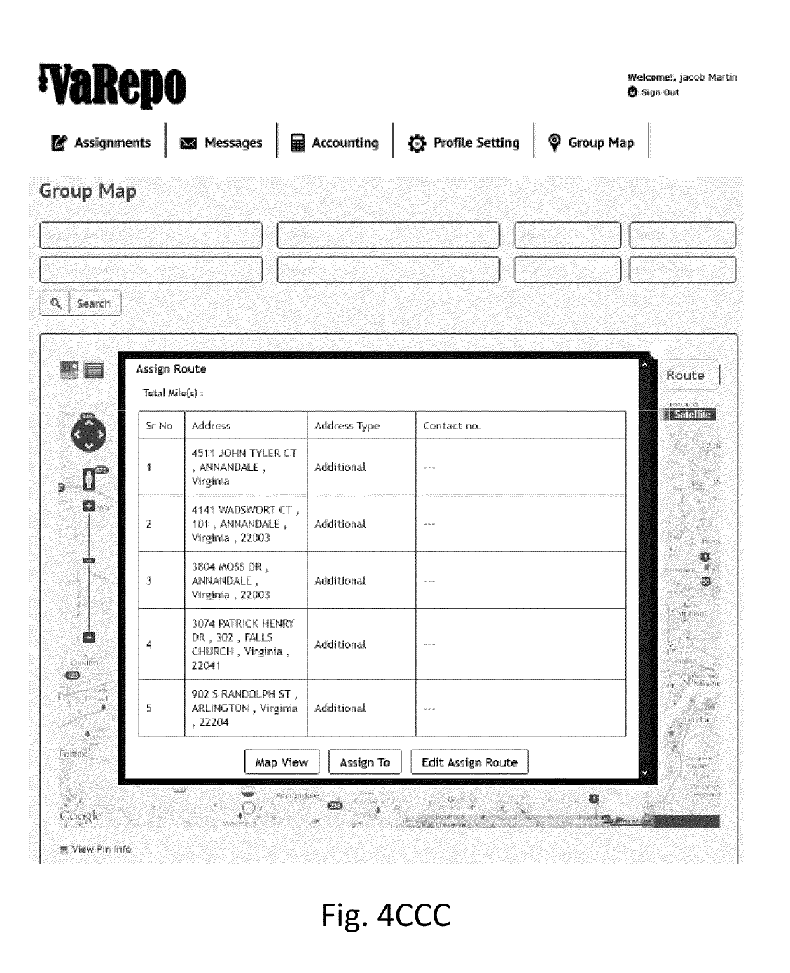

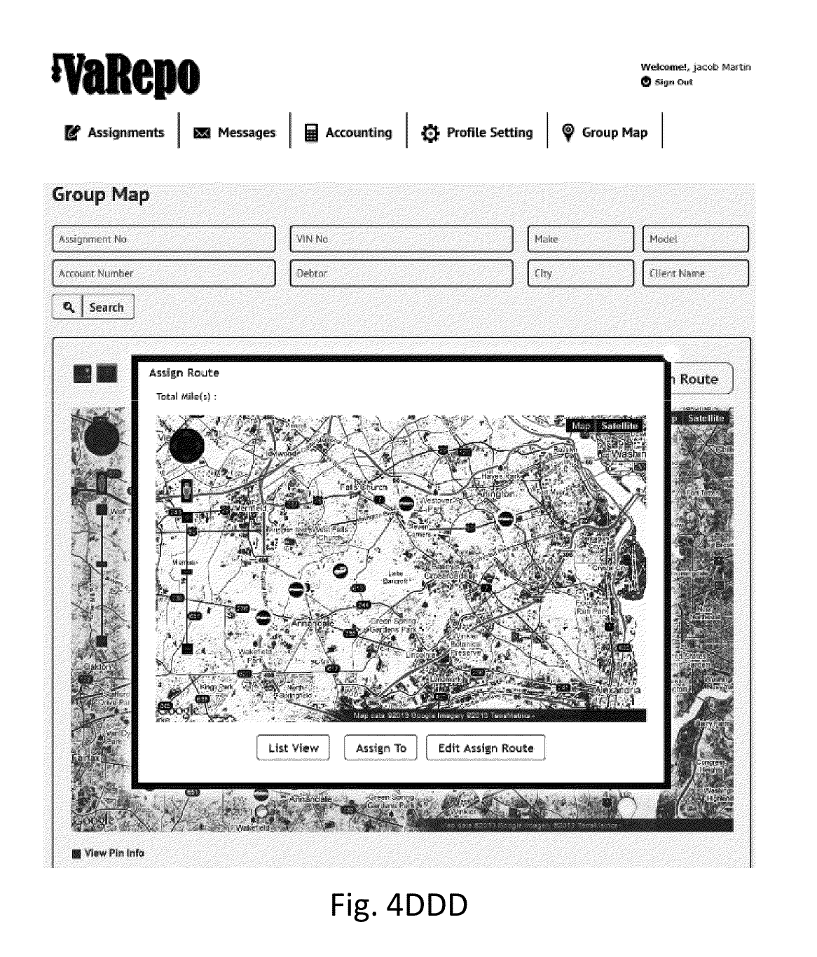

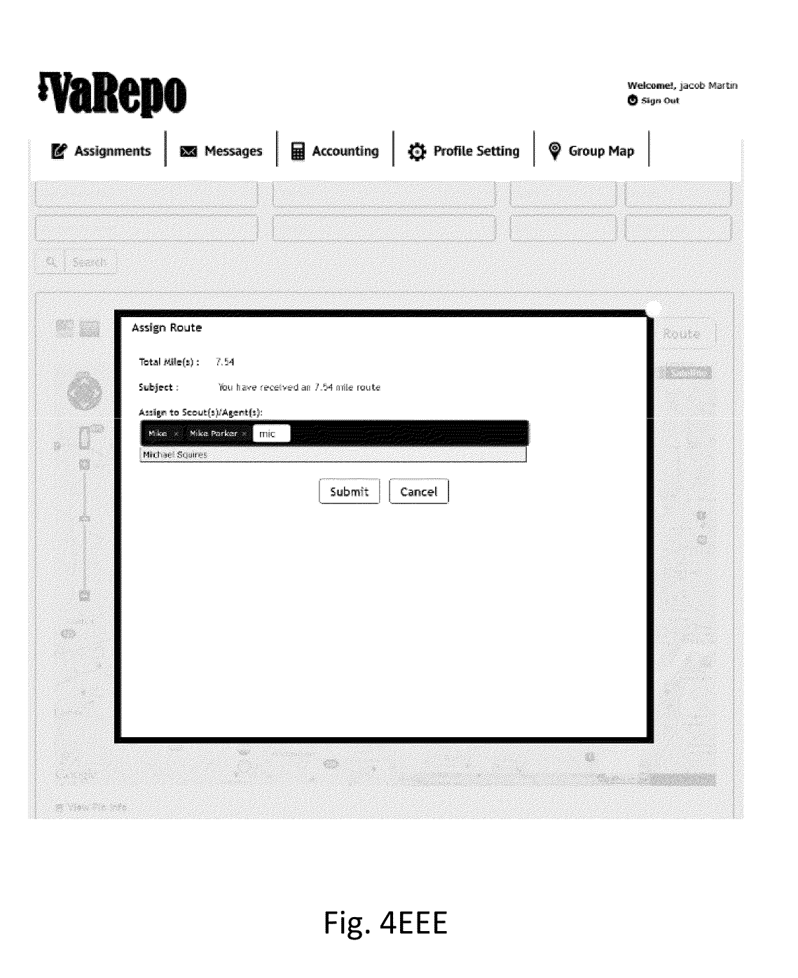

As will be understood more fully from the description below, the inventive system is the first computerized repossession tool which has a centralized web-based server program that integrates with its own smart-phone application. Screenshots of the server program are shown in FIG. 4. This innovative integration of the centralized repossession program with the smart-phone application results in efficient operations that had not been previously possible with standard repossession software systems. The system can generate unique information about any address and any vehicle in the country in a way that information can be organized and transferred by repo companies using the system. Additionally, the public information that is generated by any smart-phone user can be captured by the system and compiled in one place to assist the nation in locating assets or persons.

Installation and Set-Up

Upon initial installation and opening of this scouting application, the user is displayed a disclaimer stating that the application does not give permission to trespass, updates should not be made in the application while driving, and other warnings. After acknowledging the disclaimer, the user is directed into the “Update: by Va Repo” online database and put through a series of screens that will register the user and software. The user may be provided with a randomly generated E-Mail address which could also serve as a unique username for accessing the database through the system's central server. This e-mail address is the e-mail address to which the server will send objectives or routes for the user to complete. The user creates a password corresponding with the unique username. The application is preferably formatted for use on a user's smart-phone or other mobile communications device, such as a tablet computer.

The username and password can be saved on the user's phone and automatically entered into the log-in screen so the user never has to enter it manually. If the user has the option selected to have their password saved on their phone, they will not see the log-in screen as they open the application and they will be directed directly to their “E-Mail Selection Screen”. If the user does not have the option selected to have their password saved, every time they open the application they will be directed to the log-in screen to enter their information and then to their “E-Mail Selection Screen”. The application may require the user to have a Pay-Pal account set up prior to installation of the “Update: by Va Repo” scouting application so that the user's Pay-Pal account can be linked to their Va Repo Database account.

Alternative Data Formats for Communications

In one embodiment, the scouts and field agents can run a smart-phone application that communicates directly with the system running on the central server. In this embodiment, the data can be formatted according to the standard data formats used for smart-phone applications on various platforms, such as Apple's iPhone, Google's Android, MicroSoft's Windows, RIM's BlackBerry as well as any other platform that may be developed.

In another embodiment, the user may receive an E-Mail containing all of the information required for them to complete their route. The format in which the user preferably receives the route information is shown in the table below followed by an example. An exemplary e-mail is also shown in FIG. 3I.

```
    E-Mail Format Table
    1st line - Enter the Address
    2nd line - Enter vehicle Year, Make and Model.
    3rd line - Enter either the entire VIN or the Last 6 of the VIN and
    Color.
    4th line through any additional lines needed - Enter any
    additional information
    Skip a Line to Separate Objectives (Blank Line)
    Repeat for any additional objectives
EXAMPLE:
“ 123 main st sterling va
  2002 ford mustang
  123456 blue
  963 alabama ave alexandria va
  2008 hyundai elantra
  223456
  be sure to check the alley out back. ”
```

This innovative format for communicating multiple objectives can be used in other types of task reporting systems and is not necessarily limited to the repossession industry. According to one aspect of the present invention, the objectives can be sent in a single e-mail, and the user's task application (such as the scouting application particularly described herein) can parse each one of the objectives according to the blank line between the objectives.

It will be appreciated that although one embodiment uses a formatted e-mail as the input to the application, the system could also be started with a text message or any other electronic communication from the central server to one or more scouts and field agents that are running a smart-phone application that communicates directly with the system running on the central server. For example, the system may just send a text message or even an automated call that a new set of objectives are ready for a scout and keep the objectives within the centralized server. When the scout runs the application and enters a unique user ID and password combination, the application could log into the server through a secure link into the server and receive the objectives during the secure interactive session. As discussed below, the application preferably captures the sequence of end user selections (such as the button selections) throughout the update process and sends this sequence to the database where the return update is created and sent back to the mobile device for the end user to review. In creating a return update, the database will use the exact text from the first line of information for that objective as the title of the return E-Mail. If desired, no additional information needs to be entered beyond the first line. This allows the end user to have a simple route sent to their smart-phone that can help them navigate through several destinations that may not be repo oriented.

The option to provide routing information to an end user may be helpful for a contractor, a plumber, an electrician, a house-call physician or any other service provider who may have a number of service calls to make, such as any business which provides for deliveries of goods or other packages, such as by a courier, a florist, a grocery store, a pizza parlor, etc. The system according to the present invention can be designed to provide particular queries based on their services or may interface with another application that is specific to their field. For example, as discussed in detail below, when a user comes within a specified distance of the objective location, the system can notify the user. This notification may be linked to a selection option which allows the user to launch another specialized application for the service provider's particular task.

E-Mail Selection Screen

This screen shows the user any E-Mails sent to their “Va Repo Database” E-Mail address within the last 24 months. This screen allows the user to view the E-Mail title and the Data/Time each E-Mail was received. Each E-Mail is displayed as a selectable box and selecting any box with a short-hold directs the user to the “Objectives Screen” for that E-Mail. Selecting any of these boxes with a long-hold will display a pop-up window that allows the user to Delete or Forward that E-Mail. This screen may also display the total number of tags the user has entered into the database. This screen can also display an icon to allow the user to create a “Random Tag Update”.

### Objectives Screen

This screen shows the user all of their objectives within whichever route they selected on the “E-Mail Selection Screen. The objectives can be viewed as either a list view or a map view as illustrated in FIG. 3, and the view can be toggled by the user at any time by selecting a “change view” type of button on this screen. If any objective is selected, such as with a “long hold” operation, the application may overlay a selection screen that provides the user with an option for a particular action. For example, a selection screen may allow the user to select a navigation tool to a selected address or an internet search of the objective.

List View

The user is displayed a list of all objectives within their route and given selectable buttons for each objective. The list is created by compiling the first lines of every objective within the route and this list will be displayed in the same order in which it was entered in the E-Mail. The exact text within the first line of each objective will be used as the exact text for the selectable boxes. Selecting any objective will display a window that has all information about the objective. The information can be displayed in the format that it is presented in the e-mail.

The information in the first line is selectable and will allow the user to navigate to the destination. This can be done by using the text of the objective as a search in navigation software that is also installed on the user's phone. If the user is already within the “Required Distance” (described below), selecting the first line will also provide a selectable option to create an update for that destination.

The text in the second line of the objective identifies the vehicle or other collateral that is the subject of the scout's mission. The application can automatically launch an internet search to find images which show general examples of the vehicle and can then provide the scout with pictures that will help in the scout's mission. The application can parse the text from the second line of the objective and form an internet search query along with other words that may help focus the search. For example, the word “photos” could be automatically added to the end of a search query that starts with the second line's text.

It is also possible to send a pre-defined URL which is directly linked to one or more pictures of general versions of the collateral. Also, it is possible that the system may have an exact picture of the collateral stored in the centralized server or a very close approximation down to particular model variations, color schemes and other information that could help identify the collateral. In such a case, the second line or a subsequent line in the objective could include a unique URL link to a webpage that is populated by images from the system. Such a webpage that is hosted by the system may require the user to securely access the system before the images are shown and the system may provide additional details about the collateral, the location being searched or the party from whom the collateral is being repossessed. The webpage could also provide alternate views of the collateral and may even provide video. Some URL links could be rather long, and a shortened form of the URL link may be sent in the e-mail. For example, both URLs listed below are linked to the same webpage which shows a 2010 Ford Mustang GT convertible (blue with black interior). It is more efficient to send the shortened version of the link rather than the longer version. If the webpage were populated by the Update database on the central server, additional details about collateral could also be included in the webpage, such as information about the aluminum alloy wheels or a dent in driver's door, etc.
1. http://en.wikipedia.org/wiki/File:2010_Ford_Mustang_GT_convertible_{—}1_—_{—}09-07-2009.jpg
2. http://bit.ly/KnnXKm

Thumbnails of several photos can be automatically displayed to the user on the bottom of the “Objective Info Screen” below any additional information. The Objective Info Screen is described in detail below. All additional lines are selectable and the text within any additional line can also be used as the text for an internet search.

Map View:

The user is displayed a map with selectable pushpins representing each objective. The application can perform an internet search using the exact text within the first line of each objective to determine the location to place the pushpins on this map. The default map zoom level will be out just far enough as to allow the user to view all pushpins for the route but the user can adjust the zoom level in and out, and navigate through the map as desired and in their accustomed manner. Selecting a pushpin will display a window that has all information about the objective. The additional functions are the same as when the user is in List View. The pushpins begin as one color and once the user has entered within the “Required Distance” of any objective, the pushpin color will permanently change as to notify the user that that specific objective is complete. Performing a Long-Hold on any pushpin will display a window that will allow the user to change the color back to the original color if desired.

Just as the scouting application could work in combination with an internet search application, or may have its own internet search functionality, it will also be appreciated that the scouting application could operate in combination with a mapping program that also runs on the smart-phone. In such a case, the location could be provided as an address along with GPS coordinates or a URL link to the particular address (10425 Old Olive Street Road in St. Louis, Mo. 63141—http://binged.it/wU7Exx).

Objective Info Screen

The Objective Info Screen is automatically displayed to the user when the user enters the “Required Distance” for any objective. As shown in FIG. 3, it displays all of the information within the E-Mail for the particular destination as well as an “Update” button that allows the user to initiate the update process and the “Track Me” button which allows the user to initiate the map tracking from their current position. The information can be displayed in the exact format that it is presented in the e-mail.

The Objective Info Screen may only cover a small portion of the users screen so that when this screen automatically appears when the user is within the “Required Distance”, it does not interfere with the user's ability to continue viewing the navigation software that will be directing them towards the destination. Initially, a transparent background and a selectable box can be displayed. The selectable box would contain the information within the first three lines of the objective. The box can be placed directly below the top box for the navigation screen which contains upcoming turn information for the user, and the size of the box can be reduced so that it covers as little toward the center of the screen as possible. The box should be large enough to read the information.

Also, information from the objective may be truncated or otherwise shortened in the selectable box. For example, the house number is the most important part of the information within the first line as the scout approaches the location within the “Required Distance”, so anything beyond the house number and the first part of the street name can be substituted with an ellipsis to save space. When the user selects this box, a full screen view of the “Objective Info Screen” will be displayed with all of the information, buttons and photos.

VIN Checker

The VIN Checker functionality is preferably built into the system. The VIN is automatically decoded when the repossession company user enters the VIN with a new assignment. The details are viewable to the repossession company user as a note on the assignment, and the details are viewable to the field agent user on their “Collateral Details” screen.

If the user has the phone in a vertical position, multiple lines may be used to display the entire VIN on the bottom of the screen, such as by displaying the first 9 digits on the first of the two lines and the last 8 digits on the bottom line. This will keep the VIN from being too small to easily read on the users screen.

Required Distance from an Objective

The Required Distance is initially set at ⅓ mile but may be changed by an administrator level user or through a centralized programming change. When a user selects a route from their “Messages Screen”, the “Objective Info Screen” will be automatically displayed as soon as they enter the Required Distance of any objective within their route. Once the users enter this area, they are able to add new information into the database regarding the address. When the user first enters this area, an audible chime may be played through the speaker of the mobile communications device to notify the user that they have arrived within the Required Distance.

The user may want the mobile communication device to be silent when they receive the proximity notice. Smart-phones typically have a silent mode of operation where notifications are provided to the user with a vibration. Also, some smart-phones can be linked into a car's communication system for a user to take phone calls or to play music or to provide text messages or other information. Accordingly, when the geo-location module determines that the mobile communications device is within the pre-defined radius from an objective site location, the mobile communication device could vibrate or provide some other form of notice to the user either directly or through a link into the user's car or some other communication system that may be linked to the user's smart-phone.

Follow Me Option

The Follow Me option allows the user to show their office and client exactly where they traveled while they were searching around any destination. The application will create tracking information to attach to the return E-Mail containing the update. As shown in FIG. 3, the tracking information is preferably in the form of a map image which is centered around the destination and shows a highlighted route around the destination. As the user selects to activate this option, the application begins tracking the route that the user travels and highlights this route on the map. The default map zoom level of this map will be out just far enough as to allow a view of the entire route traveled as the “Follow Me” option was active. The user should deactivate the “Follow Me” option before they can begin the update process.

When the user selects the “Follow Me” button, the button turns into a “Turn Off Follow Me” button. At certain times, the user will stop traveling and check the VIN on vehicles, and continue traveling if it is not the vehicle that is the subject of the objective. If the user stops for more than a particular time, such as twenty (20) seconds, at any location while the application is plotting their route, the application can emphasize this stop on the “Follow Me” map with a symbol, such as a circle that is slightly larger than the highlighted route and a different color, in order to show locations where there may have been vehicles that had similarities to the desired collateral. When the user is stopped close to an intersection, it may be due to a red light or traffic, and the user can have the option to remove the emphasis on one or more stops from the Follow Me route. If the scout wants to show a particular view of a location or finds the vehicle of interest at this time or at any time during the update process described below, the user can select the option to take a picture.

Creating the Updates

The “Update: by Va Repo” smart-phone application has two (2) independent parts that work together, the mobile application running on the smart-phone or other mobile communication device and the online database running on the centralized server. In the preferred embodiment, the smart-phone application contains the questions (A1-A161), Answers (C1-C163) and the Screen Logic. The online database contains the Update Pieces and Update Logic. As the user is asked questions by the application, they will answer the questions by selecting buttons on their screen. As the user progresses through the update process, the application will keep track of the order in which buttons were selected throughout the process. At the end of the update process, the application will recall the exact sequence of buttons that was selected by the user and send this sequence to the Va Repo Database and the database will assemble the update and send it back to the user on their smart-phone for review. At this point, the user will be displayed the compete update and given the option to send or re-create the update.

When the user selects the option to send a completed update, the database will insert the exact text from within the return update that was just created, attach any photos that were captured during the update process, capture the user's current date, time and GPS coordinates and then send the completed return update to the sender of the original e-mail (sent to the user) and then create an exact copy of the entire return E-Mail including any photos to be stored in the Va Repo Database. If the user enters an area where they cannot maintain a connection to the Va Repo Online Database, the application will remember the exact return update details and automatically attempt to communicate with the database and create the return update as soon as the user exits the “Roaming” state or allow the smart-phone user to manually submit the update when they find themselves to be in an area with a good connection to the Va Repo Online Database. When this occurs, the application will capture the exact location where the user was when the update was completed and when the reference number for that update is entered into the database, the map view will show both the address as well as where the user was when they created the update.

Update Process Flowchart

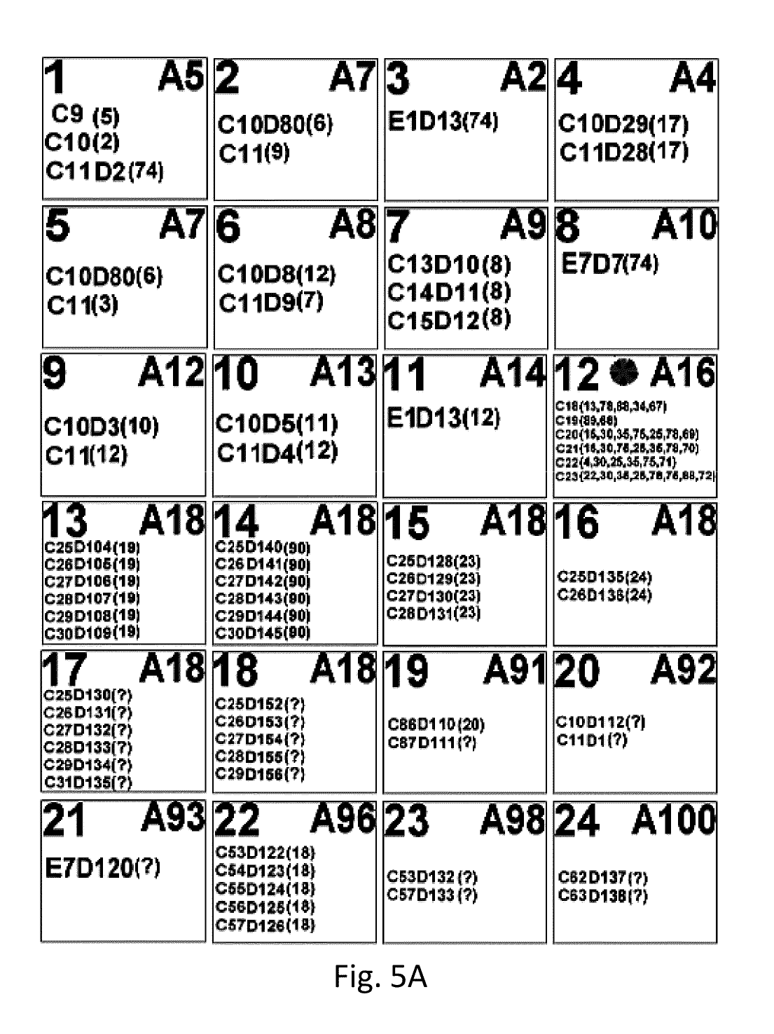

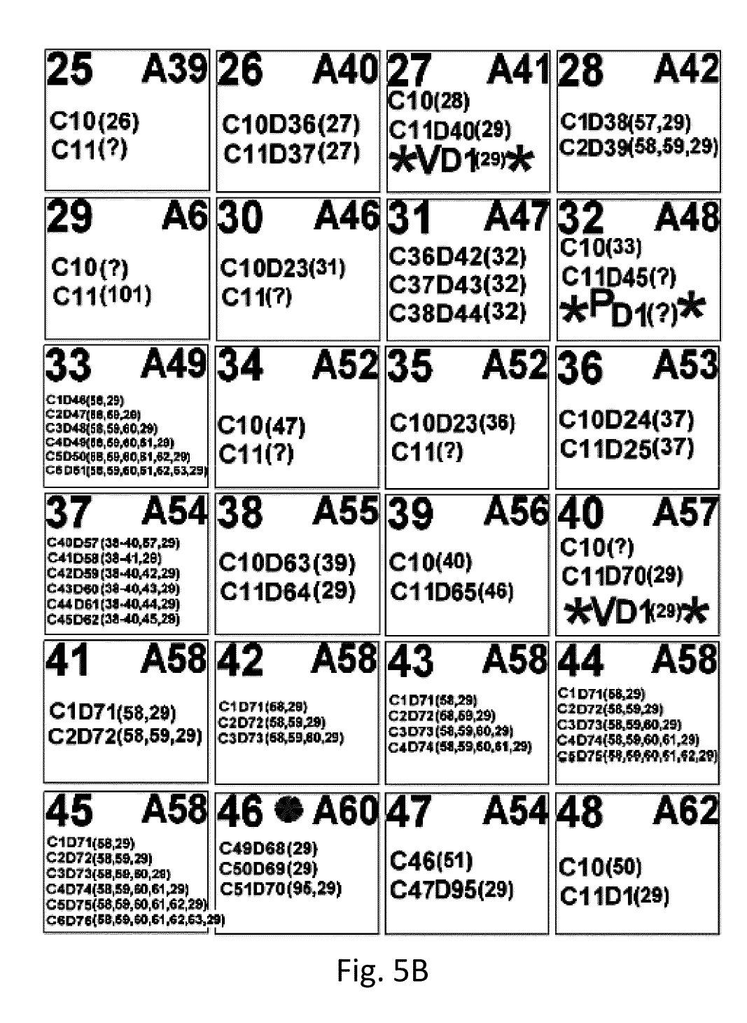

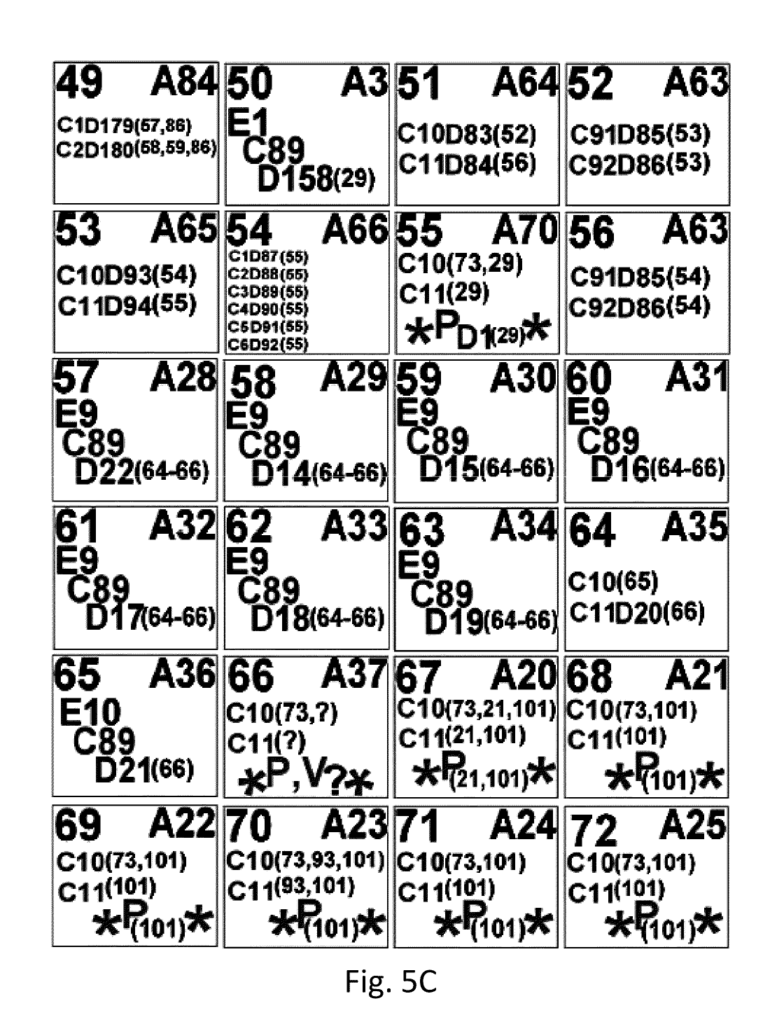

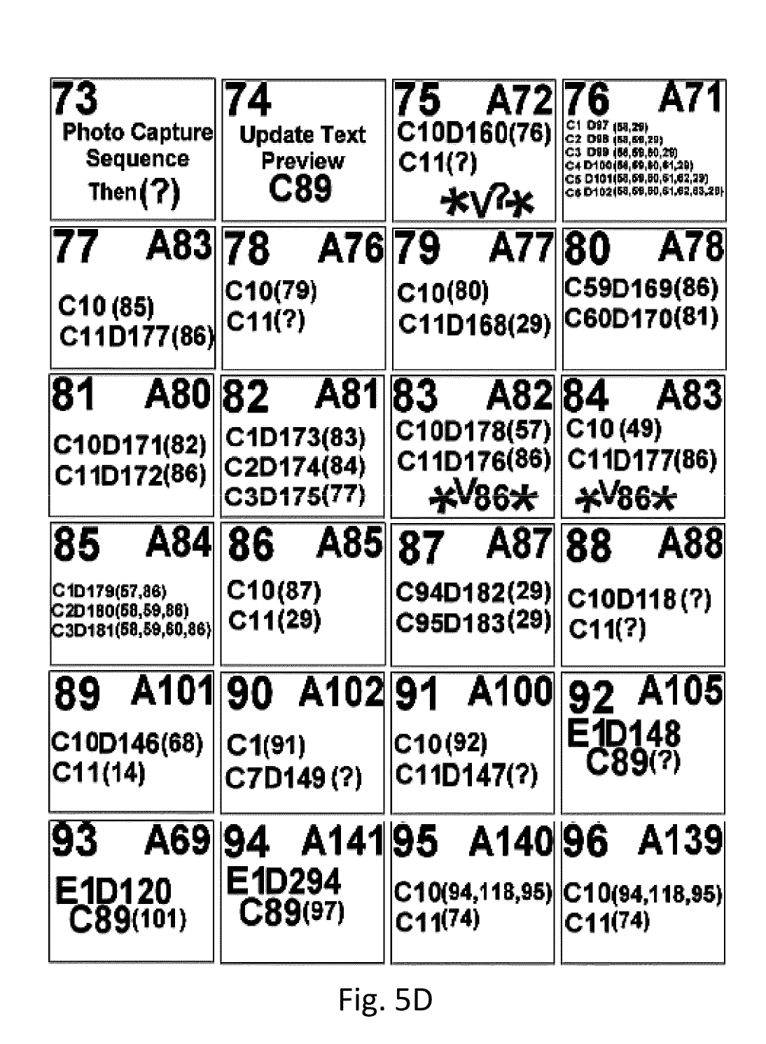

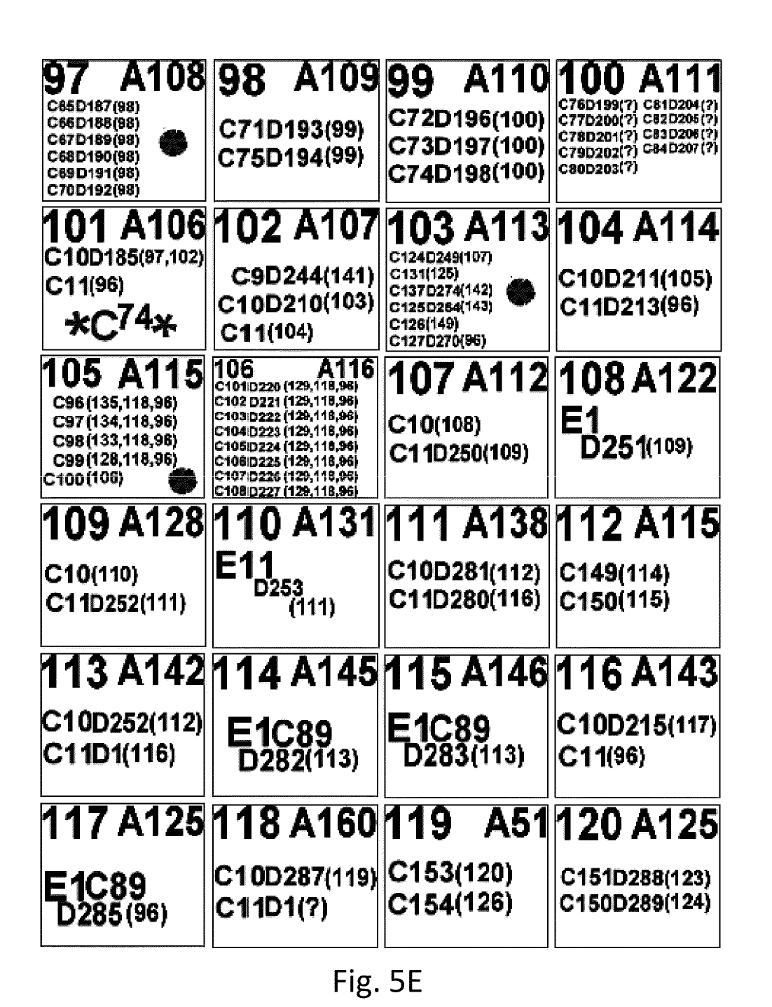

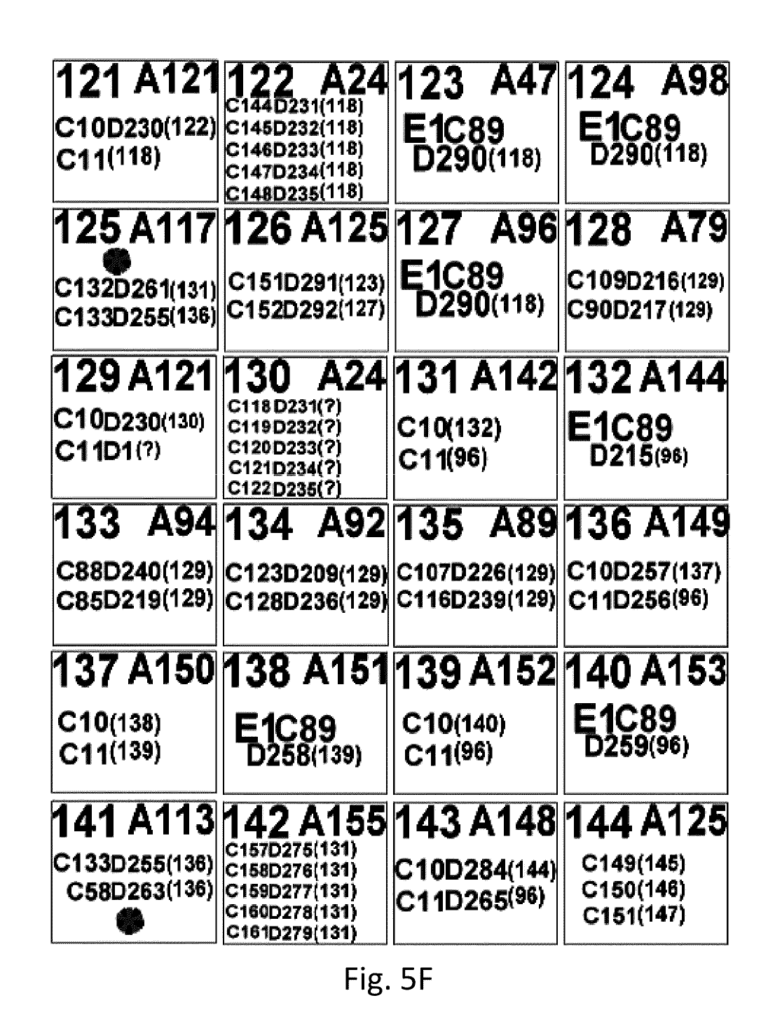

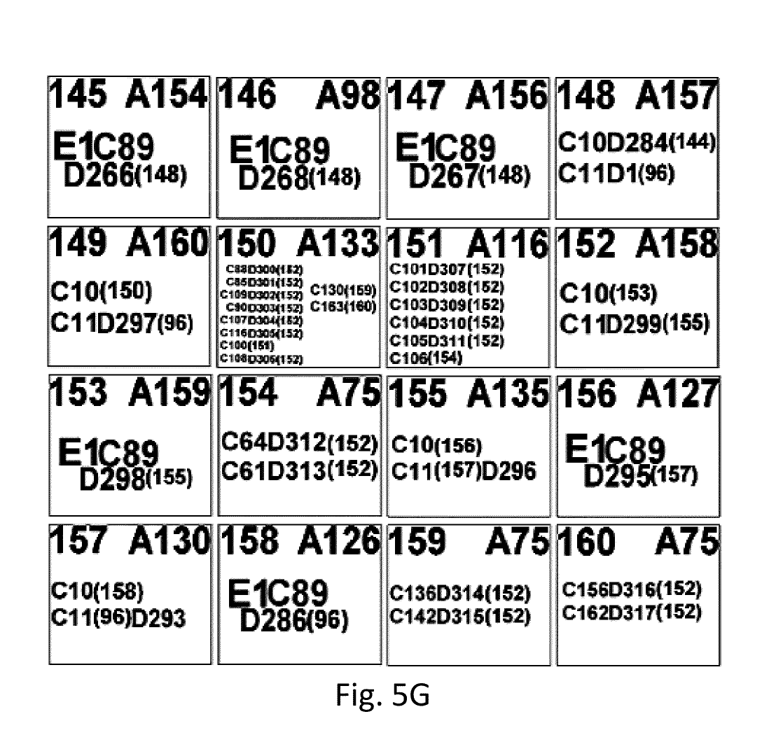

The update process flowchart is graphically depicted in FIGS. 5A-5G with reference to the coded tables listed below. The flowchart and tables show how the user is prompted for information by the mobile application throughout the update process and how the application takes the information from the user to create the return update.

In FIG. 5, the numbers in the upper left corner of the blocks represent screen numbers (i.e., screens 1-160). One number within a parenthesis “( )” indicates that the flow should go to the indicated screen. Multiple numbers within one set of parenthesis indicate that the flow will go to the first screen number and soon the flow will come to a “(?)” and the next unused number is the next screen in the progression. A particular example of a screen flow for a scouting update is shown in FIGS. 3II-3LL which shows the particular path of the scouting updates listed in the flowchart of FIG. 5. The key to the elements within the screens is provided in the table below.

Flowchart Key Table

Blue “A” codes (A1-A161) represent questions and other inquiries for the user (example
questions from Inquiry Table duplicated below).

| | |
|---|---|
| A1 | Do you want to turn off Updates/Launch another program? |
| A2 | So, what is the situation? |
| A3 | What did they say? |
| ... | |
| A160 | Did they provide any information about the customer or the vehicle? |
| A161 | Did they say how this person was related to the customer? |

Green “C” codes (C1-C163) represent optional answers and other responses that can be
listed on the screen and selected by the user (selections from Optional Response Table
duplicated below).

| | | | | | | | | | | | |
|---|---|---|---|---|---|---|---|---|---|---|---|
| C1 | 1 | C2 | 2 | C3 | 3 | C4 | 4 | C5 | 5 | C6 | 6 |

| | | | | | | | |
|---|---|---|---|---|---|---|---|
| C7 | Several | C9 | I'm not sure | C10 | Yes | C11 | No |
| C13 | Gate | C14 | Guard | | | | |
| ... | | | | | | | |

| | | | |
|---|---|---|---|
| C157 | Later today | C158 Tonight C159 Tomorrow | C160 In a couple days |
| C161 | In a week or so | | |
| C162 | X-Girlfriend | C163 X-BF/GF | |

Pink “D” codes (D1-D317) represent additional text responses for the return update
(selections from Response Update Table duplicated below).
D1 .

| | |
|---|---|
| D2 | This address does not exist. |
| D3 | This address is empty |
| ... | |
| D314 | a boyfriend is in possession of the unit. |
| D315 | a girlfriend is in possession of the unit |
| D316 | an X-boyfriend is in possession of the unit. |
| D317 | an X-girlfriend is in possession of the unit. |

Red “E” codes (E1-E11) are text entry boxes for the user (see Text Entry Table below).

| | |
|---|---|
| E1 | Enter Text Here: |
| E2 | Enter the color |
| E3 | Enter the make |
| E4 | Enter the model |
| E5 | Enter the tag state |
| E6 | Enter the tag number |
| E7 | Enter the name of the community |
| E9 | Enter “Color Make Model” |
| E10 | Enter tag State (or abbreviation) and Number |
| E11 | This will need to display a selectable calendar |

Orange “P”, “V” and “C” codes represent restrictions which are restricted by the users'
settings configuration.

Each screen is preferably limited to one (1) question to ask the user, and the optional answers for questions are preferably displayed as selectable buttons on the screen. If a screen restriction occurs, the screen indicated in black is the next screen in the screen progression. When a button is selected that is correlated to a pink “D” code, the text is added to the end of the return update. The database will add a blank space at the end of every block of text and two spaces after a period. For entering information into the text-entry boxes, the text listed within the key is the text that will be displayed to the user to let the user know exactly how to enter the information required.

The dual colored circle on the flowchart screens indicates that a selectable button should be displayed to the user. This button will allow the user to suggest additional answers to be made available for selection with future application software updates.

The user is preferably given the ability to toggle (on/off) certain settings and types of questions in the mobile scouting application. Optional settings include Photos (“P”), Vehicles (“V”) and Contacts (“C”). The flowchart explains which restriction a screen could trigger and where to go if the corresponding setting is turned off. An example can be screen number 27 as shown in FIG. 5B. It has a screen restriction of “*VD1(29)*” which indicates that if the option for “Vehicle Questions” is turned off and screen number 27 is reached then a period (i.e., “D1”) should be inserted into the return update and the flow proceeds to screen number 29.

If the “Photos” option is turned “On”, the application would allow a sub-option of “Night Time Photos” to be toggled. When “Night Time Photos” option is turned “Off”, the application will not ask the user if they wish to capture photos during night time hours. This is useful if the user cannot capture photos in the dark. There is also preferably an “All Update Questions” on/off toggle which allows the users to send routes to themselves that are not repo oriented, and they will not be given the “Update” button on any “Objective Info Screen”. For example, as indicated above, this option could be useful to users that want to use the route navigation capabilities and route views of the present invention or may want to launch another program when the user arrives at the destination. This option could be selected with an initial inquiry (i.e., A1) on a launch screen to avoid the detail update inquiries. An administrator level user or a centralized programming change can define the alternative application that may be launched when the user arrives at the destination so that all the user needs to do is select this option initially, follow the navigation information or otherwise go to the location on the route and then either launch an alternative application on arrival at the destination or just keep using the navigation functionality to go to the next destination on the route.

As indicated above, this innovative format for communicating multiple objectives can be used in other types of task reporting systems and is not necessarily limited to the repossession industry. Accordingly, the present invention could be applied to create a set of objectives that may be used for a landscaping business. When the update application is being used by a service provider, the application may prompt the user to take one or more “before pictures” (such as a picture of a flower bed), perform a series of tasks and then when one or more tasks are entered into the system as completed, the application could then prompt the user to take one or more “after photos” to show the completed work and provide a time-stamp of the completion.

Random Tag Updates

The random tag update option will allow a user to easily report the location of a tag number they can see from their current position. This type of update will only be sent into the Va Repo Database and does not require a randomly generated reference number. This function gives everybody with a smart-phone the ability to become an active part of locating collateral for the repossession industry and in turn, gives everybody with a mobile communications device the ability to make easy money.

When the end user has entered the required distance of any active objective within their route where the end user has already previously completed a return update, the user can be displayed an additional “Re-Run” button on their objective info screen. Selecting this button can allow the end user to send a simple return update that states “This address has been Re-Run and nothing significant has changed.” Along with this simple return update, the database will also take a copy of the previous return update text and insert it into the current return update. The user will not be asked any additional questions after they select the “Re-Run” button other than to confirm or decline the return update and if they confirm the return update the end user would then be directed back to their Objectives Screen.

The e-mail information that is sent to the scout can also identify the client who is being served. It is possible that the application could vary the update inquiries based on the particular client that is identified.

Centralized Server

Multiple databases may be hosted on a centralized server for several repossession companies, each of which has secure rights to their individual accounts. Also, clients may be given limited rights to view information that is hosted on one or more databases on the centralized server. It is also possible that the clients themselves may maintain their own information on the database and grant access rights to certain repossession companies as users of the database. In either event, each repossession database on the centralized server would have an administrator who controls and authorizes the rights and privileges of the various users.

The administrator grants the users the right to sign in to the administrator's database using their computer, and allows access of the information within all open assignments to specific mobile users that have the “Update: by Va Repo” application. Verification can be met by checking for a Va Repo Database E-Mail address, a savable password, “Update: by Va Repo” software registration number, the serial number and/or phone number of the mobile users cellular device. For authorized users of the system who are verified with the proper security credentials, the system allows the mobile user to search for information in the form of a Name, Address, Street name, City, Reference Number, Account Number, Assignment Number, Make, Model or Last 6. The system also allows the database to accept updates from a mobile user in an E-Mail format with possible photos attached. The user may also “Copy” and “Paste” updates into their system that were created by the application. Additionally, the mobile user can change the status of an open assignment to “Repossessed” and make a note of which address the user is updating along with the date/time of notification.

Database

The database will manage all registered users and updates. The updates will be stored within the database for a reasonable period of time, such as twenty four (24) months. Each update created by the “Update: by Va Repo” mobile application will be stored within this online database. The database will keep track of which user created the update, any tag information and corresponding vehicle details, what date and time the update was created and it will separate photos of vehicles and general property photos. The database can do this by allowing the smart-phone application to save photos of vehicles with some specific code in the file name and saving general property photos with another code within the file name. This will create a searchable platform where a paying customer can enter a tag number as a search within the database in order to obtain the location of the vehicle in question.

If a positive search result appears within the database, the customer is displayed a complete list of all vehicle descriptions and location dates and times that associate with the tag information within the database along with a numerical value of how many times that tag information has been entered into the database. If desired, the customer can then purchase all locations associated with the tag information within the database for a one-time fee. When a tag location is purchased from the database, the customer is sent a simple E-Mail message requesting notification if a successful location occurs so that the users responsible for creating the successful location could get paid. The customer may sign into the database at any time after the purchase and make notification of a successful location or they may use the information within this E-Mail message. This message may contain direct website links that could notify the database of which location provided the successful location or it may contain direct website links that would allow the customer to sign into the database and notify the database of the successful location. When any customer notifies the database of a successful location, the database will pay the users responsible for the successful tag location at the correct address (up to 3 users can be paid). If a customer makes a purchase from the “Va Repo Online Database” and does not notify the database of a positive location the following day, the database will send out an E-Mail questionnaire to the party to see if: the vehicle was located and they forgot to sign in and notify the database, the vehicle was located but not secured, or if the vehicle was not located at any of the addresses. If the customer has not reported a successful location after 7 days from the date of purchase, an additional questionnaire is sent to the customer with an additional questionnaire being sent again every 7 days until a period such as 30 days from time of purchase has elapsed. During this period such as 30 days while the customer is claiming that no successful location has occurred, the database will place the tag information the customer provided on a list within the database for a period such as 30 days that will alert the customer if the tag they wish to locate is ever entered into the database. If a tag location entry is made into the database with this desired tag information within a period such as 30 days after the time of purchase, the customer will be given the new information at no additional charge. If the tag location is captured any time after a period such as 30 days from the time of purchase, the customer may be required to make another purchase. This will also create a searchable platform where a paying customer can enter an address as a search within the database to obtain any property description updates created for that address. If a positive search result appears within the database, as long as the customer has a valid subscription, they are given any updates created for that as well as any general photos of the address, not including any tag or vehicle information or photos (annual subscription).

Every tag entry entered by the user from day one is eligible for a deposit to be made into the users pay-pal or direct deposit bank account (pay per use fee only). Deposits, such as $20 per tag entry can be compiled and sent out at the end of every month so this money would be usable by the end user around the first day of any subsequent month. Each update created by the application will also receive a randomly generated reference number that is specific to that update. This reference number can be searchable on the Va Repo Database for a reasonable period of time, such as 48 hours. This randomly generated reference number will give the repo office and client a way to verify that the update was in fact created with the application which gives another route to trusting that the information is true.

If a reference number is entered as a search into the Va Repo Database and a positive result occurs, a map is displayed with one pushpin located at the objective and one pushpin located where the user created the return update. A default display of this map can be a satellite view with the normal information including street names with a zoom setting that allows both pushpins to be viewable.

When the database creates an update that contains text from D140, D141, D142, D143, D144 or D145, the database will flag this address in a way that it is easily identifiable as a Business address. Any time the user has an address within a route that has been flagged as a Business address, the user will be notified of this by the database displaying a small icon next to the address that lets the user know that the address is going to be a business address. When the database creates an update that contains text from D146 (This address is a P.O. Box.), the database will flag this address in a way that it is easily identifiable as a P.O. Box address. Any time the user has an address within a route that has been flagged as a P.O. Box address, the user will be notified of this by the database displaying a small icon next to the address that lets the user know that the address is going to be P.O. Box address. At any time, they can select to provide a simple update stating that the address is a P.O. Box address and they are not required to be within “the required distance” to create this simple P.O. Box update.

When the user logs into the Va Repo Database using the smart-phone application or on a computer, they can perform a number of actions and status checks. They can view, delete and forward any E-Mail or specific update they have created within a period of time, such as the past 30 days. They can view any E-Mail as a normal text E-Mail or as a map with selectable pushpins. Selecting any text or pushpin will display a pop-up window with all of the information for that objective from the E-Mail to the user as well as the completed update including selectable thumbnails for any photos. If any Thumbnail is selected, a larger view of the photo is displayed. From this larger view of any photo, the user can delete, forward or download the photo. The database will allow the user to perform searches within the information for all of their objectives. These searches can be by Date Range, Address, Street name, City, Make and/or Model.

Business Model

The current industry standard for repossessions allows fees ranging from $250 to $1000 per purchase of tag locations. The business model computations can be conservatively calculated by placing the locations provided by the database on the low side of the scale at $250 per location. A total of 200,000 purchased locations in a given year would come out to 50 million dollars before any users were paid for their successful locations. If an average of one (1) user was paid for each successful location, there would be 46 million dollars remaining, and if an average of (2) users were paid, there would be 42 million dollars remaining and if an average of three (3) users per location were paid, there would be 38 million dollars remaining. Accordingly, this system could essentially become a source of income to the general public paying up to 12 million dollars annually.

In the event that the repossession database reaches one million active users averaging 5 tag entries per day, then only 0.01% of all tag entries entered into the database would need to be purchased in order to annually produce 38-46 million dollars. Field agents within the repossession industry can easily average between 20 and 30 tag entries per day and if each tag entry is worth a potential $20, many end users would enter far more than five (5) tag entries per day. The present invention allows anyone to use their mobile device and be two (2) buttons away from entering some simple information that could be worth $20. Accordingly the system disclosed herein can be monetized rapidly; also, the system does not require significant costs for the obtaining the information nor does it require significant ongoing efforts to create or maintain the system.

Visual Design Options

The buttons are preferably provided as large as possible with sufficient space separating the buttons to help the user to easily make selections. Preferably, each screen would display a “Back” button. There can be different daytime and nighttime color themes. The night time theme would preferably be darker than the daytime theme as to not blind the user while snooping around in the dark. Red and black are most preferable for the nighttime theme. There may be several different options when it comes to background images and/or colors as well as button and text colors. The users will be both men and women who may want to personalize or otherwise tweak their app a little. The user may be allowed to use a photo within their gallery to use as the background or even allow for a transparent background so the buttons appear out of nowhere through the update process.

Although animations and audio are possible with the mobile application, they are not necessary. The application can provide a simple fade when a button is selected. However, as described above, the application may provide the user with an audible tone when the user enters the distance required to create an update.

The logo of the system can be displayed on the screens of the application. The logo should be large enough to be able to read what it says and may be displayed over any background and below any buttons. When there are several buttons, the logo may not be shown or may be covered.

System Users

The various users of the system are described below.

COMPANY USERS: For a Repossession Company to obtain a user profile on the Va Repo database and access all of the features available to repossession company users, all that is required is to access the VaRepo.net homepage and submit a request to obtain a Repossession Company User Profile. This request will require the Repossession Company User to submit specific details about their repossession company and once the request has been submitted, a member of the Va Repo team will contact the repossession company user and verify the information and then require the repossession company submit a business license that matches the details provided in the profile request that was submitted by the repossession company user. As soon as the Va Repo team member has received this document and verified the information, the repossession company user will be granted a repossession company user profile and the repossession company user will be able to access and begin using all the features available. Company Users can establish a team of connected Field Agent Users that have the ability to interact with the Company Users repossession assignments and report various updates at any time about any address desired. Company Users can also then create individual Employee User profiles that will allow employees to log into the database and interact with the database the same way as the original Company User and the system will keep track of what each employee is doing on every assignment.

CUSTOMER USERS: For a Potential Customer to obtain a user profile on the Va Repo database and have the ability to search for the location of people and collateral, all that is required is to access the VaRepo.net homepage and submit a request to obtain a Customer User Profile. This request will require the Potential Customer User to submit specific details about their Company and once the request has been submitted, a member of the Va Repo team will contact the repossession company user and verify the information and eligibility and then have the Potential Company User submit a business license that matches the details provided in the profile request that was submitted by the Potential Company User. As soon as the Va Repo team member has received this document and verified the information, the repossession company user will be granted a repossession company user profile and the repossession company user will be able to access and begin using all the features available.

At this point, The Customer User will be able to determine how they wish to pay for the information they wish to obtain from the database. They can enter credit card or bank account information and have the credit card or bank account billed each time they purchase information from the database as a Pay-Per-Use Customer User. They can also select to pre-pay a specific amount so they can make multiple purchases while their credit card or bank account is only billed once for the multiple purchases they pre-paid as a Tab Billing Customer User. Finally, the Customer User can select to pre-pay a specific amount and then they can create additional Customer User Accounts that will purchase information from the database and the funds for each purchase will be deducted from the pre-paid amount for the original Customer Users account. These newly created Customer Users are known as Group Tab Billing Customer Users and their access can be managed by either the website administrator or the original Customer User that created the Group Tab Billing Customer User.

FIELD AGENT USERS: For a Smart-phone User to obtain a user profile on the Va Repo database and have the ability to utilize the ability to report the location of anything by using the “Just a tip, I see this and Photo Capture” features, all that is required is to download the free smart-phone application and enter their information and they will automatically be granted a Field Agent User profile. For a smart-phone application user to access all the additional features for Scout Users and Repossession Agent Users, all that is required is to have an active Repossession Company User send a “Request to Connect” to the Field Agent User as an internal message and have the Field Agent User accept the request. When a Repossession Company User submits a “Request to Connect”, the Repossession Company User must establish whether the Field Agent User will utilize the smart-phone application as a Scout User, Repossession Agent User or a Both User and this will determine what features will be available to the Field Agent User.

The Repossession Company User will also be able to submit a “Request to Connect” to any smart-phone user that has not yet downloaded the smart-phone application by sending the “Request to Connect” to any email address and the request will have links for the smart-phone user to download the smart-phone application and once the smart-phone application user has established their profile details, they will automatically be connected to the Repossession Company User.

It will be appreciated that there could be thousands of users in the general public who have downloaded the free smart-phone application but have not been associated with any Company in the database. Such Field Agents would be considered an unassigned Field Agent, a freelancer or just an interested member of the general public. However, since these freelancers are not associated with a particular Company, the system restricts the information that may be provided to such users. Additionally, the freelancer's version of the software can be restricted or otherwise limited so that it is only enabled to operate those features that the system allows for generally accessibility to the public.

General System Architecture & Overview

The system has a web-based application that is hosted on a server platform and which communicates with a smart-phone application that is hosted on various mobile communication devices.

Va Repo Company provides vehicle repossession service to its clients (financial companies), and the computerized system described herein is used to support the repossession service. By creating an account, Va Repo company can manage different assignment orders (Vehicle Repossession orders) of the clients. Service to be provided for each order will have different objectives (addresses). The company user will attach multiple objectives (addresses) within one message & assign it to the smart-phone field agents. They will receive this objective. Scouts may either be able to locate the vehicle or may not be. If they can locate, they will say “Vehicle Located” otherwise they has to go through the update process (i.e., answer sets of questions). When the located and/or update information is submitted, all agents of Va Repo and the company user will receive a message on the same. Then any one agent can repossess this vehicle and company user will be notified about the same. Even though a scout located the vehicle, if the agent could not find the vehicle at the time of repossession he/she can also go through update process (i.e answer the sets of questions). For each update, a unique reference number will be generated (Ref. No.). Once notification is received, company user can change the status of the assignment order accordingly and fill a “Report Repossession” form. The clients will receive an update along with address & Ref No. via email. They can also search for the updates using that Ref No. from the homepage.

Smart-phone users can also enter “Random Entries” for any vehicle or person they desire, irrespective of the assigned objectives. The random entries for any vehicle/license plate or person will be stored in the database and will only be displayed to the Va Repo system administrator. Customers can sign-up through this web application. Only registered customers can search for the updates, address(s) and tips related to a particular object or person. In order to get the updates, address(s) and tips related to a object or person, he/she needs to purchase the information. Once purchased, each time the system receives any updates related to that object or person, the customer can be notified for a small fee or free of cost.

Website Interface

The website interface is generally described relative to the screenshots of the various interactive web pages.

New Company Profile Request

A company that is new to the system must enter basic company information in order to obtain an account within the system. For example, mandatory information could include the Company Name, a Username and corresponding Email Address along with contact information for the company, such as the Address and Telephone Number. Additional information that may be requested could be a Fax Number, Website URL, Trade Associations and Number of years in business. A Company Sign-Up Request for a new company will be sent to the system administrator and once approved, the company user will receive an activation email at the email id specified in the application form for the company profile request.

After a Company User has been granted access into the database, the Company User will be able to gain entry into the database and utilize all of the features available. Use of the database by a Company User will allow a Company user to digitally manage their repossession company digitally. They will be able to establish all of the details regarding their storage facilities, clients, field agents, police departments, transport companies, services and fees associated with each service and then easily print off any required documents, maintain all of their repossession assignments, view active addresses on various maps and interact with the addresses as pins on the maps, establish a team of connected Field Agent Users that have the ability to interact with the Company Users repossession assignments, easily generate and dispatch routes to their connected Field Agents and receive return updates in real time that are automatically entered into the database under the correct address/assignment and automatically notify their clients of all activity on their assignments in real time.

VIEW ASSIGNMENTS SCREEN: This screen allows the Company User to view and access all of their repossession assignments and filter the results by Assignment Number, Account Number, Service Type, VIN, Debtor Name, Assignment Status, Make/Model and City. They can also change the status of any assignment to “Open, Closed, On-Hold, Repossessed and Released”. If they change the status of any assignment from Open to Closed, On-Hold or Repossessed, the pins for all addresses associated with the assignment will be removed from all map views and changing the status of any assignment back to Open will automatically place the pins for all associated addresses back on all map views. The system can automatically generate unique Assignment numbers for each new assignment that is added by the company user.

On change of status, the actions listed below can be taken:

1) Closed: On-change of this,
Case 1: If service fee is set for this client (via Add/Edit Client):
->It redirects to “Create Invoice” page for this order with “Service Rendered” selected as “Close Fee” & “Cost” as Service fee set in “Add/Edit Client” module.
->Also all pins associated with this assignment will be removed from the “Map View” containing the pins for all active addresses
Case 2: If service fee is not set for this client (via Add/Edit Client):
->It refreshes “View Assignment page with changed status.
->Also all pins associated with this assignment will be removed from the “Map View” containing the pins for all active addresses.

2) Repossessed: On-change of this,
->It redirects to “Recovery” Tab within the “Assignment Detail” page for this assignment.
->Also all pins associated with this assignment will be removed from the “Map View” containing the pins for all active addresses.

3) On-Hold: On-change of this,
->It refreshes “View Assignment page with changed status.
->Also all pins associated with this assignment will be removed from the “Map View” containing the pins for all active addresses.

4) From On-Hold to Open: On-change of this,
->All pins associated with this assignment will be added back to the “Map View”
->It refreshes “View Assignment page with changed status.

5) From Repossessed to Released: On-change of this,
->It redirects to the assignment detail page->Forms tab

STORED COLLATERAL SCREEN: This screen allows the Company User to view the details associated with all repossessed collateral currently being stored at their storage facilities and give them the ability to print a report containing these details.

DETAIL SEARCH SCREEN: This screen allows the Company User to search for any assignment by providing any piece of information they have regarding the specific client, collector, collateral, location, Debtor, Co-Maker or employment details.

ADD ASSIGNMENT SCREEN: This screen will allow the Company user to enter all the details about a new repossession assignment they have received so that the information is in the database and the Company User can interact with the assignment digitally. This screen will allow the Company User to enter all of the details regarding the Client, Collector, Debtor, Co-Maker, Employer, Collateral and any additional notes/addresses and then the user can select what style pin to display on the map views for the addresses associated with the assignment as well as establish whether to automatically email the collector every time activity occurs on the assignment. If the Company user selects to automatically email activity to the collector, an email will be sent to the collector when the Company User enters the repossession assignment into the database, every time an update is created by a smart-phone user and when the status of the assignment is changed to Repossessed, Closed or On Hold. The Company User is also given a link on this screen to easily add a new client if the Company User has not already entered the details of the Client of the new assignment. The repossession company user is also given a dropdown menu describing the various pin styles that are available and the user must select a pin style to change the address pins for that assignment from the default pin.

The features of the Assignment Screen are integrated into the Map Screen described below. The computer program allows the repo company user to toggle between a “Map View” and a “List View” of all addresses associated with the assignments and objectives. As described in detail below, the program allows the repo company user to generate a route for a connected smart-phone user in either view mode by simply selecting any number of addresses and assigning the route to a connected smart-phone user.

MESSAGES SCREEN: This screen will allow the Company User to easily view Update Messages that were generated by their connected Field Agent Users, create messages to send to their connected Field Agent Users or any email address and view any messages they have sent using the database. When viewing any Update Message from a connected Field Agent User, the Company User is given the ability to forward the message to any connected Field Agent User or Email address, send a Reply Message back to the Field Agent User and change the status of the address to Dead which will remove the pin for that address from the map views. Automatic messaging can be enabled for particular changes in the status of an objective. For example, a company user can receive automated messages based on the status changes listed below:

1) When any updates is received for the objective assigned by company.

2) When any vehicle is located for which order is placed by company.

3) When any vehicle is repossessed for which order is placed by company.

With the integration of the centralized repossession program and the smart-phone application, the messaging functions are made more efficient between the administrative user or other centralized company user who is operating the program on the server and the scouts and field agents who are running the integrated application on their smart-phones and other mobile communications devices. A repo company administrative user can now interact with a smart-phone scout user and exchange different types of information very easily. The administrative user can send routes and general messages to any connected smart-phone user.

When a repo company user sends a route to a connected smart-phone user, the smart-phone user will report back with some sort of update for each address within their route and the information generated by the smart-phone application user will be automatically entered into the information for the address within the repo assignment on the database and a message will be sent to the repo company user to notify them of the update. The smart-phone user can report several alternative updates back to the repo company user, such as Address Update, Re-Run Update, Vehicle Located, Vehicle Repossessed and a reply to a general message.

When an Address Update or Re-Run Update message is received by the repo company user, they will have the ability to change the status of the address to “Dead” directly from the message, as well as send a Reply message to the smart-phone user, Forward the message to any connected smart-phone user or email the message directly to the collector or any email address they desire. When a Vehicle Located Update message is received by the repo company user, they will have the ability to send a Reply message to the smart-phone user, Forward the message to any connected smart-phone user or email the message directly to the collector or any email address they desire. When a Vehicle Repossessed message is received by the repo company user, they will have buttons in this message that will direct them to the correct recovery report or invoice screen for the repo assignment if desired. They will also have the same ability to send a Reply message to the smart-phone user, Forward the message to any connected smart-phone user or email the message directly to the collector or any email address they desire. The repo company user can also send a general message to any connected user or a general email to anybody they desire directly from their “Compose Message” screen.

MAP VIEW/GROUP MAP SCREEN: This screen allows the Company User to view all of their active addresses associated with all active repossession assignments their repossession company is currently looking for along with their storage locations, home addresses for their Field Agent Users as well as the current location of any connected Field Agent User that is currently logged into the system. The locations of the active addresses on this map are established by associating a specific color/style combination pin for each address. A specific color depicts a specific client and a specific style pin depicts the type of collateral being searched for at the address. This allows the Company User to view this map and visually establish the specific client and collateral at each address on the map view. The Company User, i.e., repo company administrative user, can generate and dispatch a route to any connected smart-phone user for the company which could include any active address for any open repo assignment as well as an option to perform various searches to narrow down the number of pins displayed on the map.

By hovering the pointer over any pin will display additional information such as the Assignment Number, Vehicle Year, Make, Model, VIN and Color, Debtor Name and Client Name associated with the pin. The Company User can easily generate and dispatch a route to any connected Field Agent User by simply selecting any pins desired and selecting the “Assign Route” button and then selecting which connected Field Agent User to send the route to. Selecting this “Assign Route” button will also display the entire new route on a window and establish how many miles the route will require before the Company User submits the route to any connected Field Agent User.

Selecting any active address pin a second time will remove the address from the current route being generated. Selecting any storage location or field agent home address pin more than once will place the address into the route another time rather than removing it. The first pin selected will be the beginning of the route and each additional pin will be displayed next in the route sent to the smart-phone user but the smart-phone user is free to interact with any address within their route in any order they desire.

This screen also allows the Company User to narrow down the number of pins displayed on this map view by giving them the ability to search the assignments by Assignment Number, Account Number, VIN, Debtor Name, Make/Model and City. Multiple objectives can be shown on the map, and for each objective, the company administrative user can assign multiple scouts and agents. Additionally, by identifying particular objectives to particular scouts and field agents, the administrative user can assign routes to the various company users. Once assigned, those scouts will report to the selected agents. As soon as the scouts locate the vehicle, it will be reported to the agent. Those address(s) will be reviewed and after that, the on-site vehicle will be repossessed at any one location at which time the agent will change the status as discussed above to “Vehicle Repossessed” which will be communicated to the system administrator and updated in the system for all of the company users.

The map view identifies the particular aspects of the objectives with color coded symbols and also provide real-time position information for the company's scouts and agents.
->All the address(s) provided for the objectives will be displayed in the objectives tab
->A company administrative user can create a route by using the objectives address(s) & assign it to particular scout(s)/agent(s)
->It will display pins of the address(s) under the selected objective
->Each objective map preferably displays color-coded pins as listed below
   1) All Objective address displayed with defined pin image & color.
   2) If any address is dead, then it will be displayed with say black pin icon (as set by the admin for dead address)
   3) If any address is inaccessible, then it will be displayed with say no-entry pin icon in the color set for associated client (as set by the admin for inaccessible address)
   4) If an update is already provided for any address, then it will be displayed with its defined color but a dim icon.
   5) Each objective map should display the storage locations added by the company so that field agents know where they can store particular vehicle.
   6; Each objective map should display logged-in scout/agent's current address with some pin icon (as set by the admin for current address)

In assigning a route, the first address selected will be the beginning point and each address selected will be added to the route in the order it was selected by the user. It will be appreciated that the pins can be selected more than once. A Refresh button can be selected to de-select all of the pins on the map. The Assign Route button can be enabled for selection whenever any one or more addresses are selected from the map view or from a list view. The Objective Address pin can have toggle-selection functionality (selectable/non-selectable), and even though the Scout/Agent address can be selectable, it does not need to toggle like the collateral address will toggle (selectable/unselectable). Various icons and pins are listed and described below.
Storage Location address icon: preferably set by the admin user, and on selecting it, the address bar is displayed. By selecting the address bar, the map will become a navigation screen that directs the user to the stored location from his current location.
Scout/agent icon can: preferably set by the admin user. As discussed above, the map can display the present location of each scout/agent. When a scout/agent icon is selected on the map, the map displays the current location in the address bar.
Inaccessible address icon can be set to a color for an associated client (set by the admin). On-tapping, it will display the address bar. & on-tapping that address bar it will redirect to the objective info screen.
Dead address icon (set by the admin). On-tapping, it will display the address bar. & on-tapping that address bar it will redirect to the objective info screen.
Assignment order specific pin icon (as set by the company user). On-tapping, it will display the address bar, & on-tapping that address bar it will redirect to the objective info screen.
Assignment order specific pin icon in dim view. On-tapping, it will display the address bar & on-tapping that address bar it will redirect to the objective info screen.

The Map View has three (3) primary purposes. It allows the administrative user to view the map and establish client and collateral information based on the visual characteristics of the selectable pins at each address. It also allows the administrative user to interact with the addresses associated with their open repo assignments. Finally, it allows the administrative user to easily generate/dispatch routes to smart-phone users. As discussed below with reference to the smart-phone application for mobile communications devices, the Map View is also helpful to the scouts and field agents and provides an efficient way to organize and communicate a large amount of information in a very manageable format. As described above, the repo company user can select any number of pins, select to assign the route, select a smart-phone user to send the route to and then select to send the route.

These features can be used by a repo company user when they view their “Assignment Detail Screen” for any individual repo assignment and on their “Group Map” with all addresses for all repo assignments. A smart-phone user can also view the same exact “Group Map” as the repo company user and they can also view their routes in this “Map View” and the smart-phone user will view a “map View” when they begin the “Condition Report Process” and have multiple positive search results from their initial search(the user will do a search and if 1 positive search result occurs, the smart-phone user will be directed to the “Condition Report Process” and if multiple positive search results occur, they will be displayed a “map View” with selectable pins at every address associated with the positive search results and the smart-phone user can then select which ever pin they desire and then they will be directed to the “Condition Report Process”.). Search fields are given to all users to allow the user to narrow down the number of pins displayed on any map.

When any repo company user sets up a new client within their “Edit Profile” screen, they will establish a color for all pins to be displayed for this new client. The pin shape is established by the repo company user on their “Add Assignment” screen any time they add a new repo assignment into the database.

The specific pin color and shape for any address can be viewed the same way regardless of what type of user is viewing it or which map they are viewing. The pin shape for any address can be automatically be changed to various shapes which represent different statuses for any address. The 4 different statuses for any address are “Active”, “Dead”, “Inaccessible” and “Vehicle Located”. The pin associated with any address that has a status changed to “Dead” will be turned black and will not be selectable on any Map View and changing the status of any address back to “Active” will automatically change the pin back to the normal color/shape as when it was active before. If any address is inaccessible for a smart-phone user, the pin for that address can automatically be changed to the correctly colored “No Entry” pin to reflect this whenever a smart-phone user establishes this while being directed through the update process for the address and selecting that the address is inaccessible by choosing the answer “No” when being asked “Can you gain entry into this secure area?” If the collateral is located at any address and a smart-phone user selects the “Vehicle Located” button on their “Objective Info Screen”, the pin for that address is automatically changed to the correctly colored “Vehicle Located” pin to reflect this. When the status of any repo assignment is changed from “Open” to “Closed”, “On-Hold” or “Repossessed, the pins for all addresses associated with the repo assignment are removed from the “Map View” and if the status of the assignment is ever changed back to “Open”, then the correct pins are placed back on the “Map View”.

ACCOUNTING SCREEN: This screen gives the Company User the ability to create, search, edit, maintain and print invoices as well as create, print and view monthly reports that are required by their repossession insurance company.

ASSIGNMENT DETAIL SCREEN: This screen will allow the Company User to view all of the details associated with the specific repossession assignment including client, collateral, debtor, co-maker and employment details including all addresses, updates and activity on the assignment. The Company User can also add new addresses to the assignment, change the status of any address to Dead which will remove the pin from all map views or Active which will place a pin at the address on all map views, review and forward all updates generated by any Field Agent Users associated with all addresses for the assignment, establish the details associated with the repossession of the collateral, print various required forms for the assignment such as repossession orders, Delivery and Release Tickets, Personal Property Reports, a Report of all activity on the assignment, Redemption forms with and without fees owed, generated invoices as well as create invoices for the assignment and enter random notes and links for reference associated with researching the repossession assignment.

EDIT PROFILE SCREEN: This screen allows the Company User to establish all of their public and private information so that it can be displayed in the public areas or on the various forms needed by the Company User. They can edit basic details such as their location and contact information and then add photos of their company and these details will be viewable by visitors of the VaRepo.net website.

The Company User can enter the details regarding their clients including location and contact info as well as names and contact info for any individual collectors at any client. When entering the details of a new client into the database, the Company User must select a color to display all pins associated with the repossession assignments for the specific client. This color is selected on this screen and then the individual style of each pin is determined every time the Company User enters a new assignment into the database.

The Company user can also enter the details for any companies their company must interact with such as Police Departments, Transport Companies, Auction Companies and their Repossession Insurance Company and the information for these companies will automatically be entered onto the various forms that the Company User will need to print out at various times.

The Company User can also maintain their Field Agent Users as well as Employee Users and add/remove mobile access to the information associated with their repossession assignments. It will be appreciated that field agents could be independent contractors or employees.

SEARCH SCREEN: This screen will allow any Customer User to search for the location of anybody or anything by providing two (2) different search screens with search filters such as VIN, Debtor Name, Vehicle Year, Make, Model, Color and License Plate info (for vehicles) and First/Last Name DOB, SSN, Phone Number, Email Address (for people). A positive search result will only display the total number of positive search results as well as the date/time of each positive search result and purchasing the information will provide the Customer User with all information associated with the positive search results including any photos and updates.

RECOVERY TAB SCREEN—This tab allows the repo company user to manually enter any information regarding the successful recovery of any collateral. The user can enter information such as recovery date and time, address, which agent recovered it, the mileage, color and various other details regarding the successful recovery and collateral. If a connected field agent has completed a Condition Report Process for any assignment, then all of these details will already be entered for the repo company user.

TABS MANAGE ADDRESSES SCREEN—This tab allows the Repo Company User to view and edit addresses associated with any assignment. As a user enters any address, a satellite view of the address is automatically displayed to the user and the user can add any address, determine the status of any address, edit any phone numbers associated with any address, and manually adjust the address pins for the assignment.

TABS OBJECTIVES SCREEN—This tab allows the repo company user to view the addresses associated with the assignment as map with all the same functionality of the Group Map or as a list that will allow the user to view all addresses and updates (including photos) for the addresses as well as which field agent created the update and a date\time stamp.

TABS UPDATES SCREEN—This tab allows the repo company user to view all addresses and updates (including photos) for the addresses as well as which field agent created the update and a date\time stamp. The default view of this tab lists all addresses associated with the assignment and selecting any address will display all updates created for the address.

EDIT FIELD AGENT SCREEN—This screen gives administrator privileges to the repo company user so they can manage the information regarding their field agents' user profiles. They can edit any information within the profiles they desire as well as temporarily suspend mobile access to the database. It should be recognized that with other repo specific smart-phone applications currently in existence, the smart-phone users are managed by the Administrators of the database and not by the individual repossession companies as the Va Repo Online Database does.

FORMS ALL ACTIVITIES SCREEN—This form displays information regarding ALL activities an any specific repossession assignment and it displays the user\date\time of all actions from when the assignment was generated to when repossession efforts are ended for any reason. This also includes all notes, updates, status changes and any submitted photos.

LIST EMPLOYEE SCREEN—This screen gives administrator privileges to the repo company user so they can manage website access to their employees. They can add new employees, delete employees, temporarily suspend mobile access to the database as well as reactivate the mobile access. It should be recognized that with other repo specific smart-phone applications currently in existence, the smart-phone users are managed by the Administrators of the database and not by the individual repossession companies as the Va Repo Online Database does.

LIST STORAGE LOCATIONS SCREEN—This screen allows a repo company user to add and delete information regarding their storage locations. Entering a storage location on this screen will provide a “Storage Location” pin to be displayed on all Map Views so that it can be viewed or inserted into routes.

MESSAGES INBOX SCREEN—This screen displays all messages within the smart-phone user's inbox. The system utilizes push-notifications and the user is able to simply “Refresh” the inbox to check for new messages if desired. Selecting on any message title will direct the user to one of several different types of messages. The user can also delete any messages as desired and search their messages using various filters such as is used for the Group Map Search Screen so the user can find specific messages based on the information about the assignment or within the return updates.

MESSAGES REPLY TO UPDATE SCREEN—This type of message allows a repo company user to respond to a specific field agent regarding a specific update the Field Agent User provided some time in the past. This screen displays the update and allows the user to enter any text they wish in the same area so it is easiest for the Field Agent User to remember what the Repo Company User is asking about when they receive the message. As the users communicate back and forth, these individual messages will compile and keep track of the entire conversation from the beginning much like “text messaging” does. This screen also allows the repo company user to send the message to any email address if desired and they could send it to a client, different employee or anybody they wish.

Mobile Communications Device Interface

The mobile communications device interface is generally described relative to the screenshots of the various interactive smart-phone screens. As indicated above, the innovative integration of the centralized repossession program with the smart-phone application results in messaging functions that are vastly more efficient than the best possible messaging that can be performed with current repossession software systems that do not use the present invention. The system now uses internal push notification features between the administrative user or other centralized company user who is operating the program on the server and the scouts and field agents who are running the integrated application on their smart-phones and other mobile communications devices. While e-mail can still be used between these users, it is not as efficient as transferring information to and from the smart-phone application user with the internal push functionality.

For example, when a route is received by a connected repo company user, the smart-phone application user will be notified of the route they have received and the total distance of their route will be part of the title of the message containing the route. This eliminates a step of launching the application based on the information contained in an e-mail message. Also, by using internal push functionality between the smart-phone application that is integrated with and communicates directly to the server software program, the smart-phone user can interact with all information associated with any address within their route. The smart-phone application can also retrieve all of the information associated with an objectives list while it is in communication with the server software program so that if the smart-phone loses connection to the server for a period of time, such as in a remote area with poor cellular service, the scout or field agent can still use the smart-phone application. Additionally, when the smart-phone is unable to communicate with the server, entries made by the field agent can be stored by the application until communications are restored and the information can be transmitted.

The smart-phone application user can also create “Condition Reports” for any repo assignment with a status of “Repossessed” and the information generated by the smart-phone application user will automatically be entered into the database, preferably in a .pdf format so that the information is ready to print or email. This “Condition Report Process” that the smart-phone application will direct the user around the repo and ask the user to supply various information and photos and once completed, the repo company user will be able to access all of the generated information.

As discussed below, when any Scout or Agent smart-phone application user selects the “Vehicle Located” button on their “Objective Info” screen, notifications will automatically be sent to all “Agent” users and the pin associated with the address will be changed to the correctly colored “Vehicle Located” pin and a message is sent to the repo company user. When any Agent smart-phone application user selects the “Vehicle Repossessed” button on their “Objective Info” screen, the message to the repossession company user will contain a button allowing the repossession company user to change the status of the assignment to “Repossessed” and generate any invoices. The smart-phone application user also has the ability to search and view all active addresses associated with all open repo assignments. The results of these searches can be displayed as a “Map View” or a “List View”.

Additionally, as discussed in detail below, the “Just A Tip” and “I See This” random updates can be used by anyone who is running the smart-phone application to report the location of any object or person. The user can be anyone with the repossession smart-phone application even if they are not connected as an authorized user associated with any particular Company, i.e. an unassigned Field Agent, a freelancer or anyone in the general public who is using the smart-phone application. In this random update mode, the smart-phone application user can simply walk up to a vehicle, take a photo of the tag number and walk away to report the location of any vehicle they desire. The database will take the image of the text and establish the text within the tag information as well as capture the GPS coordinates of the smart-phone application user and place both pieces of information in the database so it can be searched.

It is a unique ability for the smart-phone application of the present invention to be able to generate public information such as an Address, Vehicle description and Tag Number (both via the Update Process) and GPS locations and general tips (both via Random Update) and assemble the public information in one centralized location for the industry to come coming to the database for this type of unique information.

HOMEPAGE SCREEN: Every time a smart-phone user creates an “Address Update”, the system will generate a random reference number for the update which can be entered on the homepage to verify that their update was actually generated with our system.

MESSAGES SCREEN: This screen allows a Field Agent User to receive, review and respond to Company Users using simple messages that prompt notifications on the Field Agent Users smart-phone and these messages are accessible in the users inbox under their Field Agent User profile. This inbox can be accessed by selecting any smart-phone notification or by selecting the “Messages” button displayed on the bottom of the screen throughout the application.

A Field Agent User that is not connected as an authorized user associated with any particular Company, i.e. an unassigned Field Agent, a freelancer or anyone in the general public who is using the smart-phone application, can only receive 2 types of messages:
1) A “Request to Connect”—A request sent from a Company User to allow the Field Agent User mobile access to interact with their repossession assignments.
2) A “You are getting a check for the information you have captured.”—A message automatically sent to the Field Agent User when the information they have captured has been deemed “Useful” by a Customer User letting the Field Agent User Know that they have money coming in from the system.

A connected Scout User or Field Agent User who is an authorized user associated with a Company by a Company User will be able to receive 6 types of messages in their inbox:
1) A “Request to Connect”—A request sent from a Company User to allow the Field Agent User mobile access to interact with their repossession assignments.
2) A “You are getting a check for the information you have captured.”—A message automatically sent to the Field Agent User when the information they have captured has been deemed “Useful” by a Customer User letting the Field Agent User Know that they have money coming in from the system.
3) A “General Message”—A message sent to the connected Scout User from a connected Company User which can contain any sort of general information about anything.
4) A “You have received an ## mile route.”—A message sent to the Scout User informing them that they have received a new route to navigate and approximately how far the route will have the connected Scout User travel. This message will have selectable addresses which will direct the Scout User to the correct Objective Info Screen when they select an address or they can toggle the view of the addresses to a Map View with selectable pins at every address in their route. Selecting any pin will display basic information about the address such as Address and Vehicle Details and then selecting this additional information will direct the Scout User to the correct Objective Info Screen.
5) A “VIN ### has been repossessed.”—A message sent to a scout user when they are the connected Scout User that selected their “Vehicle Located” button and a connected Agent User later selected their “Vehicle Repossessed” button for the same vehicle to inform them that the vehicle was secured by their team.
6) A “VIN ### has not been repossessed.”—A message sent to a scout user when they are the connected Scout User that selected their “Vehicle Located” button and a connected Agent User later selected their “Vehicle Not Repossessed” button for the same vehicle to inform them that the repossession was attempted but the vehicle was not secured by their team for some reason.

A connected Agent User will be able to receive 5 types of messages in their inbox:
1) A “Request to Connect”—A request sent from a Company User to allow the Field Agent User mobile access to interact with their repossession assignments.
2) A “You are getting a check for the information you have captured.”—A message automatically sent to any Field Agent User when the information they have captured has been deemed “Useful” by a Customer User letting the Field Agent User Know that they have money coming in from the system.
3) A “General Message”—A message sent to the connected Agent User from a connected Company User which can contain any sort of general information about anything.
4) A “You have received an ## mile route.”—A message sent to the Agent User informing them that they have received a new route to navigate and approximately how far the route will have the connected Agent User travel. This message will have selectable addresses which will direct the Agent User to the correct Objective Info Screen when they select an address or they can toggle the view of the addresses to a Map View with selectable pins at every address in their route. Selecting any pin will display basic information about the address such as Address and Vehicle Details and then selecting this additional information will direct the Agent User to the correct Objective Info Screen.
5) A “VIN ### has been located.”—A message sent to a connected Agent User when a connected Scout User has selected their “Vehicle Located” button to inform them that the vehicle was located by their team and this message/notification will give all connected Agent Users the ability to easily navigate to the address if they need to do so.

RANDOM ENTRY SCREEN: This screen has two (2) separate tabs that separate the searches for people and collateral, and the search tabs have optional text areas to enter a Name, Address, VIN, Vehicle Year, Make, Model and Color, a License Plate State and Number, Approximate Age, Tattoo Description, Email Address, SSN, Phone Number and any other random text they may wish to enter and photo they wish to capture and allows any Field Agent User and General User to report the location of anything or anybody they desire. There are 4 different buttons on the bottom of this screen that determine what information is captured by the Field Agent User for reporting information:
1) “Just a tip”—When this button is selected, only the information entered into the optional text fields will be captured and entered into the database to be searchable.
2) “I see this”—When this button is selected, the information entered into the optional text fields will be captured as well as the GPS coordinates of the Smart-phone Application User and both parts are entered into the database to become searchable.
3) “Photo Capture”—When this button is selected, the Smart-phone Application User will then capture a photo of any vehicle they wish and the text within the license plate information is captured from the photo, the GPS coordinates of the Smart-phone Application User is captured, the color, make and model are captured and all parts are entered into the database to become searchable. The random entry feature will also have the ability to extract information from the photo using OCR techniques. Preferably, this will occur after the photo is submitted to the database although some smart-phones may have sufficient processing power to perform the OCR operation locally and then submit the extracted textual information along with the photo. The system could also utilize a third party API and utilize their photo capture capabilities and have the information populated to the “Va Repo” system online database. The system could also be used to run the plate information and enter it into a Motor Vehicles database and capture owner and vehicle details. It will also be appreciated that a program running on the smart-phone could be used to capture the color, make, model and plate information all from a photo.
4) “Attach a Photo”—When a Smart-phone Application User selects this button, the user is able to capture any photo they wish to attach along with the information they are providing.

GROUP MAP SCREEN: This screen allows a connected Field Agent User to view a map with their current location along with all of the active addresses associated with all repossession assignments associated with their repossession Company User along with their storage locations. The visual appearance of this Group Map is the same exact color/style theme seen by the Company User when viewing any of their Map Views. Selecting any active address pin on this Group Map will display a small window containing basic information such as the address and vehicle information. Selecting the small information window will direct the connected Field Agent User to the correct Objective Info Screen for then pin. This screen also allows the connected Field Agent User to narrow down the number of pins displayed on this map view by giving them the ability to search the assignments by Assignment Number, Account Number, VIN, Debtor Name, Vehicle Make/Model and City. The map icons and routing information is described above in the web-based server program portion of the system.

CREATE CONDITION REPORT SCREEN: This screen allows the user to first search for a specific repossession assignment by the Assignment Number, VIN, License Plate Number, Vehicle Year, Make and Model, City and Zip Code. If only 1 positive search result occurs, the user is asked to select which condition report process they wish to be directed through. If multiple positive search results occur, the connected Field Agent User is displayed a Map with selectable pins at each address associated with the positive search results and the User can select any pin to review the information associated with the pin as well as begin creating a condition report for the collateral associated with the pin if desired.

Once the correct collateral/assignment has been selected, the connected Field Agent User will Be directed through a series of questions where the answers will establish the Repossession Details such as Date, Time and Address, the exact condition of the collateral both inside and outside and will allow the User to capture specific photos and lists of personal property associated with the collateral and all this information is entered into the database so that it is associated with the repossession assignment, searchable, savable, printable and communicable (e-mail or text message) by the Company User at any time.

OBJECTIVES INFO SCREEN: This screen allows the Field Agent User to interact with the repossession assignment in various ways. The first way the User can interact with the information associated with any pin is to review existing information associated with the pin and this is done with 5 buttons on this screen that are available to the User at all times.
1) Collateral Details—Pressing this button will direct the User to the correct “Collateral Details” screen.
2) Debtor and Co-Signer Details—Pressing this button will direct the User to the correct “Debtor and Co-Signer Details” screen.
3) Navigate—Pressing this button will initiate the GPS navigation on the Users smart-phone with the address associated with the pin as the destination.
4) Past Updates—Pressing this button will direct the User to the correct “Past Updates” screen.
5) All Addresses—Pressing this button will direct the User to the correct “All Addresses” screen.

There are additional buttons that can be displayed to the Field Agent User but they require that the User physically be within a required radius of the address associated with the pin.
1) Update—Selecting this button will allow the User to create a new update regarding the address.
2) Re-Run Update—Selecting this button will allow the User to move on to other things while the system documents that the user was within the required radius of the address and that there is nothing new or important to report.
3) Vehicle Located—Selecting this button will allow the User to establish that the collateral is at their current location and automatically notify all connected Agent Users of the successful location of the collateral and change the pin for the address to the correctly colored “Vehicle Located” pin so that all connected users within their group can see that the vehicle has been located by looking at any of the map views that would display the pin for that address.
4) Vehicle Repossessed—(This button is only available for Agent Users, not Scout Users) Selecting this button will allow the Agent User to automatically do the following: change the status of the repossession assignment to “Repossessed”, remove all pins associated with the repossession assignment from the map views for the group, enter the repossession details such as Date, Time and Address into the database and notify the Company User and Collector (if applicable) of the repossession details.
5) Follow Me—Selecting this button will allow the User to track the route they travel until they turn off the Follow Me feature and add the exact route they traveled onto a map and save this as a photo on their smart-phone so they can add it to the upcoming Return Update they are about to create for the address. While the Field Agent User is being directed through the Update Process, they will be asked if they wish to attach a Follow Me Photo at which time the User can select the Follow Me Photo they just created.

PAST UPDATES SCREEN: This screen allows the connected Field Agent User to view all prior updates created by their team for that address as well as the Dates and Times the address was checked before.

ALL ADDRESSES SCREEN: This screen allows the connected Field Agent User to view a list of all addresses associated with the repossession assignment and select any address to review it further if desired.

COLLATERAL DETAILS SCREEN: This screen allows the connected Field Agent User to view all of the details associated with the collateral such as Year, Make, Model, Color, Exact Specifications such as Body Size and Style, Engine and Drivetrain Specifications, photos of the type of vehicle they will be looking for as well as random notes that Va Repo has added for the specific type of vehicle.

DEBTOR AND CO-SIGNER DETAILS SCREEN: This screen allows the connected Field Agent User to view all of the details available regarding the Debtor and Co-Signer associated with the repossession assignment such as Name, Address, Contact Information, DOB and Employment Information.

NAVIGATION SCREEN—It is appreciated that Update: by Va Repo allows its users to simply receive their route and select one button to navigate to any address and it is the first smart-phone application designed for repo use that allows its users to navigate to any address which is associated with any connected repo company. Repo Field Agents no longer need to enter their destinations into any GPS Navigation device again.

PAST UPDATES SCREEN—This screen allows the users to easily view any updates that have been created for the same address in the past by anybody connected to the repo company. This will display the date and time of any entry and selecting any entry will display the update in question.

SETTINGS SCREEN—This screen allows the user to toggle one unique feature and this is the default view of the objectives. The default toggle can be set to “Map” or “List” and the users routes will respond accordingly.

SUBMIT SUGGESTION SCREEN—The Update: by Va Repo smart-phone application also allows the users to submit ideas and thoughts regarding additional questions and answers to display to the users in the update process.

UPDATE PREVIEW SCREEN—This screen allows a field agent user to review a complete return update (including photos) before they submit the update into the database. This screen allows the users to report errors within the Update Process, submit the update or restart the update process.

VEHICLE NOT RECOVERED SCREEN—This screen allows the Field Agent User to easily notify their repo company user that a piece of collateral was not successfully recovery for whatever reason. The Field Agent User can attach a photo to the update and add additional notes if desired. The GPS location of the user is established and entered as the location of the collateral when they select to submit this type of update but the field agent user can manually adjust the address before submitting the update (this functions the same on the “Vehicle Located” and “Vehicle Recovered” screens.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A computer implemented system for coordinating repossessions using a distributed network of mobile communications devices, comprising:
a centralized data storage device comprising a first set of information identifying a plurality of vehicles to be repossessed, a second set of information identifying a plurality of users associated with the network of mobile communications devices, and a third set of information identifying at least one location corresponding with each of said vehicles to be repossessed;
a communications module in networked communication with the mobile communications devices, wherein said communications module receives an information report from at least one of the mobile communications devices, wherein said information report comprises specific information defining at least one of a particular vehicle and a particular person associated with a vehicle, wherein said specific information further comprises a geographic location of at least one of said particular vehicle and said particular person; and
a centralized computer processor in operative communication with said centralized data storage device and said communications module, wherein said centralized computer processor compares said information report with said first set of information to determine whether at least one of said particular vehicle and said particular person corresponds with at least one of said vehicles to be repossessed, and wherein said centralized computer processor creates a record in said centralized data storage device linking said information report with at least one of said users.

2. The invention of claim 1, wherein said computer processor receives a repossession report confirming said particular vehicle has become a repossessed vehicle at a repossession location corresponding with said geographic location.

3. The invention of claim 1, wherein said first set of information is selected from the group of information consisting of a license tag associated with a vehicle, a physical description of a vehicle, a person having possession of a vehicle, a person having a registration to a vehicle, and any combination thereof.

4. The invention of claim 2, wherein said computer processor identifies a user associated linked with said information report having said geographic location corresponding with said repossession location, and wherein said centralized computer processor determines a payment to said identified user.

5. The invention of claim 1, further comprising an input device, wherein said input device is in operable communication with said centralized data storage device, wherein said input device is operated to define a set of vehicles to be repossessed according to a subset of said first set of information.

6. The invention of claim 5, wherein said centralized computer processor creates a travel route between each of said locations corresponding to said set of vehicles.

7. The invention of claim 6, wherein said centralized computer processor communicates said travel route through said communications module to at least one mobile communications device in the distributed network of mobile communications devices.

8. A computer implemented system for scouting and reporting on personal property and corresponding locations with a mobile communications device, comprising:
a data storage device comprising a plurality of inquiries related to physical site properties and a plurality of optional responses corresponding with potential physical site findings, wherein a first set of optional responses is related to a first inquiry, a second set of optional responses is related to a second inquiry and an alternative second set of optional responses is related to an alternative second inquiry;
a computer processor comprising a logic path between a first response in said first set of optional responses and said second inquiry and an alternative logic path between an alternative response in said first set of optional responses and said alternative second inquiry;
a display screen in operative communication with said computer processor, wherein said display screen shows said first inquiry with said first set of optional responses and subsequently shows at least one of said second inquiry with said second set of optional responses and said alternative second inquiry with said alternative second set of optional response; and
a user input interface in operative communication with said computer processor, wherein a first selection of at least one of said first response and said alternative response is received through said user input interface and a second selection from at least one of said second set of optional responses and said alternative second set of optional responses.

9. The invention of claim 1, wherein said physical site information is selected from the group of site items consisting of a geographic location, a building-type, a vehicle parking descriptor, a vehicle tag, and any combination thereof.

10. The invention of claim 1, wherein said plurality of inquiries are further comprised of witness contact information and witness reporting information.

11. The invention of claim 1, further comprising a communications module, a camera module, a geo-location module, a speaker and a navigation module.

12. The invention of claim 4, further comprising a proximity notice when said geo-location module determines the mobile communications device is within a pre-defined radius from an objective site location.

13. The invention of claim 4, further comprising a centralized server with a database, wherein said database receives a sequence of said selections and assembles said selections into a report.

14. The invention of claim 6, further comprising a geo-location report on a location of the mobile communications device in response to a vehicle tag location update selection, wherein said first inquiry is an inquiry on the vehicle tag State and said second inquiry is a vehicle tag number (optional inquiry on make and model of vehicle).

15. A method for locating a vehicle to be repossessed in a central computer system, wherein a plurality of repossession agents and a plurality of freelancers can communicate with the central computer system through a computer application on a mobile communications device in operative communication with the central computer system through a communications network, comprising the steps of:
maintaining an electronic database in the central computer system, wherein said electronic database comprises a plurality of user accounts and vehicle information, wherein said user accounts are accessible through the communications network, wherein said vehicle information further comprises lender information and borrower information corresponding with uniquely identified vehicles, wherein a first set of user accounts correspond with the repossession agents and wherein a second set of user accounts correspond with the freelancers;
assigning in the central computer system a first level of communication access to the repossession agents and a second level of communication access to the freelancers, wherein said repossession agents receive vehicle information from said electronic database and submit updated vehicle information to said electronic database through said application and wherein said freelancers only submit suspect vehicle information to said electronic database through said application and do not receive other vehicle information from said electronic database;
providing a computer processor in the central computer system, wherein said computer processor compares suspect vehicle information with said uniquely identified vehicles in said electronic database and computes a reward for at least one of the freelancers for suspect vehicle information provided by said one of the freelancers.

16. The method according to claim 15, further comprising the step of providing repossession instructions to the repossession agents.

17. The method according to claim 15, wherein said vehicle information is provided in at least one of user-inputted text information, communications device location information, and user-inputted image information.

18. The method according to claim 15, further comprising the step of providing address information to the mobile communication device for the repossession agents.

19. The method according to claim 18, further comprising the step of providing navigation information corresponding to said address information.

20. The method according to claim 15, further comprising the step of creating a repossession report from information received from the repossession agents through the computer application on the mobile communications device.
